SEQUENCE LISTING (1398 sequences)

SEQ ID NO: 1 - DNA, 28 bp, Artificial Sequence
  Synthesized de novo.
tctgctttctcttttgctgctatgttaa

SEQ ID NO: 2 - DNA, 20 bp, Artificial Sequence
  Synthesized de novo.
gatgaaaggtctagatgggg

SEQ ID NO: 3 - DNA, 20 bp, Artificial Sequence
  Synthesized de novo.
tacatgccgcagatgtcgta

SEQ ID NO: 4 - DNA, 22 bp, Artificial Sequence
  Synthesized de novo.
tcccctttgttgcagatcacgg

SEQ ID NO: 5 - DNA, 20 bp, Artificial Sequence
  Synthesized de novo.
ttgtctgctttttctttggc

SEQ ID NO: 6 - DNA, 21 bp, Artificial Sequence
  Synthesized de novo.
tctggggttcatgttgtgcag

SEQ ID NO: 7 - DNA, 21 bp, Artificial Sequence
  Synthesized de novo.
tcaaagatgtaatcgttgcag

SEQ ID NO: 8 - DNA, 21 bp, Artificial Sequence
  Synthesized de novo.
ttccatgcattcgtccataat

SEQ ID NO: 9 - DNA, 40 bp, Artificial Sequence
  Synthesized de novo.
tcgggtacaaattatgaattcgatctttggacttttcgac

SEQ ID NO: 10 - DNA, 40 bp, Artificial Sequence
  Synthesized de novo.
tccaccaaagtatttccgtgatacaaagtccggactgggc

SEQ ID NO: 11 - DNA, 40 bp, Artificial Sequence
  Synthesized de novo.
ttgatttttgggattaaattcagttttgtggaggttttaa

SEQ ID NO: 12 - DNA, 40 bp, Artificial Sequence
  Synthesized de novo.
tttgttttctggttattttacgtttaaattgtctaattgc

SEQ ID NO: 13 - DNA, 40 bp, Artificial Sequence
  Synthesized de novo.
ttttgtgctcagcggtcgcatttactagcggggacggcgc

SEQ ID NO: 14 - DNA, 40 bp, Artificial Sequence
  Synthesized de novo.
tggaatttacaaagaagtaagttgttggatctttattcac

SEQ ID NO: 15 - DNA, 40 bp, Artificial Sequence
  Synthesized de novo.
tttaaaaagtttttgtttgattgttttgacaaggttacac

SEQ ID NO: 16 - DNA, 40 bp, Artificial Sequence
  Synthesized de novo.
tgatgttgagtttttatacatgtttgtgtgtgttttgtgc

SEQ ID NO: 17 - DNA, 40 bp, Artificial Sequence
  Synthesized de novo.
tgcgtaagaatacaagttttgtgtgaaaaatttattaaaa

SEQ ID NO: 18 - DNA, 40 bp, Artificial Sequence
  Synthesized de novo.
tgtacgggcgcgtcggggttttcccggcgggcgggcgcgc

SEQ ID NO: 19 - DNA, 40 bp, Artificial Sequence
  Synthesized de novo.
tgggaaacttgacctttgaacgggcgcggtgaagtggcac

SEQ ID NO: 20 - DNA, 40 bp, Artificial Sequence
  Synthesized de novo.
ttaagagctttattggaattttatataaaatttatgagac

SEQ ID NO: 21 - DNA, 40 bp, Artificial Sequence
  Synthesized de novo.
ttgcaagtgccacgtcgtcgtgggcgtgtcttttgtgacc

SEQ ID NO: 22 - DNA, 40 bp, Artificial Sequence
  Synthesized de novo.
ttgggggcggcgggcggtgattggtggagaggggtgtgac

SEQ ID NO: 23 - DNA, 40 bp, Artificial Sequence
  Synthesized de novo.
tgggtggaggtgtggctttggcgtgcttgtaagtttgggc

SEQ ID NO: 24 - DNA, 40 bp, Artificial Sequence
  Synthesized de novo.
tctgggaggggcggggagtgtccgtgtgcgtgcgagcggc

SEQ ID NO: 25 - DNA, 40 bp, Artificial Sequence
  Synthesized de novo.
ttgggcgggtttttgtaacttttggccattttggcgcgaa

SEQ ID NO: 26 - DNA, 40 bp, Artificial Sequence
  Synthesized de novo.
tcggggaggagcgcggggcggggcgggcgtgtcgcgcggc

SEQ ID NO: 27 - DNA, 40 bp, Artificial Sequence
  Synthesized de novo.
tttgccacgtcatttatgacgcaacgacggcgagcgtggc

SEQ ID NO: 28 - DNA, 40 bp, Artificial Sequence
  Synthesized de novo.
tttataccggaagttgggtaatttgggcgtatacttgtaa

SEQ ID NO: 29 - DNA, 40 bp, Artificial Sequence
  Synthesized de novo.
tgtggatcgtgtggtgattggctgtggggttaacggctaa

SEQ ID NO: 30 - DNA, 40 bp, Artificial Sequence
  Synthesized de novo.
tttgtgacgtggcgcggggcgtgggaacggggcgggtgac

SEQ ID NO: 31 - DNA, 40 bp, Artificial Sequence
  Synthesized de novo.
ttcgttaggggcggggcaggtgacgttttgatgacgcgac

SEQ ID NO: 32 - DNA, 40 bp, Artificial Sequence
  Synthesized de novo.
tttggacttttcgacgcgcccagtgactgtactttattgc

SEQ ID NO: 33 - DNA, 40 bp, Artificial Sequence
  Synthesized de novo.
tctggcaccgatagcaataaatgggcgttcccttgcgtgc

SEQ ID NO: 34 - DNA, 40 bp, Artificial Sequence
  Synthesized de novo.
ttggacgagagaagacgatgcaaatgacgtcacgacgcac

SEQ ID NO: 35 - DNA, 40 bp, Artificial Sequence
  Synthesized de novo.
ttttgtggaggttttaaaggttaaaatttttatttggtgc

SEQ ID NO: 36 - DNA, 40 bp, Artificial Sequence
  Synthesized de novo.
ttgatttgttcgttttctgtttgaattgtgggcggttaaa

SEQ ID NO: 37 - DNA, 40 bp, Artificial Sequence
  Synthesized de novo.
tttactagcggggacggcgcgttactgcaccttgggcgca

SEQ ID NO: 38 - DNA, 40 bp, Artificial Sequence
  Synthesized de novo.
ttacttcacatgatattttacttaaattttgtacatacaa

SEQ ID NO: 39 - DNA, 40 bp, Artificial Sequence
  Synthesized de novo.
ttgttttgacaaggttacaccctgttcagggcgtttccca

SEQ ID NO: 40 - DNA, 40 bp, Artificial Sequence
  Synthesized de novo.
ttttgtgcttgtgtaaaggagttttggttttttactttgc

SEQ ID NO: 41 - DNA, 40 bp, Artificial Sequence
  Synthesized de novo.
tgtgaaaaatttattaaaaatgaagtttaaagaatattaa

SEQ ID NO: 42 - DNA, 40 bp, Artificial Sequence
  Synthesized de novo.
ttcccggcgggcgggcgcgccccgtggcgtgcgaggcggc

SEQ ID NO: 43 - DNA, 40 bp, Artificial Sequence
  Synthesized de novo.
tgaagtggcacgtgatgacgcagcactgcggacctttgcc

SEQ ID NO: 44 - DNA, 40 bp, Artificial Sequence
  Synthesized de novo.
tcaagttttaatattattgtcatcatgtaagtttttgtaa

SEQ ID NO: 45 - DNA, 40 bp, Artificial Sequence
  Synthesized de novo.
ttgtgacctttggacgggcgtttcgctggccgggttccca

SEQ ID NO: 46 - DNA, 40 bp, Artificial Sequence
  Synthesized de novo.
tgacgtagcgtgggaacgtgacgtcgcgtgggaaaatgac

SEQ ID NO: 47 - DNA, 40 bp, Artificial Sequence
  Synthesized de novo.
tgggcggatgaggaagtggggcgcggcgtgggagccgggc

SEQ ID NO: 48 - DNA, 40 bp, Artificial Sequence
  Synthesized de novo.
tgtatttatgatggggtgtttagggtatcagctgttggac

SEQ ID NO: 49 - DNA, 40 bp, Artificial Sequence
  Synthesized de novo.
ttttggcgcgaaaactgagtaatgaggacgtgggacgaac

SEQ ID NO: 50 - DNA, 40 bp, Artificial Sequence
  Synthesized de novo.
tttttattcattttgcaagtttttctgtacattttggcgc

SEQ ID NO: 51 - DNA, 40 bp, Artificial Sequence
  Synthesized de novo.
tgagggcggcgggggcggcgcgcggggcggcgcgcggggc

SEQ ID NO: 52 - DNA, 40 bp, Artificial Sequence
  Synthesized de novo.
ttgggcgtatacttgtaagttttgtgtaatttggcgcgaa

SEQ ID NO: 53 - DNA, 40 bp, Artificial Sequence
  Synthesized de novo.
ttaacggctaaaaggggcggtgcgaccgtgggaaaatgac

SEQ ID NO: 54 - DNA, 40 bp, Artificial Sequence
  Synthesized de novo.
tgacgtttttggtgtgcgccggtgtatacgggaagtgaca

SEQ ID NO: 55 - DNA, 40 bp, Artificial Sequence
  Synthesized de novo.
tctggtggggaaaagtgacgtcaaacgaggtgtggtttaa

SEQ ID NO: 56 - DNA, 40 bp, Artificial Sequence
  Synthesized de novo.
tcaccacgcccgggagatttcgaaattgctatttccgtgc

SEQ ID NO: 57 - DNA, 40 bp, Artificial Sequence
  Synthesized de novo.
tcccttgcgtgcggaattgcgccggcacagtcccaatggc

SEQ ID NO: 58 - DNA, 40 bp, Artificial Sequence
  Synthesized de novo.
tcgcggggctgatgacgtataaaaaagcggactttagacc

SEQ ID NO: 59 - DNA, 20 bp, Artificial Sequence
  Synthesized de novo.
ccctcaatgtcaatccatgt

SEQ ID NO: 60 - DNA, 23 bp, Artificial Sequence
  Synthesized de novo.
caagtgatgatcaaataacaatg

SEQ ID NO: 61 - DNA, 20 bp, Artificial Sequence
  Synthesized de novo.
agagaagagttgtatattgt

SEQ ID NO: 62 - DNA, 20 bp, Artificial Sequence
  Synthesized de novo.
cactcactttgtttaacaat

SEQ ID NO: 63 - DNA, 40 bp, Artificial Sequence
  Synthesized de novo.
cccaatgggtcttagatattcaagagaggtcaaacaacgg

SEQ ID NO: 64 - DNA, 20 bp, Artificial Sequence
  Synthesized de novo.
aaaacaaagatttcttaagg

SEQ ID NO: 65 - DNA, 20 bp, Artificial Sequence
  Synthesized de novo.
acacacaaatccaaaaactt

SEQ ID NO: 66 - DNA, 40 bp, Artificial Sequence
  Synthesized de novo.
ctgtgtgaggcccatccacctatttgaccaacatggggtt

SEQ ID NO: 67 - DNA, 22 bp, Artificial Sequence
  Synthesized de novo.
cacccatgacaaaaaatcttga

SEQ ID NO: 68 - DNA, 40 bp, Artificial Sequence
  Synthesized de novo.
aagcatgggcaactgcaatcgaactcagaaacccagttcg

SEQ ID NO: 69 - DNA, 25 bp, Artificial Sequence
  Synthesized de novo.
ccccccggggggaccccccgccggg

SEQ ID NO: 70 - DNA, 40 bp, Artificial Sequence
  Synthesized de novo.
agagagttatgtttaaactatatagaacaggatgagaggt

SEQ ID NO: 71 - DNA, 24 bp, Artificial Sequence
  Synthesized de novo.
caactacacaaagttttggtatgt

SEQ ID NO: 72 - DNA, 40 bp, Artificial Sequence
  Synthesized de novo.
agatcttgtgagaaagtgggtccctgatgacctggaactg

SEQ ID NO: 73 - DNA, 40 bp, Artificial Sequence
  Synthesized de novo.
aaagacatggtaagaaaatgggttccagaatgggaagagt

SEQ ID NO: 74 - DNA, 20 bp, Artificial Sequence
  Synthesized de novo.
cctaactcacaggcatttgt

SEQ ID NO: 75 - DNA, 20 bp, Artificial Sequence
  Synthesized de novo.
ctaccatttttgaacccctt

SEQ ID NO: 76 - DNA, 24 bp, Artificial Sequence
  Synthesized de novo.
ctcaaaacacttgatctgatcagt

SEQ ID NO: 77 - DNA, 27 bp, Artificial Sequence
  Synthesized de novo.
ctcaaagcacttaatctgatctgtcaa

SEQ ID NO: 78 - DNA, 22 bp, Artificial Sequence
  Synthesized de novo.
catcactagaggtatatgatgt

SEQ ID NO: 79 - DNA, 40 bp, Artificial Sequence
  Synthesized de novo.
aacatggggttgaggtactccaaagcagtcaaagacaaat

SEQ ID NO: 80 - DNA, 40 bp, Artificial Sequence
  Synthesized de novo.
agttcgtcttctaacaacctcgagaagccaccacaagctg

SEQ ID NO: 81 - DNA, 40 bp, Artificial Sequence
  Synthesized de novo.
ccgtgcaagacagcgcagagctccccacaatgggcaactg

SEQ ID NO: 82 - DNA, 40 bp, Artificial Sequence
  Synthesized de novo.
cactactttaggaccttattttcaccaatgggtctgagat

SEQ ID NO: 83 - DNA, 40 bp, Artificial Sequence
  Synthesized de novo.
aaacaagcaagccaaagccccagaatcaaaagacagtccg

SEQ ID NO: 84 - DNA, 40 bp, Artificial Sequence
  Synthesized de novo.
aagcactcacacaagtcccgcaaccaccacacctacaagg

SEQ ID NO: 85 - DNA, 40 bp, Artificial Sequence
  Synthesized de novo.
caacaccacatctccaatttcatcagcaacgaggcaagat

SEQ ID NO: 86 - DNA, 40 bp, Artificial Sequence
  Synthesized de novo.
cctcaggaaacactttcctgctaaagaggagatcagtcgt

SEQ ID NO: 87 - DNA, 40 bp, Artificial Sequence
  Synthesized de novo.
agaacaggatgagaggttgtcaaggcagaaactcaacttt

SEQ ID NO: 88 - DNA, 20 bp, Artificial Sequence
  Synthesized de novo.
ccccccagtccgcggcctgg

SEQ ID NO: 89 - DNA, 40 bp, Artificial Sequence
  Synthesized de novo.
ccctgatgacctggaactgtcagaacagaaaaacattatg

SEQ ID NO: 90 - DNA, 40 bp, Artificial Sequence
  Synthesized de novo.
agaatgggaagagttatctgagcagaagaataacgtgctt

SEQ ID NO: 91 - DNA, 23 bp, Artificial Sequence
  Synthesized de novo.
ccattgttcacagccatcttcat

SEQ ID NO: 92 - DNA, 40 bp, Artificial Sequence
  Synthesized de novo.
aaagattttgttagaaaacagatacctgatagaccagagt

SEQ ID NO: 93 - DNA, 25 bp, Artificial Sequence
  Synthesized de novo.
cccctctgacaaagttttttgaaag

SEQ ID NO: 94 - DNA, 40 bp, Artificial Sequence
  Synthesized de novo.
agatactcaaaggctgtcagagacagatatggagagaggg

SEQ ID NO: 95 - DNA, 40 bp, Artificial Sequence
  Synthesized de novo.
cccagtgtcagaacagattgcaataatggggcttaggtat

SEQ ID NO: 96 - DNA, 40 bp, Artificial Sequence
  Synthesized de novo.
ctacagcaaagaggtgagagagagacacggagacaaagat

SEQ ID NO: 97 - DNA, 40 bp, Artificial Sequence
  Synthesized de novo.
aagcagtcaaagacaaatatggagatcgagaaattgaagg

SEQ ID NO: 98 - DNA, 40 bp, Artificial Sequence
  Synthesized de novo.
agcaccagatttcatctaatgggtaactccaagtcaaaat

SEQ ID NO: 99 - DNA, 40 bp, Artificial Sequence
  Synthesized de novo.
accacaagctgcagaatttagaagaacggcagagcccagt

SEQ ID NO: 100 - DNA, 40 bp, Artificial Sequence
  Synthesized de novo.
cccaacacacaaacatcatccaaccaaccctcagcagagt

SEQ ID NO: 101 - DNA, 40 bp, Artificial Sequence
  Synthesized de novo.
ccccaaaccgctccagctcccacaaccaagagtgtccctg

SEQ ID NO: 102 - DNA, 40 bp, Artificial Sequence
  Synthesized de novo.
cagcacaaatctcctcaaggagacagaaccaaggcatcca

SEQ ID NO: 103 - DNA, 40 bp, Artificial Sequence
  Synthesized de novo.
agaatcaaaagacagtccgagagccagcctgatcccagat

SEQ ID NO: 104 - DNA, 40 bp, Artificial Sequence
  Synthesized de novo.
ccaccacacctacaaggacccgccaacagtcccgccaaat

SEQ ID NO: 105 - DNA, 40 bp, Artificial Sequence
  Synthesized de novo.
aacgaggcaagatcaccccttatcatgggacagaagcctt

SEQ ID NO: 106 - DNA, 40 bp, Artificial Sequence
  Synthesized de novo.
cagtcgtcagatcactgttgtcacctcacaaactgaaatg

SEQ ID NO: 107 - DNA, 40 bp, Artificial Sequence
  Synthesized de novo.
gttatgaatctgggttcagctcgctcacgtgagtggctta

SEQ ID NO: 108 - DNA, 21 bp, Artificial Sequence
  Synthesized de novo.
caggcatttgagtatgcctat

SEQ ID NO: 109 - DNA, 40 bp, Artificial Sequence
  Synthesized de novo.
tttctctgaccgtttaccacacaattaacaacaatatggc

SEQ ID NO: 110 - DNA, 40 bp, Artificial Sequence
  Synthesized de novo.
ccccaaaggctttcactgctcaggccggactggccaaatt

SEQ ID NO: 111 - DNA, 40 bp, Artificial Sequence
  Synthesized de novo.
ccaaggctcttgctccagctgatgggcccatagtggccgg

SEQ ID NO: 112 - DNA, 40 bp, Artificial Sequence
  Synthesized de novo.
tttgcatcccttgatcaacggcgggagcgccaagaagaac

SEQ ID NO: 113 - DNA, 40 bp, Artificial Sequence
  Synthesized de novo.
cgctcacgtgagtggcttaatgagctacccagcacagcac

SEQ ID NO: 114 - DNA, 40 bp, Artificial Sequence
  Synthesized de novo.
tgtctatgacaaagtgctgcagttcggctctaagaaggcc

SEQ ID NO: 115 - DNA, 40 bp, Artificial Sequence
  Synthesized de novo.
ttcaccctcgtggctctggccagcgctgtgtctatgacac

SEQ ID NO: 116 - DNA, 40 bp, Artificial Sequence
  Synthesized de novo.
acaattaacaacaatatggcatacggtgagccatactata

SEQ ID NO: 117 - DNA, 40 bp, Artificial Sequence
  Synthesized de novo.
caggccggactggccaaattggtcaatccggccggcttaa

SEQ ID NO: 118 - DNA, 40 bp, Artificial Sequence
  Synthesized de novo.
gatgggcccatagtggccggcctcgacaaactagtgaacc

SEQ ID NO: 119 - DNA, 40 bp, Artificial Sequence
  Synthesized de novo.
gcgggagcgccaagaagaacaggcgcagtccggccttgac

SEQ ID NO: 120 - DNA, 40 bp, Artificial Sequence
  Synthesized de novo.
tgagctacccagcacagcactcaaccagctgcgtgacatc

SEQ ID NO: 121 - DNA, 40 bp, Artificial Sequence
  Synthesized de novo.
agttcggctctaagaaggccagagctcgtggcatggccct

SEQ ID NO: 122 - DNA, 40 bp, Artificial Sequence
  Synthesized de novo.
cagcgctgtgtctatgacacagtgctccggtttggggacc

SEQ ID NO: 123 - DNA, 40 bp, Artificial Sequence
  Synthesized de novo.
tacggtgagccatactatagctctaaacctgacaaagatt

SEQ ID NO: 124 - DNA, 40 bp, Artificial Sequence
  Synthesized de novo.
ggtcaatccggccggcttaaatagcatcctcgctagaggg

SEQ ID NO: 125 - DNA, 40 bp, Artificial Sequence
  Synthesized de novo.
cctcgacaaactagtgaacctggaaggggttcacgacttg

SEQ ID NO: 126 - DNA, 40 bp, Artificial Sequence
  Synthesized de novo.
aggcgcagtccggccttgacaaggtgttctacttccaagg

SEQ ID NO: 127 - DNA, 40 bp, Artificial Sequence
  Synthesized de novo.
gcaatgccacccaagagacgcctggttgatgacgccgatg

SEQ ID NO: 128 - DNA, 40 bp, Artificial Sequence
  Synthesized de novo.
cctggttgatgacgccgatgccatggaggatcaagatcta

SEQ ID NO: 129 - DNA, 40 bp, Artificial Sequence
  Synthesized de novo.
ccatggaggatcaagatctatatgaacccccagcgagcct

SEQ ID NO: 130 - DNA, 40 bp, Artificial Sequence
  Synthesized de novo.
aacagggtcttaactgccctccagctgtgacctttacctc

SEQ ID NO: 131 - DNA, 25 bp, Artificial Sequence
  Synthesized de novo.
agatgataaagcatgattggtctga

SEQ ID NO: 132 - DNA, 20 bp, Artificial Sequence
  Synthesized de novo.
gtttatgatgatggtgcacc

SEQ ID NO: 133 - DNA, 26 bp, Artificial Sequence
  Synthesized de novo.
ggtgcaagtggagtttatccttcatt

SEQ ID NO: 134 - DNA, 20 bp, Artificial Sequence
  Synthesized de novo.
gggccttatgaagatttagc

SEQ ID NO: 135 - DNA, 40 bp, Artificial Sequence
  Synthesized de novo.
tcaatatcgtgctaggatcaacgatgcaaatgatccagaa

SEQ ID NO: 136 - DNA, 40 bp, Artificial Sequence
  Synthesized de novo.
agatattcatgagagagtcaaggaggcagtcccaggggaa

SEQ ID NO: 137 - DNA, 40 bp, Artificial Sequence
  Synthesized de novo.
aagactggttttgttagagtgccaatcaagcattttgact

SEQ ID NO: 138 - DNA, 40 bp, Artificial Sequence
  Synthesized de novo.
attaaatccaacagaaggtcattaaaggctctttaatgat

SEQ ID NO: 139 - DNA, 40 bp, Artificial Sequence
  Synthesized de novo.
tgtaagagcattaaccattcatccactgaggaggtatgaa

SEQ ID NO: 140 - DNA, 40 bp, Artificial Sequence
  Synthesized de novo.
acaaaaattaatagaaaatggaaccactttactgttgtct

SEQ ID NO: 141 - DNA, 40 bp, Artificial Sequence
  Synthesized de novo.
aaactaatattaagatcaaaattatggcactatttgctct

SEQ ID NO: 142 - DNA, 25 bp, Artificial Sequence
  Synthesized de novo.
gtattaaatctgcattcagcatcaa

SEQ ID NO: 143 - DNA, 40 bp, Artificial Sequence
  Synthesized de novo.
atactatctaaggctctggtactgtgtttaataggttgta

SEQ ID NO: 144 - DNA, 40 bp, Artificial Sequence
  Synthesized de novo.
aatttatgatacaaagaaatactatttatggtttttggaa

SEQ ID NO: 145 - DNA, 40 bp, Artificial Sequence
  Synthesized de novo.
tagacagtctaatttgggaaagggttgttgatgaacaata

SEQ ID NO: 146 - DNA, 40 bp, Artificial Sequence
  Synthesized de novo.
tagtggtctttccttttgtgaaaccatggacttcttgaga

SEQ ID NO: 147 - DNA, 40 bp, Artificial Sequence
  Synthesized de novo.
tgtgacctttacctccagccatatgagaccgccaattcca

SEQ ID NO: 148 - DNA, 20 bp, Artificial Sequence
  Synthesized de novo.
ggagcatcacctcaggttgc

SEQ ID NO: 149 - DNA, 40 bp, Artificial Sequence
  Synthesized de novo.
gggtttactattgacaatgattttgatcgattttggggca

SEQ ID NO: 150 - DNA, 40 bp, Artificial Sequence
  Synthesized de novo.
gagaaattcacaataaacttaaggagttctctcctggtac

SEQ ID NO: 151 - DNA, 24 bp, Artificial Sequence
  Synthesized de novo.
ggttttgaatggggtaagcctaat

SEQ ID NO: 152 - DNA, 40 bp, Artificial Sequence
  Synthesized de novo.
actgttgctcaaccaatatcggaataggatattgcactgc

SEQ ID NO: 153 - DNA, 40 bp, Artificial Sequence
  Synthesized de novo.
acgatgcaaatgatccagaaactgctaaagatatattagc

SEQ ID NO: 154 - DNA, 40 bp, Artificial Sequence
  Synthesized de novo.
aggcagtcccaggggaaacatcagcagtagaatgtttaga

SEQ ID NO: 155 - DNA, 40 bp, Artificial Sequence
  Synthesized de novo.
gatccacaatagaatgagagaatgtgtgccaggggaggta

SEQ ID NO: 156 - DNA, 40 bp, Artificial Sequence
  Synthesized de novo.
aatcaagcattttgactgtacaatgctaactctggcactt

SEQ ID NO: 157 - DNA, 40 bp, Artificial Sequence
  Synthesized de novo.
taaaggctctttaatgattgagttggaatttcatgatgtc

SEQ ID NO: 158 - DNA, 40 bp, Artificial Sequence
  Synthesized de novo.
gattcatcaaagagtcaaggagattcctcctgggggggct

SEQ ID NO: 159 - DNA, 40 bp, Artificial Sequence
  Synthesized de novo.
atccactgaggaggtatgaatcatcaatctatgacacacc

SEQ ID NO: 160 - DNA, 40 bp, Artificial Sequence
  Synthesized de novo.
atatatgcataatggactatcaagagtatcaacaattctt

SEQ ID NO: 161 - DNA, 40 bp, Artificial Sequence
  Synthesized de novo.
gaaccactttactgttgtctattgaggattgtgtaggttc

SEQ ID NO: 162 - DNA, 40 bp, Artificial Sequence
  Synthesized de novo.
attatggcactatttgctctttcagttgtatggctactta

SEQ ID NO: 163 - DNA, 20 bp, Artificial Sequence
  Synthesized de novo.
gggattaaaacatataaagc

SEQ ID NO: 164 - DNA, 40 bp, Artificial Sequence
  Synthesized de novo.
actgtgtttaataggttgtaacattctttgctgcgttcca

SEQ ID NO: 165 - DNA, 40 bp, Artificial Sequence
  Synthesized de novo.
actatttatggtttttggaacgcatgtagttctaatcctt

SEQ ID NO: 166 - DNA, 40 bp, Artificial Sequence
  Synthesized de novo.
ataagaaatactatttctgacactaatgtctggtttagaa

SEQ ID NO: 167 - DNA, 40 bp, Artificial Sequence
  Synthesized de novo.
agggttgttgatgaacaatatatcactaacccaacatttt

SEQ ID NO: 168 - DNA, 40 bp, Artificial Sequence
  Synthesized de novo.
tggacttcttgagaagccttgactggactcaagtgattgc

SEQ ID NO: 169 - DNA, 40 bp, Artificial Sequence
  Synthesized de novo.
atatgagaccgccaattccatcatttctgctctggactga

SEQ ID NO: 170 - DNA, 40 bp, Artificial Sequence
  Synthesized de novo.
attcaagatgcagagatattatgagattagagataggata

SEQ ID NO: 171 - DNA, 40 bp, Artificial Sequence
  Synthesized de novo.
ttttgatcgattttggggcatccttaaggaatgtctatga

SEQ ID NO: 172 - DNA, 20 bp, Artificial Sequence
  Synthesized de novo.
ggtgaaaaaaagattcttgc

SEQ ID NO: 173 - DNA, 40 bp, Artificial Sequence
  Synthesized de novo.
ggagtttgctattactggccgctttagttggccaaggctt

SEQ ID NO: 174 - DNA, 40 bp, Artificial Sequence
  Synthesized de novo.
ggaataggatattgcactgccgtgaacctgagatagcaaa

SEQ ID NO: 175 - DNA, 40 bp, Artificial Sequence
  Synthesized de novo.
actgctaaagatatattagctgatctattaatggatcgac

SEQ ID NO: 176 - DNA, 40 bp, Artificial Sequence
  Synthesized de novo.
gtagaatgtttagatttattggatagattgtatgcagtga

SEQ ID NO: 177 - DNA, 40 bp, Artificial Sequence
  Synthesized de novo.
atgtgtgccaggggaggtatctgcagtagagtgcctggat

SEQ ID NO: 178 - DNA, 40 bp, Artificial Sequence
  Synthesized de novo.
gattcatcagagagttagggaccttgcacctggaacggta

SEQ ID NO: 179 - DNA, 40 bp, Artificial Sequence
  Synthesized de novo.
atgctaactctggcacttccaacatttgatgtttccaaga

SEQ ID NO: 180 - DNA, 40 bp, Artificial Sequence
  Synthesized de novo.
agttggaatttcatgatgtcgctgctaacaccagcagtac

SEQ ID NO: 181 - DNA, 40 bp, Artificial Sequence
  Synthesized de novo.
agattcctcctgggggggcttctgcattagaatgtttaga

SEQ ID NO: 182 - DNA, 40 bp, Artificial Sequence
  Synthesized de novo.
tcatcaatctatgacacaccaataccagcctatgtgatca

SEQ ID NO: 183 - DNA, 40 bp, Artificial Sequence
  Synthesized de novo.
atcaacaattcttggctaggattaatactgcaagggatgc

SEQ ID NO: 184 - DNA, 40 bp, Artificial Sequence
  Synthesized de novo.
tgaggattgtgtaggttctaaccacgatctagctttggat

SEQ ID NO: 185 - DNA, 40 bp, Artificial Sequence
  Synthesized de novo.
ttcagttgtatggctacttatgctagatgctcatgtaaaa

SEQ ID NO: 186 - DNA, 21 bp, Artificial Sequence
  Synthesized de novo.
gttttgagcttgattgttgct

SEQ ID NO: 187 - DNA, 40 bp, Artificial Sequence
  Synthesized de novo.
acattctttgctgcgttccacttaaacatcattaactatt

SEQ ID NO: 188 - DNA, 40 bp, Artificial Sequence
  Synthesized de novo.
atgtagttctaatccttatctaccttacattacattgcta

SEQ ID NO: 189 - DNA, 40 bp, Artificial Sequence
  Synthesized de novo.
actaatgtctggtttagaacttgcaactagactgcatcct

SEQ ID NO: 190 - DNA, 40 bp, Artificial Sequence
  Synthesized de novo.
tatcactaacccaacattttgtgttagtgactattttgaa

SEQ ID NO: 191 - DNA, 40 bp, Artificial Sequence
  Synthesized de novo.
gactggactcaagtgattgctggtcaatatgtgtccaacc

SEQ ID NO: 192 - DNA, 20 bp, Artificial Sequence
  Synthesized de novo.
tctagtgcagctcgactaga

SEQ ID NO: 193 - DNA, 20 bp, Artificial Sequence
  Synthesized de novo.
tatcctaagtgtgatagagc

SEQ ID NO: 194 - DNA, 29 bp, Artificial Sequence
  Synthesized de novo.
ggccacgcggagtacgatcgagggtacag

SEQ ID NO: 195 - DNA, 40 bp, Artificial Sequence
  Synthesized de novo.
ttttggtttgcccaccatacgggcagttttcagaccgcag

SEQ ID NO: 196 - DNA, 21 bp, Artificial Sequence
  Synthesized de novo.
taagcattttagtatgatgat

SEQ ID NO: 197 - DNA, 40 bp, Artificial Sequence
  Synthesized de novo.
tttgattttaacgaacttaaataatagccttgctgtgtgc

SEQ ID NO: 198 - DNA, 40 bp, Artificial Sequence
  Synthesized de novo.
tttgtttttaacgaacttaaataatagccctgctggtttg

SEQ ID NO: 199 - DNA, 40 bp, Artificial Sequence
  Synthesized de novo.
tagtttaaatctaatctaatctaaactttataaacggcac

SEQ ID NO: 200 - DNA, 40 bp, Artificial Sequence
  Synthesized de novo.
tctactcttctcaactaaacgaaatttacgtctttttgtg

SEQ ID NO: 201 - DNA, 40 bp, Artificial Sequence
  Synthesized de novo.
gtgtctacttttctcaactaaacgaaatttttgctatggc

SEQ ID NO: 202 - DNA, 40 bp, Artificial Sequence
  Synthesized de novo.
tgtctactcttctcaactaaacgaaatttttctagtgctg

SEQ ID NO: 203 - DNA, 40 bp, Artificial Sequence
  Synthesized de novo.
ttaacttaacaaaacggacttaaatacctacagctggtcc

SEQ ID NO: 204 - DNA, 40 bp, Artificial Sequence
  Synthesized de novo.
taaatacctacagctggtcctcataggtgttccattgcag

SEQ ID NO: 205 - DNA, 40 bp, Artificial Sequence
  Synthesized de novo.
tactcaattcaactaaacagaaattttgtccttccttccg

SEQ ID NO: 206 - DNA, 40 bp, Artificial Sequence
  Synthesized de novo.
tttgtctactcgattcaactaaacgaaattttgtccttca

SEQ ID NO: 207 - DNA, 40 bp, Artificial Sequence
  Synthesized de novo.
tcccctcaactaaacgaaatttttgccatatgtttatggc

SEQ ID NO: 208 - DNA, 40 bp, Artificial Sequence
  Synthesized de novo.
gggcagttttcagaccgcagtgtcttgtcagggaggtcca

SEQ ID NO: 209 - DNA, 40 bp, Artificial Sequence
  Synthesized de novo.
tagccttgtgctagattttgtcttcggacaccaactcgaa

SEQ ID NO: 210 - DNA, 40 bp, Artificial Sequence
  Synthesized de novo.
gtctaatcccctcaactaaacgaaatttttgccatacttg

SEQ ID NO: 211 - DNA, 40 bp, Artificial Sequence
  Synthesized de novo.
gtacgaatcactcttgaacgaacttaaaattgcatcatac

SEQ ID NO: 212 - DNA, 40 bp, Artificial Sequence
  Synthesized de novo.
tagccttgtgctagatttgtcttcggacaccaactcgaac

SEQ ID NO: 213 - DNA, 40 bp, Artificial Sequence
  Synthesized de novo.
tctgttctttaaacgaactttaaaatctgtgtggctgtcg

SEQ ID NO: 214 - DNA, 40 bp, Artificial Sequence
  Synthesized de novo.
tctgttctctaaacgaactttaaaatctgtgtggctgtcg

SEQ ID NO: 215 - DNA, 40 bp, Artificial Sequence
  Synthesized de novo.
tctgttctctaaacgaactttaaaatctgtgtagctgtcg

SEQ ID NO: 216 - DNA, 40 bp, Artificial Sequence
  Synthesized de novo.
taaatctaaactttttaaacaagattccctgttatccatg

SEQ ID NO: 217 - DNA, 40 bp, Artificial Sequence
  Synthesized de novo.
taatagccttgctgtgtgcgtgttgtgttgtggtctgcag

SEQ ID NO: 218 - DNA, 40 bp, Artificial Sequence
  Synthesized de novo.
tttgtaatctaaactttataaaaacatccactccctgtag

SEQ ID NO: 219 - DNA, 40 bp, Artificial Sequence
  Synthesized de novo.
taatagccctgctggtttgcgtgctgcgatacctttctgc

SEQ ID NO: 220 - DNA, 40 bp, Artificial Sequence
  Synthesized de novo.
tctaaactttataaaaacatccactccctgtaatctatgc

SEQ ID NO: 221 - DNA, 40 bp, Artificial Sequence
  Synthesized de novo.
tctcttttaatctaaactttataaaaacacccactccctg

SEQ ID NO: 222 - DNA, 40 bp, Artificial Sequence
  Synthesized de novo.
ttcataatctaaactttataaaaacatccactccctgtag

SEQ ID NO: 223 - DNA, 40 bp, Artificial Sequence
  Synthesized de novo.
gtttaaatctaatctaaactttataaacggcacttcctgc

SEQ ID NO: 224 - DNA, 40 bp, Artificial Sequence
  Synthesized de novo.
tataaacggcacttcctgcgtgtccatgcccgtgggcctg

SEQ ID NO: 225 - DNA, 40 bp, Artificial Sequence
  Synthesized de novo.
tgtggcaaacaacccaaattaaacaaaacggacttgggtg

SEQ ID NO: 226 - DNA, 40 bp, Artificial Sequence
  Synthesized de novo.
ttacgtctttttgtgtatgctacgcatgcacaattagatg

SEQ ID NO: 227 - DNA, 40 bp, Artificial Sequence
  Synthesized de novo.
ttttgctatggccggcatctttgatgctggagtcgtagtg

SEQ ID NO: 228 - DNA, 40 bp, Artificial Sequence
  Synthesized de novo.
tctagtgctgtcatttgttatggcagtcctagtgtaattg

SEQ ID NO: 229 - DNA, 40 bp, Artificial Sequence
  Synthesized de novo.
taggtgttccattgcagtgcactttagtgccctggatggc

SEQ ID NO: 230 - DNA, 40 bp, Artificial Sequence
  Synthesized de novo.
ttttgtccttccttccggccgcatgttcatgctgctggaa

SEQ ID NO: 231 - DNA, 40 bp, Artificial Sequence
  Synthesized de novo.
ttttgtccttcagcacacatgtctatgtgtgctgaagtga

SEQ ID NO: 232 - DNA, 40 bp, Artificial Sequence
  Synthesized de novo.
ttgccatatgtttatggctaattgaaatttcagtcggttg

SEQ ID NO: 233 - DNA, 40 bp, Artificial Sequence
  Synthesized de novo.
tgtcttgtcagggaggtccagccttgactttacttctccg

SEQ ID NO: 234 - DNA, 40 bp, Artificial Sequence
  Synthesized de novo.
ttgccatatgtttatggcgaattgaaatttcagtcggttg

SEQ ID NO: 235 - DNA, 40 bp, Artificial Sequence
  Synthesized de novo.
tcgaactaaacgaaatatttgtctttctatgaaatcatag

SEQ ID NO: 236 - DNA, 40 bp, Artificial Sequence
  Synthesized de novo.
tttttgccatacttgtatggcggattgaaatttccctagg

SEQ ID NO: 237 - DNA, 40 bp, Artificial Sequence
  Synthesized de novo.
taaaattgcatcatacgtcacggtaggtttcgtcttgctg

SEQ ID NO: 238 - DNA, 40 bp, Artificial Sequence
  Synthesized de novo.
tcgaactaaacgaaatatttgtctctctatgaaaccatag

SEQ ID NO: 239 - DNA, 40 bp, Artificial Sequence
  Synthesized de novo.
taaaatctgtgtggctgtcgcttggctgtatgcctagtgc

SEQ ID NO: 240 - DNA, 40 bp, Artificial Sequence
  Synthesized de novo.
taaaatctgtgtggctgtcgctcggctgcatgcctagcgc

SEQ ID NO: 241 - DNA, 40 bp, Artificial Sequence
  Synthesized de novo.
taaaatctgtgtagctgtcgcttggctgcatgcctagtgc

SEQ ID NO: 242 - DNA, 40 bp, Artificial Sequence
  Synthesized de novo.
taaaatctgtgtagctgtcgctcggctgcatgcctagtgc

SEQ ID NO: 243 - DNA, 40 bp, Artificial Sequence
  Synthesized de novo.
tgttatccatgcttgtgagtgtggtttaatcataatcttg

SEQ ID NO: 244 - DNA, 40 bp, Artificial Sequence
  Synthesized de novo.
tgttgtgttgtggtctgcagcgtttaggcgccgggcttca

SEQ ID NO: 245 - DNA, 40 bp, Artificial Sequence
  Synthesized de novo.
tgtagtctatgcttgtgggcgtagatttttcatagtggtg

SEQ ID NO: 246 - DNA, 40 bp, Artificial Sequence
  Synthesized de novo.
tgctgcgatacctttctgctgcgtcataggcgccggactg

SEQ ID NO: 247 - DNA, 40 bp, Artificial Sequence
  Synthesized de novo.
tgtaatctatgcttgtgggcgtagatttttcatagtggtg

SEQ ID NO: 248 - DNA, 40 bp, Artificial Sequence
  Synthesized de novo.
tgtaatctatgcttgcgagcttagacttttcatagtggtg

SEQ ID NO: 249 - DNA, 40 bp, Artificial Sequence
  Synthesized de novo.
tgtagtctatgcctgtgggcgtagatttttcatagtggtg

SEQ ID NO: 250 - DNA, 40 bp, Artificial Sequence
  Synthesized de novo.
tataaacggcacttcctgcgtgtccatgcccgcgggcctg

SEQ ID NO: 251 - DNA, 40 bp, Artificial Sequence
  Synthesized de novo.
tgtccatgcccgtgggcctggtcttgtcatagtgctgaca

SEQ ID NO: 252 - DNA, 40 bp, Artificial Sequence
  Synthesized de novo.
ttgggtgtgtttcctgaccgcacgcgagtggggggtggca

SEQ ID NO: 253 - DNA, 20 bp, Artificial Sequence
  Synthesized de novo.
aagcaactccaacaatatgc

SEQ ID NO: 254 - DNA, 40 bp, Artificial Sequence
  Synthesized de novo.
gaatattaacattgacattgagacttgtcagtctgttaat

SEQ ID NO: 255 - DNA, 24 bp, Artificial Sequence
  Synthesized de novo.
aagattaaaaccttcatcatcctt

SEQ ID NO: 256 - DNA, 40 bp, Artificial Sequence
  Synthesized de novo.
actatgaggaagattaacagttttcctcagtttaagatat

SEQ ID NO: 257 - DNA, 40 bp, Artificial Sequence
  Synthesized de novo.
agacttgtcagtctgttaatattcttgaagagatggattt

SEQ ID NO: 258 - DNA, 31 bp, Artificial Sequence
  Synthesized de novo.
gttgcattgagccacatgattggacaaaaaa

SEQ ID NO: 259 - DNA, 40 bp, Artificial Sequence
  Synthesized de novo.
actatgaggaagattaataattttcctctcattgaaattt

SEQ ID NO: 260 - DNA, 40 bp, Artificial Sequence
  Synthesized de novo.
attcttgaagagatggatttacacagtttgttggagttgg

SEQ ID NO: 261 - DNA, 25 bp, Artificial Sequence
  Synthesized de novo.
ccccccctcccgggagagccatagt

SEQ ID NO: 262 - DNA, 40 bp, Artificial Sequence
  Synthesized de novo.
accgacgcctatctaagtagacgcaatgactcggcgccga

SEQ ID NO: 263 - DNA, 40 bp, Artificial Sequence
  Synthesized de novo.
ccccccctagcagggcgtgggggatttcccctgcccgtct

SEQ ID NO: 264 - DNA, 40 bp, Artificial Sequence
  Synthesized de novo.
gtacgtctatcggtccggctggcccgaaaggcggtggatc

SEQ ID NO: 265 - DNA, 40 bp, Artificial Sequence
  Synthesized de novo.
tcagaaaaacaaaattaaattggttaataaaaaattgcaa

SEQ ID NO: 266 - DNA, 40 bp, Artificial Sequence
  Synthesized de novo.
accacctcagggccgaggagggcaggtcaaacaaaaaccc

SEQ ID NO: 267 - DNA, 40 bp, Artificial Sequence
  Synthesized de novo.
ccggcctcccaaagggaaagccatgggcatgggactgatt

SEQ ID NO: 268 - DNA, 40 bp, Artificial Sequence
  Synthesized de novo.
aaagcgcggtgcgtcccgcgcgcttggtccaatgatcaag

SEQ ID NO: 269 - DNA, 40 bp, Artificial Sequence
  Synthesized de novo.
gaaacgcgggccgtcccgtgttccgaatccagtggatttg

SEQ ID NO: 270 - DNA, 40 bp, Artificial Sequence
  Synthesized de novo.
aaaacgcctggctagcgtgtccccctcaagggggcgaaga

SEQ ID NO: 271 - DNA, 40 bp, Artificial Sequence
  Synthesized de novo.
aaagcgtacggcggccaacgcagccagccccttggggctg

SEQ ID NO: 272 - DNA, 40 bp, Artificial Sequence
  Synthesized de novo.
tggatacattgtaccagagattaacacgttgaaattattt

SEQ ID NO: 273 - DNA, 40 bp, Artificial Sequence
  Synthesized de novo.
tgacagttggttgggatcaaatttgttctgtgcgcgtcac

SEQ ID NO: 274 - DNA, 40 bp, Artificial Sequence
  Synthesized de novo.
cttaacacagttctaacagtttgtttgaatagagagcaga

SEQ ID NO: 275 - DNA, 40 bp, Artificial Sequence
  Synthesized de novo.
ggggggcaacccccctcggcaaaagccgaaagtggttgca

SEQ ID NO: 276 - DNA, 40 bp, Artificial Sequence
  Synthesized de novo.
gtgggaaagttttgaagcgttaacgtgttgaggaaaagac

SEQ ID NO: 277 - DNA, 40 bp, Artificial Sequence
  Synthesized de novo.
ggacattgccgagttgaaaccttggtttccggctggaaac

SEQ ID NO: 278 - DNA, 40 bp, Artificial Sequence
  Synthesized de novo.
ttttcagagcttaagttgtttttaatttttgccgagagac

SEQ ID NO: 279 - DNA, 40 bp, Artificial Sequence
  Synthesized de novo.
cttaacgtagtgctgacagttttttattagagagcagatc

SEQ ID NO: 280 - DNA, 40 bp, Artificial Sequence
  Synthesized de novo.
gctcaacgtagttctaacagttttttaattagagagcaga

SEQ ID NO: 281 - DNA, 40 bp, Artificial Sequence
  Synthesized de novo.
cttaacgtagttctaacagttttttattagagagcagatc

SEQ ID NO: 282 - DNA, 40 bp, Artificial Sequence
  Synthesized de novo.
agggttggtggaaggaattgcccgcatcagccagtcgtga

SEQ ID NO: 283 - DNA, 40 bp, Artificial Sequence
  Synthesized de novo.
tgttaagttgttaacacgtttgaataatttctactgaaag

SEQ ID NO: 284 - DNA, 40 bp, Artificial Sequence
  Synthesized de novo.
caaggcttgagttgtttataatagtcgtttttctcgcaga

SEQ ID NO: 285 - DNA, 40 bp, Artificial Sequence
  Synthesized de novo.
ctgttgaacgtgagtgtgttgagaaaaagacagcttagga

SEQ ID NO: 286 - DNA, 40 bp, Artificial Sequence
  Synthesized de novo.
tagtgatctaaagtgaggagttattcttactgtcatcaaa

SEQ ID NO: 287 - DNA, 40 bp, Artificial Sequence
  Synthesized de novo.
taggcaataaacacatttggattaattttaatcgttcgtt

SEQ ID NO: 288 - DNA, 40 bp, Artificial Sequence
  Synthesized de novo.
ttgaaagagacatttttttttctttcatcagccgtgaacg

SEQ ID NO: 289 - DNA, 40 bp, Artificial Sequence
  Synthesized de novo.
taataacttaacttgactgcgaacagttttttagcaggga

SEQ ID NO: 290 - DNA, 40 bp, Artificial Sequence
  Synthesized de novo.
tgtgattgtggatattctttctgcaagttttgtcgtgaac

SEQ ID NO: 291 - DNA, 40 bp, Artificial Sequence
  Synthesized de novo.
agagattagtgcagtttaaacagttttttagaacggaaga

SEQ ID NO: 292 - DNA, 40 bp, Artificial Sequence
  Synthesized de novo.
ttgattaacgcggtttgaacagttttttggagcttttgat

SEQ ID NO: 293 - DNA, 40 bp, Artificial Sequence
  Synthesized de novo.
gtgagattaacacagtgccggcagtttctttgagcgttga

SEQ ID NO: 294 - DNA, 40 bp, Artificial Sequence
  Synthesized de novo.
tggtttgaaagagatattcttttgtttctaccagtcgtga

SEQ ID NO: 295 - DNA, 40 bp, Artificial Sequence
  Synthesized de novo.
aattttaaatcaaaggagttgttcggaaaagtgaccttgg

SEQ ID NO: 296 - DNA, 40 bp, Artificial Sequence
  Synthesized de novo.
tcagcgaaggccgaaaagaggctagccatgcccttagtag

SEQ ID NO: 297 - DNA, 40 bp, Artificial Sequence
  Synthesized de novo.
tcaatttggttcagggcctccctccagcgacggccgaact

SEQ ID NO: 298 - DNA, 40 bp, Artificial Sequence
  Synthesized de novo.
ccaattcggttagggcccctcccagcgacggccgaaccgg

SEQ ID NO: 299 - DNA, 40 bp, Artificial Sequence
  Synthesized de novo.
cgattgggttagggagccctcctagcgacggccgaaccgt

SEQ ID NO: 300 - DNA, 40 bp, Artificial Sequence
  Synthesized de novo.
atagatttggcataggcaacaccccgatgcgaaggccgaa

SEQ ID NO: 301 - DNA, 40 bp, Artificial Sequence; identical to SEQ ID NO: 284
  Synthesized de novo.

SEQ ID NO: 302 - DNA, 40 bp, Artificial Sequence
  Synthesized de novo.
atagtggtctgcggaaccggtgagtacaccggaattgccg

SEQ ID NO: 303 - DNA, 40 bp, Artificial Sequence
  Synthesized de novo.
atagtggtcttcggaaccggtgagtacaccggaatcgccg

SEQ ID NO: 304 - DNA, 40 bp, Artificial Sequence
  Synthesized de novo.
acgcaatgactcggcgccgactcggcgaccggccaaaagg

SEQ ID NO: 305 - DNA, 40 bp, Artificial Sequence
  Synthesized de novo.
gggatttcccctgcccgtctgcagaagggtggagccaacc

SEQ ID NO: 306 - DNA, 40 bp, Artificial Sequence
  Synthesized de novo.
aacttctgtcttcacgcggaaagcgcctagccatggcgtt

SEQ ID NO: 307 - DNA, 40 bp, Artificial Sequence
  Synthesized de novo.
ggcccgaaaggcggtggatcctgtgtgttagggttcgtag

SEQ ID NO: 308 - DNA, 40 bp, Artificial Sequence
  Synthesized de novo.
aactactgtcttcacgcagaaagcgtctagccatggcgtt

SEQ ID NO: 309 - DNA, 40 bp, Artificial Sequence
  Synthesized de novo.
tggttaataaaaaattgcaaactttctttatggccttctt

SEQ ID NO: 310 - DNA, 40 bp, Artificial Sequence
  Synthesized de novo.
ggcaggtcaaacaaaaacccggtgctgctattgtgggagt

SEQ ID NO: 311 - DNA, 40 bp, Artificial Sequence
  Synthesized de novo.
ccatgggcatgggactgattctcggaatcatgaactacgc

SEQ ID NO: 312 - DNA, 40 bp, Artificial Sequence
  Synthesized de novo.
cgcttggtccaatgatcaagcttaagaggatgctttttgg

SEQ ID NO: 313 - DNA, 40 bp, Artificial Sequence
  Synthesized de novo.
ttccgaatccagtggatttggtaaagaggacggttggaaa

SEQ ID NO: 314 - DNA, 40 bp, Artificial Sequence
  Synthesized de novo.
ccccctcaagggggcgaagaactattcggagaatgctaga

SEQ ID NO: 315 - DNA, 40 bp, Artificial Sequence
  Synthesized de novo.
cagccagccccttggggctggcaaaaaggctgcttggaga

SEQ ID NO: 316 - DNA, 40 bp, Artificial Sequence
  Synthesized de novo.
ttaacacgttgaaattatttctgaaaacagaaaatcagaa

SEQ ID NO: 317 - DNA, 40 bp, Artificial Sequence
  Synthesized de novo.
atttgttctgtgcgcgtcacgccactttttgtggcgggaa

SEQ ID NO: 318 - DNA, 40 bp, Artificial Sequence
  Synthesized de novo.
ttgtttgaatagagagcagatctctggaaaaatgaaccaa

SEQ ID NO: 319 - DNA, 40 bp, Artificial Sequence
  Synthesized de novo.
aaaagccgaaagtggttgcaaagaaatcgcggcagcgacc

SEQ ID NO: 320 - DNA, 40 bp, Artificial Sequence
  Synthesized de novo.
taacgtgttgaggaaaagacagcttaggagaacaagagct

SEQ ID NO: 321 - DNA, 40 bp, Artificial Sequence
  Synthesized de novo.
cttggtttccggctggaaaccacgtcgctcttcgtcaaat

SEQ ID NO: 322 - DNA, 40 bp, Artificial Sequence
  Synthesized de novo.
tttaatttttgccgagagaccgtgaggttgaacccggcaa

SEQ ID NO: 323 - DNA, 40 bp, Artificial Sequence
  Synthesized de novo.
tttttattagagagcagatctctgatgaacaaccaacgga

SEQ ID NO: 324 - DNA, 40 bp, Artificial Sequence
  Synthesized de novo.
ttttttaattagagagcagatctctgatgaataaccaacg

SEQ ID NO: 325 - DNA, 40 bp, Artificial Sequence
  Synthesized de novo.
cccgcatcagccagtcgtgaacgtgttgagaaaaagacag

SEQ ID NO: 326 - DNA, 40 bp, Artificial Sequence
  Synthesized de novo.
tgaataatttctactgaaagggtagagaaaaggagttttg

SEQ ID NO: 327 - DNA, 40 bp, Artificial Sequence
  Synthesized de novo.
atagtcgtttttctcgcagaaatgggaaaggacgacggta

SEQ ID NO: 328 - DNA, 40 bp, Artificial Sequence
  Synthesized de novo.
gagaaaaagacagcttaggagaacaagagctgggagtggt

SEQ ID NO: 329 - DNA, 40 bp, Artificial Sequence
  Synthesized de novo.
ttattcttactgtcatcaaacactacaaataaacacgttg

SEQ ID NO: 330 - DNA, 40 bp, Artificial Sequence
  Synthesized de novo.
attaattttaatcgttcgttgagcgattagcagagaactg

SEQ ID NO: 331 - DNA, 40 bp, Artificial Sequence
  Synthesized de novo.
tctttcatcagccgtgaacgtgttgagaaaaagacagctt

SEQ ID NO: 332 - DNA, 40 bp, Artificial Sequence
  Synthesized de novo.
gaacagttttttagcagggaattacccaatgtctaaaaaa

SEQ ID NO: 333 - DNA, 40 bp, Artificial Sequence
  Synthesized de novo.
ctgcaagttttgtcgtgaacgtgttgagaaaaagacagct

SEQ ID NO: 334 - DNA, 40 bp, Artificial Sequence
  Synthesized de novo.
cagttttttagaacggaagataaccatgactaaaaaacca

SEQ ID NO: 335 - DNA, 40 bp, Artificial Sequence
  Synthesized de novo.
agttttttggagcttttgatttcaaatgtctaaaaaacca

SEQ ID NO: 336 - DNA, 40 bp, Artificial Sequence
  Synthesized de novo.
gcagtttctttgagcgttgattttcaatgtctaagaaacc

SEQ ID NO: 337 - DNA, 40 bp, Artificial Sequence
  Synthesized de novo.
tttgtttctaccagtcgtgaacgtgttgagaaaaagacag

SEQ ID NO: 338 - DNA, 40 bp, Artificial Sequence
  Synthesized de novo.
gttcggaaaagtgaccttggttcgttatgaatagaggaag

SEQ ID NO: 339 - DNA, 40 bp, Artificial Sequence
  Synthesized de novo.
gctagccatgcccttagtaggactagcaaaaggaggggac

SEQ ID NO: 340 - DNA, 40 bp, Artificial Sequence
  Synthesized de novo.
cctccagcgacggccgaactgggctagccatgcccacagt

SEQ ID NO: 341 - DNA, 40 bp, Artificial Sequence
  Synthesized de novo.
cccagcgacggccgaaccgggttagccatacccgtagtag

SEQ ID NO: 342 - DNA, 40 bp, Artificial Sequence
  Synthesized de novo.
cctagcgacggccgaaccgtgttaaccatacacgtagtag

SEQ ID NO: 343 - DNA, 40 bp, Artificial Sequence
  Synthesized de novo.
taataattaggcctagggaacaaatccctctcagcgaagg

SEQ ID NO: 344 - DNA, 40 bp, Artificial Sequence
  Synthesized de novo.
accccgatgcgaaggccgaaaagggctaaccatgccctta

SEQ ID NO: 345 - DNA, 40 bp, Artificial Sequence; identical to SEQ ID NO: 315
  Synthesized de novo.

SEQ ID NO: 346 - DNA, 40 bp, Artificial Sequence
  Synthesized de novo.
tgagtacaccggaattgccgggatgaccgggtcctttctt

SEQ ID NO: 347 - DNA, 40 bp, Artificial Sequence
  Synthesized de novo.
tgagtacaccggaatcgccgggatgaccgggtcctttctt

SEQ ID NO: 348 - DNA, 40 bp, Artificial Sequence
  Synthesized de novo.
ctcggcgaccggccaaaaggtggtggatgggtgatgacag

SEQ ID NO: 349 - DNA, 40 bp, Artificial Sequence
  Synthesized de novo.
gcagaagggtggagccaaccaccttagtatgtaggcggcg

SEQ ID NO: 350 - DNA, 40 bp, Artificial Sequence
  Synthesized de novo.
aagcgcctagccatggcgttagtacgagtgtcgtgcagcc

SEQ ID NO: 351 - DNA, 40 bp, Artificial Sequence
  Synthesized de novo.
ctgtgtgttagggttcgtaggtggtaaatcccagcacagg

SEQ ID NO: 352 - DNA, 40 bp, Artificial Sequence
  Synthesized de novo.
aagcgtctagccatggcgttagtatgagtgtcgtgcagcc

SEQ ID NO: 353 - DNA, 40 bp, Artificial Sequence
  Synthesized de novo.
aagcgtctagccatggcgttagtatgagtgtcgtacagcc

SEQ ID NO: 354 - DNA, 40 bp, Artificial Sequence
  Synthesized de novo.
actttctttatggccttcttccaaattctgctggcggtgt

SEQ ID NO: 355 - DNA, 40 bp, Artificial Sequence
  Synthesized de novo.
ggtgctgctattgtgggagtcatgcattacgtgacccacc

SEQ ID NO: 356 - DNA, 40 bp, Artificial Sequence
  Synthesized de novo.
ctcggaatcatgaactacgcctcccacatcgctcttggca

SEQ ID NO: 357 - DNA, 40 bp, Artificial Sequence
  Synthesized de novo.
cttaagaggatgctttttggcctgctggatgggagggggc

SEQ ID NO: 358 - DNA, 40 bp, Artificial Sequence
  Synthesized de novo.
gtaaagaggacggttggaaaactgatcaatggcgttggtc

SEQ ID NO: 359 - DNA, 40 bp, Artificial Sequence
  Synthesized de novo.
actattcggagaatgctagatgtgagaggagcaccaagat

SEQ ID NO: 360 - DNA, 40 bp, Artificial Sequence
  Synthesized de novo.
gcaaaaaggctgcttggagacgcgtttgctggtaggggac

SEQ ID NO: 361 - DNA, 40 bp, Artificial Sequence
  Synthesized de novo.
ctgaaaacagaaaatcagaatcagacgcgatgaataatcg

SEQ ID NO: 362 - DNA, 40 bp, Artificial Sequence
  Synthesized de novo.
gccactttttgtggcgggaatgtgcgaaaataacaggaaa

SEQ ID NO: 363 - DNA, 40 bp, Artificial Sequence
  Synthesized de novo.
tctctggaaaaatgaaccaacgaaaaaaggtggttagacc

SEQ ID NO: 364 - DNA, 40 bp, Artificial Sequence
  Synthesized de novo.
aagaaatcgcggcagcgaccgactgctttgccaagagcat

SEQ ID NO: 365 - DNA, 40 bp, Artificial Sequence
  Synthesized de novo.
agcttaggagaacaagagctggggatggccaaaggagccg

SEQ ID NO: 366 - DNA, 40 bp, Artificial Sequence
  Synthesized de novo.
cacgtcgctcttcgtcaaatgacgaaaggcaaaatgaaaa

SEQ ID NO: 367 - DNA, 40 bp, Artificial Sequence
  Synthesized de novo.
cgtgaggttgaacccggcaagaaatgaagaggaaggattt

SEQ ID NO: 368 - DNA, 40 bp, Artificial Sequence
  Synthesized de novo.
tctgatgaacaaccaacggaagaagacgggaaaaccgtct

SEQ ID NO: 369 - DNA, 40 bp, Artificial Sequence
  Synthesized de novo.
tctctgatgaataaccaacggaaaaaggcgaaaaacacgc

SEQ ID NO: 370 - DNA, 40 bp, Artificial Sequence
  Synthesized de novo.
tctgatgaacaaccaacggaaaaagacgggtcgaccgtct

SEQ ID NO: 371 - DNA, 40 bp, Artificial Sequence
  Synthesized de novo.
gaaaaagacagcttaggagaacaagagctggggatggccg

SEQ ID NO: 372 - DNA, 40 bp, Artificial Sequence
  Synthesized de novo.
ggtagagaaaaggagttttgcttctcatggcaacaagagg

SEQ ID NO: 373 - DNA, 40 bp, Artificial Sequence
  Synthesized de novo.
aatgggaaaggacgacggtaagaagaagaaggggccgggc

SEQ ID NO: 374 - DNA, 40 bp, Artificial Sequence
  Synthesized de novo.
gaacaagagctgggagtggttatgatgaccacttctaaag

SEQ ID NO: 375 - DNA, 40 bp, Artificial Sequence
  Synthesized de novo.
cactacaaataaacacgttgaaattatttccggaagaaca

SEQ ID NO: 376 - DNA, 40 bp, Artificial Sequence
  Synthesized de novo.
gagcgattagcagagaactgaccagaacatgtctggtcgt

SEQ ID NO: 377 - DNA, 40 bp, Artificial Sequence
  Synthesized de novo.
gagaaaaagacagcttaggagaacaagagctggggatggg

SEQ ID NO: 378 - DNA, 40 bp, Artificial Sequence
  Synthesized de novo.
attacccaatgtctaaaaaaccaggaaaacccggtagaaa

SEQ ID NO: 379 - DNA, 40 bp, Artificial Sequence
  Synthesized de novo.
gagaaaaagacagcttaggagaacaagagctgggaatggc

SEQ ID NO: 380 - DNA, 40 bp, Artificial Sequence
  Synthesized de novo.
taaccatgactaaaaaaccaggagggcccggtaaaaaccg

SEQ ID NO: 381 - DNA, 40 bp, Artificial Sequence
  Synthesized de novo.
ttcaaatgtctaaaaaaccaggaggacccgggaagccccg

SEQ ID NO: 382 - DNA, 40 bp, Artificial Sequence
  Synthesized de novo.
ttttcaatgtctaagaaaccaggagggcccggaagaaacc

SEQ ID NO: 383 - DNA, 40 bp, Artificial Sequence
  Synthesized de novo.
gagaaaaagacagcttaggagaacaagagctggggatggt

SEQ ID NO: 384 - DNA, 40 bp, Artificial Sequence
  Synthesized de novo.
ttcgttatgaatagaggaagcttgaagaaggggcctccgg

SEQ ID NO: 385 - DNA, 40 bp, Artificial Sequence
  Synthesized de novo.
gactagcaaaaggaggggactagcggtagcagtgagttca

SEQ ID NO: 386 - DNA, 40 bp, Artificial Sequence
  Synthesized de novo.
gggctagccatgcccacagtaggactagcaaacggaggga

SEQ ID NO: 387 - DNA, 40 bp, Artificial Sequence
  Synthesized de novo.
gttagccatacccgtagtaggactagcaaacgggaggact

SEQ ID NO: 388 - DNA, 40 bp, Artificial Sequence
  Synthesized de novo.
gttaaccatacacgtagtaggactagcagacgggaggact

SEQ ID NO: 389 - DNA, 40 bp, Artificial Sequence
  Synthesized de novo.
gctagccatgcccttagtaggactagcataatgagggggg

SEQ ID NO: 390 - DNA, 40 bp, Artificial Sequence
  Synthesized de novo.
aagggctaaccatgcccttagtaggactagcaaaaaatcg

SEQ ID NO: 391 - DNA, 40 bp, Artificial Sequence
  Synthesized de novo.
atctcgatgtctaagaaaccaggagggcccggcaagagcc

SEQ ID NO: 392 - DNA, 29 bp, Artificial Sequence
  Synthesized de novo.
accattgaagcaatcactagaccaatcca

SEQ ID NO: 393 - DNA, 25 bp, Artificial Sequence
  Synthesized de novo.
ttcaagcctccaagctgtgccttgg

SEQ ID NO: 394 - DNA, 20 bp, Artificial Sequence
  Synthesized de novo.
cgtgcgggctcccctctccc

SEQ ID NO: 395 - DNA, 28 bp, Artificial Sequence
  Synthesized de novo.
tttgtattaggaggctgtaggcataaat

SEQ ID NO: 396 - DNA, 40 bp, Artificial Sequence
  Synthesized de novo.
ttttcctgctggtggctccagttccggaacagtaaaccct

SEQ ID NO: 397 - DNA, 40 bp, Artificial Sequence
  Synthesized de novo.
ttggatggctttgggacatggacatagatccctataaaga

SEQ ID NO: 398 - DNA, 40 bp, Artificial Sequence
  Synthesized de novo.
agctaggagattgctttggtggcattataactgtttattg

SEQ ID NO: 399 - DNA, 40 bp, Artificial Sequence
  Synthesized de novo.
ggctagacgattgctttggtggcattacaactgtttactg

SEQ ID NO: 400 - DNA, 40 bp, Artificial Sequence
  Synthesized de novo.
ggctaggagattgctttggtggcattacaactgtttactg

SEQ ID NO: 401 - DNA, 40 bp, Artificial Sequence
  Synthesized de novo.
gctcgcagattgctttggtggcattacaattgcctcctct

SEQ ID NO: 402 - DNA, 40 bp, Artificial Sequence
  Synthesized de novo.
ggctaggagattgctttggtggcattataattgtttactg

SEQ ID NO: 403 - DNA, 40 bp, Artificial Sequence
  Synthesized de novo.
tttcctgctggtggctcaacttcaagcattgtcaaccctg

SEQ ID NO: 404 - DNA, 40 bp, Artificial Sequence
  Synthesized de novo.
tccggaacagtaaaccctgttccgactactgcctcaccca

SEQ ID NO: 405 - DNA, 40 bp, Artificial Sequence
  Synthesized de novo.
gacatagatccctataaagaatttggttcatcctaccagt

SEQ ID NO: 406 - DNA, 40 bp, Artificial Sequence
  Synthesized de novo.
gacatagatccctataaagaatttggttcttcttatcagt

SEQ ID NO: 407 - DNA, 40 bp, Artificial Sequence
  Synthesized de novo.
gagatcaagggagaaagcctactcctccaactccacctct

SEQ ID NO: 408 - DNA, 20 bp, Artificial Sequence
  Synthesized de novo.
cctcctcttcctcctcttcc

SEQ ID NO: 409 - DNA, 20 bp, Artificial Sequence
  Synthesized de novo.
gtttttaaatactgacagta

SEQ ID NO: 410 - DNA, 21 bp, Artificial Sequence
  Synthesized de novo.
ttataacatgtattttgaaaa

SEQ ID NO: 411 - DNA, 23 bp, Artificial Sequence
  Synthesized de novo.
gtggactttgccagcctgtaccc

SEQ ID NO: 412 - DNA, 25 bp, Artificial Sequence
  Synthesized de novo.
gataattacgattacaggcatcttt

SEQ ID NO: 413 - DNA, 27 bp, Artificial Sequence
  Synthesized de novo.
gacaccatctaccagtgctacaacagc

SEQ ID NO: 414 - DNA, 40 bp, Artificial Sequence
  Synthesized de novo.
ttacttccggggcgtaacccgaaagttctcaccacaccca

SEQ ID NO: 415 - DNA, 23 bp, Artificial Sequence
  Synthesized de novo.
gtggccatgagccgccgctacga

SEQ ID NO: 416 - DNA, 40 bp, Artificial Sequence
  Synthesized de novo.
tgagattttttctcagcatacaaaggttactgatctgaat

SEQ ID NO: 417 - DNA, 21 bp, Artificial Sequence
  Synthesized de novo.
ggcgtcctggccgtggtccat

SEQ ID NO: 418 - DNA, 40 bp, Artificial Sequence
  Synthesized de novo.
gggggagctaaccctaaccctagctctaaccctaacccta

SEQ ID NO: 419 - DNA, 22 bp, Artificial Sequence
  Synthesized de novo.
gttggacctgttatatagaaga

SEQ ID NO: 420 - DNA, 40 bp, Artificial Sequence
  Synthesized de novo.
gggttcgaccctaaaccctaccatccttcggccgacagca

SEQ ID NO: 421 - DNA, 40 bp, Artificial Sequence
  Synthesized de novo.
gaacgagcgcttatttgctcggtcacggaccaaatcgtat

SEQ ID NO: 422 - DNA, 29 bp, Artificial Sequence
  Synthesized de novo.
gtgattacattgggagaacaggggtacaa

SEQ ID NO: 423 - DNA, 24 bp, Artificial Sequence
  Synthesized de novo.
ggtcatgttcatcaacaacaagcg

SEQ ID NO: 424 - DNA, 40 bp, Artificial Sequence
  Synthesized de novo.
gcccgcgatcccgccaatacccataatgcacctgggcact

SEQ ID NO: 425 - DNA, 40 bp, Artificial Sequence
  Synthesized de novo.
ggaaccaaacggacgcgttatttttcgcggtcggcggaga

SEQ ID NO: 426 - DNA, 40 bp, Artificial Sequence
  Synthesized de novo.
gacggagacggggtccagcacagcagacagacacggggca

SEQ ID NO: 427 - DNA, 40 bp, Artificial Sequence
  Synthesized de novo.
ttaggaagtagatgatttttgcaggaagttcattatgtga

SEQ ID NO: 428 - DNA, 40 bp, Artificial Sequence
  Synthesized de novo.
gacggcgtgaaacagccccaagtagggtgtccgcaccaca

SEQ ID NO: 429 - DNA, 40 bp, Artificial Sequence
  Synthesized de novo.
gaacagttttcgtgtctcacagatagctttatcatttcat

SEQ ID NO: 430 - DNA, 40 bp, Artificial Sequence
  Synthesized de novo.
ttgactgtggtgggtggtatgtctttgtctatgtgtatca

SEQ ID NO: 431 - DNA, 40 bp, Artificial Sequence
  Synthesized de novo.
gccccctcccctagtacacagagcccagcaggcagctaca

SEQ ID NO: 432 - DNA, 40 bp, Artificial Sequence
  Synthesized de novo.
gaccattcgatgcaaatgttgggtgtgtgcaccccactat

SEQ ID NO: 433 - DNA, 40 bp, Artificial Sequence
  Synthesized de novo.
gggcgcagtgggggttgggttgtatgggggttaggttgca

SEQ ID NO: 434 - DNA, 40 bp, Artificial Sequence
  Synthesized de novo.
gcggggcgaccatcgggggggatgggattttttgccggga

SEQ ID NO: 435 - DNA, 40 bp, Artificial Sequence
  Synthesized de novo.
gggaaggtgacagagggtaaaagggctctctgccgtgcga

SEQ ID NO: 436 - DNA, 40 bp, Artificial Sequence
  Synthesized de novo.
gtggcgggggacagaggggaacgtgtgcgtgcttgtggaa

SEQ ID NO: 437 - DNA, 40 bp, Artificial Sequence
  Synthesized de novo.
ggctgcctgcctgctcgctggcctgcttgctgaggggaca

SEQ ID NO: 438 - DNA, 40 bp, Artificial Sequence
  Synthesized de novo.
gaaagttctcaccacacccacttccagggcgtaacccgaa

SEQ ID NO: 439 - DNA, 40 bp, Artificial Sequence
  Synthesized de novo.
tggcggccagtcccaagatgtcgggaccagccccgcaaaa

SEQ ID NO: 440 - DNA, 40 bp, Artificial Sequence
  Synthesized de novo.
ggcgggcgggggcggggtgggggatgggcgcggagcgcga

SEQ ID NO: 441 - DNA, 40 bp, Artificial Sequence
  Synthesized de novo.
ggcccttgtgtaaacctgtctttcagaccttgttggacat

SEQ ID NO: 442 - DNA, 40 bp, Artificial Sequence
  Synthesized de novo.
gcggggtgggggaggggcgcgcttaggtggcggggcgcga

SEQ ID NO: 443 - DNA, 40 bp, Artificial Sequence
  Synthesized de novo.
tttccattggggtgaatggggagggggtgggggatgggca

SEQ ID NO: 444 - DNA, 40 bp, Artificial Sequence
  Synthesized de novo.
tcgccatcgtgataagcacacgttatgggcggtgggggat

SEQ ID NO: 445 - DNA, 40 bp, Artificial Sequence
  Synthesized de novo.
tcaatagaagcgaacgggcgctggcgagattcggcccaaa

SEQ ID NO: 446 - DNA, 40 bp, Artificial Sequence
  Synthesized de novo.
gttactgatctgaatagcctctctttattttagccagcca

SEQ ID NO: 447 - DNA, 40 bp, Artificial Sequence
  Synthesized de novo.
gcgacggcctcgaagaaaaccgtagaggggagtgggggat

SEQ ID NO: 448 - DNA, 40 bp, Artificial Sequence
  Synthesized de novo.
gggcggggccgggaccgcggggcggggccggccccgccca

SEQ ID NO: 449 - DNA, 40 bp, Artificial Sequence
  Synthesized de novo.
gtgcgcgcgcgcggcgggcgtggggggcggggccgcggga

SEQ ID NO: 450 - DNA, 40 bp, Artificial Sequence
  Synthesized de novo.
tctaaccctaaccctaaccctagctctaaccctaacccta

SEQ ID NO: 451 - DNA, 40 bp, Artificial Sequence
  Synthesized de novo.
gaggggcggcgcccgcgggggagcggccggctccggggga

SEQ ID NO: 452 - DNA, 40 bp, Artificial Sequence
  Synthesized de novo.
gggccgcggcgagcgcgccgggacgcgcgccgggacgcga

SEQ ID NO: 453 - DNA, 40 bp, Artificial Sequence
  Synthesized de novo.
gcgggcgcggcggcgcggcgccacgcgcgcgcactcgcga

SEQ ID NO: 454 - DNA, 40 bp, Artificial Sequence
  Synthesized de novo.
tttatacccccggggttaacaggtacccgtcttatttcaa

SEQ ID NO: 455 - DNA, 40 bp, Artificial Sequence
  Synthesized de novo.
gctagccctaaccctaaccctaaccctaggtctagcccta

SEQ ID NO: 456 - DNA, 40 bp, Artificial Sequence
  Synthesized de novo.
ggggtattaaccctaaccctaaccctaggccctaacccta

SEQ ID NO: 457 - DNA, 40 bp, Artificial Sequence
  Synthesized de novo.
tcacggaccaaatcgtattagtcgccctgcagagatagct

SEQ ID NO: 458 - DNA, 40 bp, Artificial Sequence
  Synthesized de novo.
tgtcggctacaggcagaatgaacgcgcagcattgcgcgga

SEQ ID NO: 459 - DNA, 40 bp, Artificial Sequence
  Synthesized de novo.
gctcttaaacctttgcaaaatttttgcgtgccgttttgca

SEQ ID NO: 460 - DNA, 40 bp, Artificial Sequence
  Synthesized de novo.
gcctgtaattgttgcgccctacctcttttggctggcggct

SEQ ID NO: 461 - DNA, 40 bp, Artificial Sequence
  Synthesized de novo.
gcctgtaattgttgcgccctacctgttttggctggcggct

SEQ ID NO: 462 - DNA, 40 bp, Artificial Sequence
  Synthesized de novo.
gcacgggtagcggaaggaaatcaggaacgcgccctctaca

SEQ ID NO: 463 - DNA, 40 bp, Artificial Sequence
  Synthesized de novo.
ggggggccacaaagggcggccgaggagaggggcccgggaa

SEQ ID NO: 464 - DNA, 40 bp, Artificial Sequence
  Synthesized de novo.
ggcggcgcgtcggccggtccggcggtcggtcggggcggct

SEQ ID NO: 465 - DNA, 40 bp, Artificial Sequence
  Synthesized de novo.
tgcacctgggcactctcttttttcctttccttatccaaga

SEQ ID NO: 466 - DNA, 40 bp, Artificial Sequence
  Synthesized de novo.
tcgcggtcggcggagagagccgccgtggggggctttcgct

SEQ ID NO: 467 - DNA, 40 bp, Artificial Sequence
  Synthesized de novo.
gacacggggcactgggaaagcacagaacaacacacggaga

SEQ ID NO: 468 - DNA, 40 bp, Artificial Sequence
  Synthesized de novo.
ggggggctttgcggcgtcggtcgcgggcgcgaggaggcga

SEQ ID NO: 469 - DNA, 40 bp, Artificial Sequence
  Synthesized de novo.
ggggggctatatttttgtcctctagagggcgctgttgcat

SEQ ID NO: 470 - DNA, 40 bp, Artificial Sequence
  Synthesized de novo.
gttgcgtgtgtggacggcgactagttgcgtgtggtgcgga

SEQ ID NO: 471 - DNA, 40 bp, Artificial Sequence
  Synthesized de novo.
gttcattatgtgatggtgtgtagtgttttgttggtgtgta

SEQ ID NO: 472 - DNA, 40 bp, Artificial Sequence
  Synthesized de novo.
gggtgaaatttggagttgcgtgtgtggacggcgacggcga

SEQ ID NO: 473 - DNA, 40 bp, Artificial Sequence
  Synthesized de novo.
ttggcgcaaggttgcgcgtgtcgcttgccgcgggcgtgca

SEQ ID NO: 474 - DNA, 40 bp, Artificial Sequence
  Synthesized de novo.
gtgtccgcaccacacgacggtcatttgctgggtgggagga

SEQ ID NO: 475 - DNA, 40 bp, Artificial Sequence
  Synthesized de novo.
gatagctttatcatttcattaacaggaacagaaaacctaa

SEQ ID NO: 476 - DNA, 40 bp, Artificial Sequence
  Synthesized de novo.
gtctttgtctatgtgtatcaaaaaataaaaatcatgaaaa

SEQ ID NO: 477 - DNA, 40 bp, Artificial Sequence
  Synthesized de novo.
gcagctacagccgctcaacgcgagtccctccccttgctca

SEQ ID NO: 478 - DNA, 40 bp, Artificial Sequence
  Synthesized de novo.
gtgtgtgcaccccactatctctggttctgcaaagcttgct

SEQ ID NO: 479 - DNA, 40 bp, Artificial Sequence
  Synthesized de novo.
tgtatgggggttaggttgcataggatgggggctgggtgca

SEQ ID NO: 480 - DNA, 40 bp, Artificial Sequence
  Synthesized de novo.
gggattttttgccgggaaacccccccccgccagcctttaa

SEQ ID NO: 481 - DNA, 40 bp, Artificial Sequence
  Synthesized de novo.
gggctctctgccgtgcgaggctcctcacagacacacagca

SEQ ID NO: 482 - DNA, 40 bp, Artificial Sequence
  Synthesized de novo.
gtgtgcgtgcttgtggaacactatggcctgctggcctgct

SEQ ID NO: 483 - DNA, 40 bp, Artificial Sequence
  Synthesized de novo.
tgctgaggggacagtaggcctgcttgctcgctggcctgct

SEQ ID NO: 484 - DNA, 40 bp, Artificial Sequence
  Synthesized de novo.
gaaagttctcaccacacccacttccggggcgtaacccgaa

SEQ ID NO: 485 - DNA, 40 bp, Artificial Sequence
  Synthesized de novo.
tggcggccagtcccaagatgtcgggaccggccccgcaaaa

SEQ ID NO: 486 - DNA, 40 bp, Artificial Sequence
  Synthesized de novo.
gatgggcgcggagcgcgagggtagggttggcacactgcca

SEQ ID NO: 487 - DNA, 40 bp, Artificial Sequence
  Synthesized de novo.
gaccttgttggacatcctgtacaatcaagatgttcctgta

SEQ ID NO: 488 - DNA, 40 bp, Artificial Sequence
  Synthesized de novo.
ttaggtggcggggcgcgaggctagggttggcaccaagcca

SEQ ID NO: 489 - DNA, 40 bp, Artificial Sequence
  Synthesized de novo.
gaccttgttggacatcccgtacaatcaagatgttcctgta

SEQ ID NO: 490 - DNA, 40 bp, Artificial Sequence
  Synthesized de novo.
ggtgggggatgggcactcactaagaattggcaaggtgcca

SEQ ID NO: 491 - DNA, 40 bp, Artificial Sequence
  Synthesized de novo.
gttatgggcggtgggggatgggatttcaatggaggccaca

SEQ ID NO: 492 - DNA, 40 bp, Artificial Sequence
  Synthesized de novo.
gagattcggcccaaatcctcggataaattttcgcctcgaa

SEQ ID NO: 493 - DNA, 40 bp, Artificial Sequence
  Synthesized de novo.
tctttattttagccagccaccgccccccttaggtgcgcat

SEQ ID NO: 494 - DNA, 40 bp, Artificial Sequence
  Synthesized de novo.
ggggagtgggggatgggatttttttattaggccacgccca

SEQ ID NO: 495 - DNA, 40 bp, Artificial Sequence
  Synthesized de novo.
gccggccgcggccgcgggggcggggcgcggggcgcgggga

SEQ ID NO: 496 - DNA, 40 bp, Artificial Sequence
  Synthesized de novo.
ggggggcggggccgcgggagcggggggaggagcgggggga

SEQ ID NO: 497 - DNA, 40 bp, Artificial Sequence
  Synthesized de novo.
tctaaccctaaccctaaccctaagtctaaccctgacccta

SEQ ID NO: 498 - DNA, 40 bp, Artificial Sequence
  Synthesized de novo.
gcccgcccgccgccgccgcccgccttcgcgccccccccca

SEQ ID NO: 499 - DNA, 40 bp, Artificial Sequence
  Synthesized de novo.
gcgcgccgggacgcgaaaaacgcgcccccccaaacgccga

SEQ ID NO: 500 - DNA, 40 bp, Artificial Sequence
  Synthesized de novo.
gcgcgcggggccgggagcccgcccgggagcccgcccggga

SEQ ID NO: 501 - DNA, 40 bp, Artificial Sequence
  Synthesized de novo.
ggtacccgtcttatttcaaaccctaaacctaaccacgact

SEQ ID NO: 502 - DNA, 40 bp, Artificial Sequence
  Synthesized de novo.
tctagccctaaccctaaccctaaccctaggtctagcccta

SEQ ID NO: 503 - DNA, 40 bp, Artificial Sequence
  Synthesized de novo.
tctaaccctaaccctaaccctaaccctaggtctaacccta

SEQ ID NO: 504 - DNA, 40 bp, Artificial Sequence
  Synthesized de novo.
gccctgcagagatagctagcccatggagctccgcgggcca

SEQ ID NO: 505 - DNA, 40 bp, Artificial Sequence
  Synthesized de novo.
gcagcattgcgcggacacagtgggtgaccgaagcacacca

SEQ ID NO: 506 - DNA, 40 bp, Artificial Sequence
  Synthesized de novo.
gccgttttgcacgttcataacgttttcctttggtttccta

SEQ ID NO: 507 - DNA, 40 bp, Artificial Sequence
  Synthesized de novo.
ttggctggcggctattgccgcctcgtgtttcacggcctca

SEQ ID NO: 508 - DNA, 40 bp, Artificial Sequence
  Synthesized de novo.
ggaacgcgccctctacatgaccgcgcatgcgcggggccga

SEQ ID NO: 509 - DNA, 40 bp, Artificial Sequence
  Synthesized de novo.
ggagaggggcccgggaaaccccccctcggggccctcccaa

SEQ ID NO: 510 - DNA, 40 bp, Artificial Sequence
  Synthesized de novo.
gcgtccgccgtgggcgttgtgggcgtgtgccggggcggct

SEQ ID NO: 511 - DNA, 40 bp, Artificial Sequence
  Synthesized de novo.
tttcctttccttatccaagatgtccgcccattgccaggta

SEQ ID NO: 512 - DNA, 40 bp, Artificial Sequence
  Synthesized de novo.
gccgtggggggctttcgctccgccccgtcgccgggcccga

SEQ ID NO: 513 - DNA, 40 bp, Artificial Sequence
  Synthesized de novo.
gacacacagagacccgcacagaggcgacaccgttcacaca

SEQ ID NO: 514 - DNA, 40 bp, Artificial Sequence
  Synthesized de novo.
tcgcgggcgcgaggaggcgagaggcggcggggggagagga

SEQ ID NO: 515 - DNA, 40 bp, Artificial Sequence
  Synthesized de novo.
gagggcgctgttgcatcgatggtcgtgagggtgctcctga

SEQ ID NO: 516 - DNA, 40 bp, Artificial Sequence
  Synthesized de novo.
tgcgtgtggtgcggaggacggcgacggcgaataaaagcga

SEQ ID NO: 517 - DNA, 40 bp, Artificial Sequence
  Synthesized de novo.
gtgttttgttggtgtgtagtgaccacgtggggttcctaat

SEQ ID NO: 518 - DNA, 40 bp, Artificial Sequence
  Synthesized de novo.
ggacggcgacggcgactagttgcgtgtgctgcggtgggta

SEQ ID NO: 519 - DNA, 40 bp, Artificial Sequence
  Synthesized de novo.
gggcgtgcagggaggccgaagcggcggccggagccgtgca

SEQ ID NO: 520 - DNA, 40 bp, Artificial Sequence
  Synthesized de novo.
tcatttgctgggtgggaggagcctaaatggccttaaaact

SEQ ID NO: 521 - DNA, 40 bp, Artificial Sequence
  Synthesized de novo.
ttaagagctcttgtagaagagtacaatggagcatgcaagg

SEQ ID NO: 522 - DNA, 29 bp, Artificial Sequence
  Synthesized de novo.
aaagaagagcaattgcaacacccggtatg

SEQ ID NO: 523 - DNA, 40 bp, Artificial Sequence
  Synthesized de novo.
gttctttgtgaaccttgtatttgtgagaacccaacatgtc

SEQ ID NO: 524 - DNA, 40 bp, Artificial Sequence
  Synthesized de novo.
tagcatacttactgacagccagacagcgaccaaaagaatt

SEQ ID NO: 525 - DNA, 40 bp, Artificial Sequence
  Synthesized de novo.
gatgtacctatacaggcagcaatttcaacaacattcccat

SEQ ID NO: 526 - DNA, 40 bp, Artificial Sequence
  Synthesized de novo.
gtacaatggagcatgcaaggaagcaccgaaagagatgtcg

SEQ ID NO: 527 - DNA, 40 bp, Artificial Sequence
  Synthesized de novo.
acaaatttaatggcatttgtagccacaaaaatgttagaga

SEQ ID NO: 528 - DNA, 40 bp, Artificial Sequence
  Synthesized de novo.
ttgtgagaacccaacatgtctaggaataacaatcccacag

SEQ ID NO: 529 - DNA, 40 bp, Artificial Sequence
  Synthesized de novo.
gaatctgatgtcgcagtctcgcactcgcgagatactaaca

SEQ ID NO: 530 - DNA, 40 bp, Artificial Sequence
  Synthesized de novo.
aggcaccaaacgatcctatgaacagatggaaactggtgga

SEQ ID NO: 531 - DNA, 40 bp, Artificial Sequence
  Synthesized de novo.
aaatctaatgtcgcagtctcgcacccgcgagatactcaca

SEQ ID NO: 532 - DNA, 40 bp, Artificial Sequence
  Synthesized de novo.
agatctaatgtcgcagtcccgcactcgcgagatactaaca

SEQ ID NO: 533 - DNA, 40 bp, Artificial Sequence
  Synthesized de novo.
gaacctgatgtcgcagtctcgcactcgcgagatactgaca

SEQ ID NO: 534 - DNA, 40 bp, Artificial Sequence
  Synthesized de novo.
aatttcaacaacattcccatacaccggtgttcccccttat

SEQ ID NO: 535 - DNA, 40 bp, Artificial Sequence
  Synthesized de novo.
aagcaccgaaagagatgtcgaagcaattcacagactacaa

SEQ ID NO: 536 - DNA, 40 bp, Artificial Sequence
  Synthesized de novo.
agccacaaaaatgttagagagacaagaagatttagacaca

SEQ ID NO: 537 - DNA, 40 bp, Artificial Sequence
  Synthesized de novo.
taggaataacaatcccacaggcaggtttcgtaagaagcgc

SEQ ID NO: 538 - DNA, 40 bp, Artificial Sequence
  Synthesized de novo.
gcactcgcgagatactaacaaaaaccacagtggaccatat

SEQ ID NO: 539 - DNA, 40 bp, Artificial Sequence
  Synthesized de novo.
aacagatggaaactggtggagaacgccagaatgccactga

SEQ ID NO: 540 - DNA, 40 bp, Artificial Sequence
  Synthesized de novo.
gcacccgcgagatactcacaaaaaccaccgtggaccatat

SEQ ID NO: 541 - DNA, 40 bp, Artificial Sequence
  Synthesized de novo.
gcactcgcgagatactaacaaaaaccactgtggatcatat

SEQ ID NO: 542 - DNA, 40 bp, Artificial Sequence
  Synthesized de novo.
gcactcgcgagatactgacaaaaaccacagtggaccatat

SEQ ID NO: 543 - DNA, 40 bp, Artificial Sequence
  Synthesized de novo.
acaccggtgttcccccttattctcatggaacgggaacagg

SEQ ID NO: 544 - DNA, 20 bp, Artificial Sequence
  Synthesized de novo.
tttgaaaatcccgcctttga

SEQ ID NO: 545 - DNA, 20 bp, Artificial Sequence
  Synthesized de novo.
tattcaggatggtgatatgg

SEQ ID NO: 546 - DNA, 20 bp, Artificial Sequence
  Synthesized de novo.
cattatacttttataaaaca

SEQ ID NO: 547 - DNA, 20 bp, Artificial Sequence
  Synthesized de novo.
ctttttttgaaaggctttgg

SEQ ID NO: 548 - DNA, 22 bp, Artificial Sequence
  Synthesized de novo.
ccgtaaaaagaagggagttgca

SEQ ID NO: 549 - DNA, 40 bp, Artificial Sequence
  Synthesized de novo.
ccatgctgtaacccacttgctaatgcagctgcaggaacaa

SEQ ID NO: 550 - DNA, 40 bp, Artificial Sequence
  Synthesized de novo.
tatgaccagaagaggtatatataaatagctgagacgttcg

SEQ ID NO: 551 - DNA, 40 bp, Artificial Sequence
  Synthesized de novo.
ttttgccgaagtatgcagatggaggattcttatctaccaa

SEQ ID NO: 552 - DNA, 21 bp, Artificial Sequence
  Synthesized de novo.
taagtgaccaagaagacgagg

SEQ ID NO: 553 - DNA, 40 bp, Artificial Sequence
  Synthesized de novo.
ttactttggatactcttatgctaccttgccatttttgcag

SEQ ID NO: 554 - DNA, 40 bp, Artificial Sequence
  Synthesized de novo.
ccgcttttaccacggacgctacgagaactctgtgtgtgga

SEQ ID NO: 555 - DNA, 22 bp, Artificial Sequence
  Synthesized de novo.
ctggaaatctttttttaaaagg

SEQ ID NO: 556 - DNA, 20 bp, Artificial Sequence
  Synthesized de novo.
cctttagatgaggaagggaa

SEQ ID NO: 557 - DNA, 21 bp, Artificial Sequence
  Synthesized de novo.
tcaggcaaaatatgtaaaaga

SEQ ID NO: 558 - DNA, 40 bp, Artificial Sequence
  Synthesized de novo.
cgtccgtgacctgtgcttggaactagacatagaagtcgga

SEQ ID NO: 559 - DNA, 22 bp, Artificial Sequence
  Synthesized de novo.
ctcagcgaccaagaggacgagg

SEQ ID NO: 560 - DNA, 40 bp, Artificial Sequence
  Synthesized de novo.
tagaggaacggattggtacaccacagatggcatcaacaag

SEQ ID NO: 561 - DNA, 40 bp, Artificial Sequence
  Synthesized de novo.
tatataagaagaccccattggctatggatttgttactgcg

SEQ ID NO: 562 - DNA, 40 bp, Artificial Sequence
  Synthesized de novo.
ttacttttggagatttatacctaccttgtgcattttgcaa

SEQ ID NO: 563 - DNA, 20 bp, Artificial Sequence
  Synthesized de novo.
tttttaaagggtataccaaa

SEQ ID NO: 564 - DNA, 40 bp, Artificial Sequence
  Synthesized de novo.
ccaataacccaagtgagaacaatttcaatccagaggattg

SEQ ID NO: 565 - DNA, 24 bp, Artificial Sequence
  Synthesized de novo.
tctgataatgattgggaaagacgc

SEQ ID NO: 566 - DNA, 40 bp, Artificial Sequence
  Synthesized de novo.
taccataggcatattcaagtttttgcctgtatcgttttcg

SEQ ID NO: 567 - DNA, 21 bp, Artificial Sequence
  Synthesized de novo.
tcaatatagggtgtttagggt

SEQ ID NO: 568 - DNA, 40 bp, Artificial Sequence
  Synthesized de novo.
cgcttaggttgttgcacccaagcacttctaggactcagga

SEQ ID NO: 569 - DNA, 40 bp, Artificial Sequence
  Synthesized de novo.
tgtatataaaagatgtgagaaacacaccacaatactatgg

SEQ ID NO: 570 - DNA, 40 bp, Artificial Sequence
  Synthesized de novo.
cgaattcggttgtatataaacagaagcaggatgcacacaa

SEQ ID NO: 571 - DNA, 40 bp, Artificial Sequence
  Synthesized de novo.
tatttaaatgaactgtgtgcacaattgcatctgccagtag

SEQ ID NO: 572 - DNA, 40 bp, Artificial Sequence
  Synthesized de novo.
tatccaggaagaacctcaaaccttaaggtaagcatggcgg

SEQ ID NO: 573 - DNA, 40 bp, Artificial Sequence
  Synthesized de novo.
cgaaaacggttgtatataaaccagccctaaaatttagcaa

SEQ ID NO: 574 - DNA, 40 bp, Artificial Sequence
  Synthesized de novo.
taactataaaaagctgctgacagaccccggttttcacatg

SEQ ID NO: 575 - DNA, 40 bp, Artificial Sequence
  Synthesized de novo.
cgatggcggttgagctatataaagatatcagttggccatg

SEQ ID NO: 576 - DNA, 40 bp, Artificial Sequence
  Synthesized de novo.
cggtacatataaaaaccaacccaaaaaacctgatctgggg

SEQ ID NO: 577 - DNA, 40 bp, Artificial Sequence
  Synthesized de novo.
cggtgcatataaaaagctcctgaaactttggttttttgtg

SEQ ID NO: 578 - DNA, 40 bp, Artificial Sequence
  Synthesized de novo.
tcaggtttctataaaagctcacaccgcacaaggttaggga

SEQ ID NO: 579 - DNA, 40 bp, Artificial Sequence
  Synthesized de novo.
ttctataaaaggaggggtaaacctgcagatttttgcccag

SEQ ID NO: 580 - DNA, 40 bp, Artificial Sequence
  Synthesized de novo.
ccgaccgattgcggtttttttaacaccaaaggttatatag

SEQ ID NO: 581 - DNA, 40 bp, Artificial Sequence
  Synthesized de novo.
tccggtcggagagaccggattcggtcttctggcattctag

SEQ ID NO: 582 - DNA, 40 bp, Artificial Sequence
  Synthesized de novo.
tctataaaagcaccacaccgcacaaggttgctatcacttg

SEQ ID NO: 583 - DNA, 40 bp, Artificial Sequence
  Synthesized de novo.
ttccaagaccgatttcggtcctggcaactgtttcggtcgg

SEQ ID NO: 584 - DNA, 40 bp, Artificial Sequence
  Synthesized de novo.
tatcatataaatactgctgaacagtagatttcttcagaag

SEQ ID NO: 585 - DNA, 40 bp, Artificial Sequence
  Synthesized de novo.
tacggtgcatataaaagagctgatcagcacagatttgaag

SEQ ID NO: 586 - DNA, 40 bp, Artificial Sequence
  Synthesized de novo.
tgctacctgcaaacttattatgtgatgaattagtaaccga

SEQ ID NO: 587 - DNA, 40 bp, Artificial Sequence
  Synthesized de novo.
ttagtattaccacaaaatttactctgtggtgaagaacttg

SEQ ID NO: 588 - DNA, 40 bp, Artificial Sequence
  Synthesized de novo.
ctttcactacatggacctttgggctccatctgcattatga

SEQ ID NO: 589 - DNA, 40 bp, Artificial Sequence
  Synthesized de novo.
tactgagccattttttttttttcggcttcaactctggcaa

SEQ ID NO: 590 - DNA, 40 bp, Artificial Sequence
  Synthesized de novo.
tactgagccatttttttttttcaggctgcactctggcaaa

SEQ ID NO: 591 - DNA, 40 bp, Artificial Sequence
  Synthesized de novo.
tttttattggccataaaactaattgttctggccaagttgg

SEQ ID NO: 592 - DNA, 40 bp, Artificial Sequence
  Synthesized de novo.
ctgcaggaacaactgcatgcacttaactatcccacagatg

SEQ ID NO: 593 - DNA, 40 bp, Artificial Sequence
  Synthesized de novo.
taaatagctgagacgttcgtaaactttaggatgcagatgg

SEQ ID NO: 594 - DNA, 40 bp, Artificial Sequence
  Synthesized de novo.
cgatttttaatatttctctttttgatgtgcatcttccttg

SEQ ID NO: 595 - DNA, 40 bp, Artificial Sequence
  Synthesized de novo.
ctttttccttataaaactctggtgggaatttctcttggga

SEQ ID NO: 596 - DNA, 40 bp, Artificial Sequence
  Synthesized de novo.
tataaaaagggacagtgcatttctactaaatcctgtccag

SEQ ID NO: 597 - DNA, 40 bp, Artificial Sequence
  Synthesized de novo.
tgccatttttgcagtagttttatggatcttaataataagg

SEQ ID NO: 598 - DNA, 40 bp, Artificial Sequence
  Synthesized de novo.
tctaagcggatggagctttgcagttcccttcaaccatgaa

SEQ ID NO: 599 - DNA, 40 bp, Artificial Sequence
  Synthesized de novo.
tattaagggaccgctttgggggttcagcacaaatggctga

SEQ ID NO: 600 - DNA, 40 bp, Artificial Sequence
  Synthesized de novo.
cgagaactctgtgtgtggagagggcaggagtttcctaatg

SEQ ID NO: 601 - DNA, 40 bp, Artificial Sequence
  Synthesized de novo.
ttcaaaacgaccgataacggtaagtcttggcacgtaggtg

SEQ ID NO: 602 - DNA, 40 bp, Artificial Sequence
  Synthesized de novo.
tctgatcctggcagtcactcctggaacaacaccgatccag

SEQ ID NO: 603 - DNA, 40 bp, Artificial Sequence
  Synthesized de novo.
tactgtaccgggcgcgataccaaatatgccacctgcgcaa

SEQ ID NO: 604 - DNA, 40 bp, Artificial Sequence
  Synthesized de novo.
ttataatacaaacagctagtatataaatacaggcagtgaa

SEQ ID NO: 605 - DNA, 40 bp, Artificial Sequence
  Synthesized de novo.
cttttactttactttgcgctttttgtgattctcctttgga

SEQ ID NO: 606 - DNA, 40 bp, Artificial Sequence
  Synthesized de novo.
ctgttctgggtttactaccggaggaattggtattaccatg

SEQ ID NO: 607 - DNA, 40 bp, Artificial Sequence
  Synthesized de novo.
ttcaatcgggcgcggtcacattatacttagtcatctcttg

SEQ ID NO: 608 - DNA, 40 bp, Artificial Sequence
  Synthesized de novo.
ctcgaggaaacaccgcaggcgcccgccaaaagtctgccaa

SEQ ID NO: 609 - DNA, 40 bp, Artificial Sequence
  Synthesized de novo.
ctgccaacttttagggtataaataagtagtttctacggaa

SEQ ID NO: 610 - DNA, 40 bp, Artificial Sequence
  Synthesized de novo.
tagaagtcggacatctgaacctaaattgtgtgtactgcaa

SEQ ID NO: 611 - DNA, 40 bp, Artificial Sequence
  Synthesized de novo.
ctatgtatgtggtgccatgagccactgaccaatctggacg

SEQ ID NO: 612 - DNA, 40 bp, Artificial Sequence
  Synthesized de novo.
cggtgtgggatccgtcgggcctgcaagctgttgcgagacg

SEQ ID NO: 613 - DNA, 40 bp, Artificial Sequence
  Synthesized de novo.
ctgcggtagccggatggataggaccgtgcactcctttgtg

SEQ ID NO: 614 - DNA, 40 bp, Artificial Sequence
  Synthesized de novo.
ctaccttgtgcattttgcaatgacatcttaacctttttgg

SEQ ID NO: 615 - DNA, 40 bp, Artificial Sequence
  Synthesized de novo.
tcggtgcatatataagtgctgcagtacactgctggacaga

SEQ ID NO: 616 - DNA, 40 bp, Artificial Sequence
  Synthesized de novo.
tcctactggatactgactctagttctggttctgagactga

SEQ ID NO: 617 - DNA, 40 bp, Artificial Sequence
  Synthesized de novo.
taacaggttgttattgccaactaccatcatcactttcaag

SEQ ID NO: 618 - DNA, 40 bp, Artificial Sequence
  Synthesized de novo.
cttggaacttaaatatagcacgaaaaccgtttcgaggcgg

SEQ ID NO: 619 - DNA, 40 bp, Artificial Sequence
  Synthesized de novo.
ttttgcctgtatcgttttcgtatcctgtaataatatccaa

SEQ ID NO: 620 - DNA, 40 bp, Artificial Sequence
  Synthesized de novo.
ccggtacatataaaagcggttgtagaaaacagttatttgg

SEQ ID NO: 621 - DNA, 40 bp, Artificial Sequence
  Synthesized de novo.
cttctaggactcaggatgctgagcagtaaattcttgggaa

SEQ ID NO: 622 - DNA, 40 bp, Artificial Sequence
  Synthesized de novo.
tcacatataaactgccgcaccgctgaaggtgctctcacaa

SEQ ID NO: 623 - DNA, 40 bp, Artificial Sequence
  Synthesized de novo.
tgcgctcaggagtgtctctgtgcgcgataagcattccatg

SEQ ID NO: 624 - DNA, 40 bp, Artificial Sequence
  Synthesized de novo.
ctataaaatacacaggtaagactctgcacaggaccagatg

SEQ ID NO: 625 - DNA, 40 bp, Artificial Sequence
  Synthesized de novo.
tccctggatgctctaaaatgcaagaatcataaatatagga

SEQ ID NO: 626 - DNA, 40 bp, Artificial Sequence
  Synthesized de novo.
ctagctacgtgcaaaacagctatgttcgaggatcctagag

SEQ ID NO: 627 - DNA, 40 bp, Artificial Sequence
  Synthesized de novo.
cgaaaacggtacatataaaagcactgtgtacaacacccag

SEQ ID NO: 628 - DNA, 40 bp, Artificial Sequence
  Synthesized de novo.
ccacaatactatggcgcgctttgaggatccaacacggcga

SEQ ID NO: 629 - DNA, 40 bp, Artificial Sequence
  Synthesized de novo.
ccatgccctaggaacatctttttgctttgcaaagagtatg

SEQ ID NO: 630 - DNA, 40 bp, Artificial Sequence
  Synthesized de novo.
tgccagtagaagagatattaattaattgttgcttttgcaa

SEQ ID NO: 631 - DNA, 40 bp, Artificial Sequence
  Synthesized de novo.
tatctgagatcgcatcggttgctggcactgtgtatctgag

SEQ ID NO: 632 - DNA, 40 bp, Artificial Sequence
  Synthesized de novo.
taaggtaagcatggcggaggaaagcccatgcacaattaaa

SEQ ID NO: 633 - DNA, 40 bp, Artificial Sequence
  Synthesized de novo.
cgaaatcggtgatatataaaccagcccaaaaattgagcaa

SEQ ID NO: 634 - DNA, 40 bp, Artificial Sequence
  Synthesized de novo.
ccagccctaaaatttagcaaacgaggcattatggaaagtg

SEQ ID NO: 635 - DNA, 40 bp, Artificial Sequence
  Synthesized de novo.
cgaaaccggttagtataaaagcagacattttatgcaccaa

SEQ ID NO: 636 - DNA, 40 bp, Artificial Sequence
  Synthesized de novo.
tacatataaaacaaggcccgtagcatctgcagaagctatg

SEQ ID NO: 637 - DNA, 40 bp, Artificial Sequence
  Synthesized de novo.
ccggttttcacatggacctgaaaccttttgcaagaaccaa

SEQ ID NO: 638 - DNA, 40 bp, Artificial Sequence
  Synthesized de novo.
tatataaaccaccctgggcagtggtccttgttaaggcaga

SEQ ID NO: 639 - DNA, 40 bp, Artificial Sequence
  Synthesized de novo.
tgtgttatggatctaccagagaccataagagacctctgcg

SEQ ID NO: 640 - DNA, 40 bp, Artificial Sequence
  Synthesized de novo.
taaagaaaccgtagggtcagcaaagcacactcatctatgg

SEQ ID NO: 641 - DNA, 40 bp, Artificial Sequence
  Synthesized de novo.
taaccgaaaacggtgtaaccgaaatgggtgcatatataaa

SEQ ID NO: 642 - DNA, 40 bp, Artificial Sequence
  Synthesized de novo.
ctggggccactatgtctgcacgttgcggctccacagctag

SEQ ID NO: 643 - DNA, 40 bp, Artificial Sequence
  Synthesized de novo.
ttttttgtggcaatggtagactgccctggcgagccaaacg

SEQ ID NO: 644 - DNA, 40 bp, Artificial Sequence
  Synthesized de novo.
tccctggagagatctcttcgcgttttctgcctcatgccag

SEQ ID NO: 645 - DNA, 40 bp, Artificial Sequence
  Synthesized de novo.
ctatgaactggacctgcaggacctgaacataacctgcgtg

SEQ ID NO: 646 - DNA, 40 bp, Artificial Sequence
  Synthesized de novo.
tttatataaaaaggcccaccgcacaagttttcacagacgg

SEQ ID NO: 647 - DNA, 40 bp, Artificial Sequence
  Synthesized de novo.
tgcccaggaatgccttaatggcgcggccactgagcatacg

SEQ ID NO: 648 - DNA, 40 bp, Artificial Sequence
  Synthesized de novo.
ttatatagcgaccgttacagttaaaccggggtacagaatg

SEQ ID NO: 649 - DNA, 40 bp, Artificial Sequence
  Synthesized de novo.
tcggtcttctggcattctaggtataagctgtgcctgtacg

SEQ ID NO: 650 - DNA, 40 bp, Artificial Sequence
  Synthesized de novo.
ctatcacttgtcactctgctcagacccttccttctgcatg

SEQ ID NO: 651 - DNA, 40 bp, Artificial Sequence
  Synthesized de novo.
ctggcaactgtttcggtcggtatatatagcatgttttggg

SEQ ID NO: 652 - DNA, 40 bp, Artificial Sequence
  Synthesized de novo.
cttcagaagctgatggagccacaatttcctactgatttgg

SEQ ID NO: 653 - DNA, 40 bp, Artificial Sequence
  Synthesized de novo.
tcagcacagatttgaaggagactgatggagcctcagagag

SEQ ID NO: 654 - DNA, 40 bp, Artificial Sequence
  Synthesized de novo.
tgtgatgaattagtaaccgaggaggaggagcagcaggacg

SEQ ID NO: 655 - DNA, 40 bp, Artificial Sequence
  Synthesized de novo.
ctgtggtgaagaacttgtggaggaggaggaggaggagcag

SEQ ID NO: 656 - DNA, 40 bp, Artificial Sequence
  Synthesized de novo.
tattgctgctctgggtttcatttcactttctgtcattgtg

SEQ ID NO: 657 - DNA, 40 bp, Artificial Sequence
  Synthesized de novo.
ttacatgtaaaactgttcacctgccaaacatacatgaatg

SEQ ID NO: 658 - DNA, 40 bp, Artificial Sequence
  Synthesized de novo.
tttacatgcaaactgttcacctgccaaacatatatgaatg

SEQ ID NO: 659 - DNA, 40 bp, Artificial Sequence
  Synthesized de novo.
tgttctggccaagttggctataaacagttcctgaaaggcg

SEQ ID NO: 660 - DNA, 40 bp, Artificial Sequence
  Synthesized de novo.
cttaactatcccacagatgatagcgacgactccacagacg

SEQ ID NO: 661 - DNA, 40 bp, Artificial Sequence
  Synthesized de novo.
tttaggatgcagatggaagaagacaggtttccaacaacag

SEQ ID NO: 662 - DNA, 40 bp, Artificial Sequence
  Synthesized de novo.
tcttccttgcatattttgtggctatattttggacctacag

SEQ ID NO: 663 - DNA, 40 bp, Artificial Sequence
  Synthesized de novo.
tttctcttgggacagatggacctgacatctgtacattcgg

SEQ ID NO: 664 - DNA, 40 bp, Artificial Sequence
  Synthesized de novo.
ctactaaatcctgtccagatggcagatggcagacctgcaa

SEQ ID NO: 665 - DNA, 40 bp, Artificial Sequence
  Synthesized de novo.
tcttaataataaggccagctaccttgcttctcaactaaag

SEQ ID NO: 666 - DNA, 40 bp, Artificial Sequence
  Synthesized de novo.
cttgcgtctcttactgtttattttgctcttttgggcaggg

SEQ ID NO: 667 - DNA, 40 bp, Artificial Sequence
  Synthesized de novo.
cgtggaccgactgcgagctccgtggtgtatcctttgcatg

SEQ ID NO: 668 - DNA, 40 bp, Artificial Sequence
  Synthesized de novo.
ttcctaatgtatctgtgacttgcaagtattgtaagaaatg

SEQ ID NO: 669 - DNA, 40 bp, Artificial Sequence
  Synthesized de novo.
taagtcttggcacgtaggtggttatttgatcgttgggatg

SEQ ID NO: 670 - DNA, 40 bp, Artificial Sequence
  Synthesized de novo.
cgatccagtggctttgccaaaagcagtttaaacctgccaa

SEQ ID NO: 671 - DNA, 40 bp, Artificial Sequence
  Synthesized de novo.
tgcgcaattgttgttagcaactactttcattacctaacaa

SEQ ID NO: 672 - DNA, 40 bp, Artificial Sequence
  Synthesized de novo.
taaatacaggcagtgaaagtgttcccatcacaatggcaaa

SEQ ID NO: 673 - DNA, 40 bp, Artificial Sequence
  Synthesized de novo.
ttttgcagacagggctcgatttgcggtatctcaactgaag

SEQ ID NO: 674 - DNA, 40 bp, Artificial Sequence
  Synthesized de novo.
ttaccatgtaacttttgtagagcgcctctttcagtgcagg

SEQ ID NO: 675 - DNA, 40 bp, Artificial Sequence
  Synthesized de novo.
tatacttagtcatctcttgtggttgttaacaacaatcttg

SEQ ID NO: 676 - DNA, 40 bp, Artificial Sequence
  Synthesized de novo.
tctgccaagttttcttggcagaacatccatttggctgcaa

SEQ ID NO: 677 - DNA, 40 bp, Artificial Sequence
  Synthesized de novo.
taagtagtttctacggaaattttcaaatggaggagccacg

SEQ ID NO: 678 - DNA, 40 bp, Artificial Sequence
  Synthesized de novo.
tgtgtgtactgcaagaaatggctgtcagcgtctgataagg

SEQ ID NO: 679 - DNA, 40 bp, Artificial Sequence
  Synthesized de novo.
tctggacgcactgaactttcttgagtgtaacctctctatg

SEQ ID NO: 680 - DNA, 40 bp, Artificial Sequence
  Synthesized de novo.
ctgcaagctgttgcgagacgcagaagccacataccatacg

SEQ ID NO: 681 - DNA, 40 bp, Artificial Sequence
  Synthesized de novo.
ccgtgcactcctttgtggagcggctgggaattcctcggga

SEQ ID NO: 682 - DNA, 40 bp, Artificial Sequence
  Synthesized de novo.
cttaacctttttggataagtctgcgtttgcatttggacag

SEQ ID NO: 683 - DNA, 40 bp, Artificial Sequence
  Synthesized de novo.
ctgctggacagattgggaaatgttttttcccaatcctgag

SEQ ID NO: 684 - DNA, 40 bp, Artificial Sequence
  Synthesized de novo.
ctgaaactgcagaagcaacctctccttcatcttctgaaga

SEQ ID NO: 685 - DNA, 40 bp, Artificial Sequence
  Synthesized de novo.
taccatcatcactttcaagtttttgcttgtatcgttttcg

SEQ ID NO: 686 - DNA, 40 bp, Artificial Sequence
  Synthesized de novo.
cgaaaaccgtttcgaggcgggctatggcgcgaccatggag

SEQ ID NO: 687 - DNA, 40 bp, Artificial Sequence
  Synthesized de novo.
tatcctgtaataatatccaatatatgtatacataaataaa

SEQ ID NO: 688 - DNA, 40 bp, Artificial Sequence
  Synthesized de novo.
tgtagaaaacagttatttgggggcaatgtctgctactgaa

SEQ ID NO: 689 - DNA, 40 bp, Artificial Sequence
  Synthesized de novo.
taaattcttgggaaaacagtgcttatggtgcagggtagaa

SEQ ID NO: 690 - DNA, 40 bp, Artificial Sequence
  Synthesized de novo.
cgctgaaggtgctctcacaaataggtgggactatgccatg

SEQ ID NO: 691 - DNA, 40 bp, Artificial Sequence
  Synthesized de novo.
ttccatgtgtgttttgtggcaatctgctaagctttgaaga

SEQ ID NO: 692 - DNA, 40 bp, Artificial Sequence
  Synthesized de novo.
tcagacagctttccgaaagcctctgtatcccatatattga

SEQ ID NO: 693 - DNA, 40 bp, Artificial Sequence
  Synthesized de novo.
ttatggcatgtgtcaaatttgcttagaggctttgctgcaa

SEQ ID NO: 694 - DNA, 40 bp, Artificial Sequence
  Synthesized de novo.
tgttcgaggatcctagagaacgacccagaacgctacatga

SEQ ID NO: 695 - DNA, 40 bp, Artificial Sequence
  Synthesized de novo.
cccaggacatccatggatcgtcagttatttgaaaatacag

SEQ ID NO: 696 - DNA, 40 bp, Artificial Sequence
  Synthesized de novo.
tccaacacggcgaccctacaagctacctgatctgtgcacg

SEQ ID NO: 697 - DNA, 40 bp, Artificial Sequence
  Synthesized de novo.
tgctttgcaaagagtatggtttggagctagaggatttgcg

SEQ ID NO: 698 - DNA, 40 bp, Artificial Sequence
  Synthesized de novo.
ttgttgcttttgcaattgccagctaagcgaaagatcaaag

SEQ ID NO: 699 - DNA, 40 bp, Artificial Sequence
  Synthesized de novo.
ctggcactgtgtatctgagatcgcaacgcattgccaggaa

SEQ ID NO: 700 - DNA, 40 bp, Artificial Sequence
  Synthesized de novo.
ttaaatctttgtgccttgcatttggactgcgttttgatga

SEQ ID NO: 701 - DNA, 40 bp, Artificial Sequence
  Synthesized de novo.
ccagcccaaaaattgagcaagcggggcataatggaaagtg

SEQ ID NO: 702 - DNA, 40 bp, Artificial Sequence
  Synthesized de novo.
tgcctccacgtctgcaacgaccatagaccagttgtgcaag

SEQ ID NO: 703 - DNA, 40 bp, Artificial Sequence
  Synthesized de novo.
tatgcaccaaaagagaactgcaatgtttcaggacccacag

SEQ ID NO: 704 - DNA, 40 bp, Artificial Sequence
  Synthesized de novo.
tctgcagaagctatgtccatgggtgcacaggaacccagaa

SEQ ID NO: 705 - DNA, 40 bp, Artificial Sequence
  Synthesized de novo.
ccaatccattctcagggttggattgtctgtggtgcagaga

SEQ ID NO: 706 - DNA, 40 bp, Artificial Sequence
  Synthesized de novo.
ttgttaaggcagaatggcaagtacttctgcctcatcacag

SEQ ID NO: 707 - DNA, 40 bp, Artificial Sequence
  Synthesized de novo.
ccataagagacctctgcgagctcctggaggcctctgcaga

SEQ ID NO: 708 - DNA, 40 bp, Artificial Sequence
  Synthesized de novo.
tccaactaatattttcctgctctgcaaggactacgaggtg

SEQ ID NO: 709 - DNA, 40 bp, Artificial Sequence
  Synthesized de novo.
tatgtccagcggggacgcataccccaccaacctcttcaga

SEQ ID NO: 710 - DNA, 40 bp, Artificial Sequence
  Synthesized de novo.
cgttgcggctccacagctagaactttatttgaattatgtg

SEQ ID NO: 711 - DNA, 40 bp, Artificial Sequence
  Synthesized de novo.
tgccctggcgagccaaacgaattgcccaggaccattcacg

SEQ ID NO: 712 - DNA, 40 bp, Artificial Sequence
  Synthesized de novo.
tgccagacaatgcattcacttctctaagctgtctttggtg

SEQ ID NO: 713 - DNA, 40 bp, Artificial Sequence
  Synthesized de novo.
ctgaacataacctgcgtgttttgcggaacagcattaacag

SEQ ID NO: 714 - DNA, 40 bp, Artificial Sequence
  Synthesized de novo.
tttcacagacggttcaggatacttctaatacatgcatgtg

SEQ ID NO: 715 - DNA, 40 bp, Artificial Sequence
  Synthesized de novo.
cgcggccactgagcatacgcagtctttgcttatcctggga

SEQ ID NO: 716 - DNA, 40 bp, Artificial Sequence
  Synthesized de novo.
ttaaaccggggtacagaatggctcgaccgacatcggtgga

SEQ ID NO: 717 - DNA, 40 bp, Artificial Sequence
  Synthesized de novo.
tgtttggagggcattcatggcgcgaccatcttcagtacaa

SEQ ID NO: 718 - DNA, 40 bp, Artificial Sequence
  Synthesized de novo.
ttctgcatgtctgctgattactatgaacatctatactgtg

SEQ ID NO: 719 - DNA, 40 bp, Artificial Sequence
  Synthesized de novo.
tatatatagcatgttttggggggcactgttatcaatggag

SEQ ID NO: 720 - DNA, 20 bp, Artificial Sequence
  Synthesized de novo.
agtgtaggtagaatgtttgc

SEQ ID NO: 721 - DNA, 20 bp, Artificial Sequence
  Synthesized de novo.
tatgggagggattgaggggt

SEQ ID NO: 722 - DNA, 40 bp, Artificial Sequence
  Synthesized de novo.
agattgctagtcccaaagaccagaatcatgggctgtaatg

SEQ ID NO: 723 - DNA, 40 bp, Artificial Sequence
  Synthesized de novo.
aaataaaaccttgaaagggagttttcccctctcttctttc

SEQ ID NO: 724 - DNA, 36 bp, Artificial Sequence
  Synthesized de novo.
attctgtgcctcatactcactcaaagagaaagaaat

SEQ ID NO: 725 - DNA, 26 bp, Artificial Sequence
  Synthesized de novo.
aacaaaccactcaggcaaggtgctct

SEQ ID NO: 726 - DNA, 40 bp, Artificial Sequence
  Synthesized de novo.
acctatggccttcgtgaccgacctcgagtcagagtagttc

SEQ ID NO: 727 - DNA, 20 bp, Artificial Sequence
  Synthesized de novo.
aaaaaacttaggagcaaagc

SEQ ID NO: 728 - DNA, 40 bp, Artificial Sequence
  Synthesized de novo.
acagtaagcccggaagtggtgttttgcgatttcgaggccg

SEQ ID NO: 729 - DNA, 22 bp, Artificial Sequence
  Synthesized de novo.
agtaagaaaaacttagggtgaa

SEQ ID NO: 730 - DNA, 40 bp, Artificial Sequence
  Synthesized de novo.
atcgtaggcccggaaccagtgtgctccggtgccggttgcg

SEQ ID NO: 731 - DNA, 40 bp, Artificial Sequence
  Synthesized de novo.
ggattaaagaactttaccgaaaggtaaggggaaagaaatc

SEQ ID NO: 732 - DNA, 40 bp, Artificial Sequence
  Synthesized de novo.
gattaggcccgaaggtgtctactttcgtggccgactgcgg

SEQ ID NO: 733 - DNA, 40 bp, Artificial Sequence
  Synthesized de novo.
atcgtgagcccagaagtggtgaattccgcggtcgacaacg

SEQ ID NO: 734 - DNA, 40 bp, Artificial Sequence
  Synthesized de novo.
accactagattcggtgccggtaacgattccagttttatac

SEQ ID NO: 735 - DNA, 40 bp, Artificial Sequence
  Synthesized de novo.
acttagggtcaatgatcctaccttaaagaacaaggctagg

SEQ ID NO: 736 - DNA, 40 bp, Artificial Sequence
  Synthesized de novo.
acttaggattaatgatcctatcaattggcacaggatttgg

SEQ ID NO: 737 - DNA, 40 bp, Artificial Sequence
  Synthesized de novo.
acttaggattcaagatcctattatcagggacaagagcagg

SEQ ID NO: 738 - DNA, 40 bp, Artificial Sequence
  Synthesized de novo.
acttaggagtaaagatcctactgtcggggggaggaggagg

SEQ ID NO: 739 - DNA, 40 bp, Artificial Sequence
  Synthesized de novo.
atcgtgagggggaagctggtggactccgggtccggagtcg

SEQ ID NO: 740 - DNA, 40 bp, Artificial Sequence
  Synthesized de novo.
aatttaggagtaaagctcctaaagcctggttccagtaccg

SEQ ID NO: 741 - DNA, 40 bp, Artificial Sequence
  Synthesized de novo.
aacttaggaaccaagacagtgacaattggtcttggtattg

SEQ ID NO: 742 - DNA, 40 bp, Artificial Sequence
  Synthesized de novo.
aacttaggaaccaagacaaacacttttggtcttggtattg

SEQ ID NO: 743 - DNA, 40 bp, Artificial Sequence
  Synthesized de novo.
aggagcaaagtagttctcctttggttggggacttggttgc

SEQ ID NO: 744 - DNA, 40 bp, Artificial Sequence
  Synthesized de novo.
atcttaggagcaaagattctccttcttggatctgggtttg

SEQ ID NO: 745 - DNA, 40 bp, Artificial Sequence
  Synthesized de novo.
aatgtctcttcaagggattcacctgagtgatctatcatac

SEQ ID NO: 746 - DNA, 40 bp, Artificial Sequence
  Synthesized de novo.
aatccttaaagaatcacagtacacaatcaaaagagatgtg

SEQ ID NO: 747 - DNA, 40 bp, Artificial Sequence
  Synthesized de novo.
atcatgggctgtaatgtgatgatggagcttgattatggtg

SEQ ID NO: 748 - DNA, 40 bp, Artificial Sequence
  Synthesized de novo.
acagaaaatgggcagtgaaacattgagtgtaattcaagtc

SEQ ID NO: 749 - DNA, 40 bp, Artificial Sequence
  Synthesized de novo.
acaataggcccggaaagttggctaatcgctagcgatctcg

SEQ ID NO: 750 - DNA, 40 bp, Artificial Sequence
  Synthesized de novo.
aaggtgtgaatctcgagtgcgagcccgaagcacaaactcg

SEQ ID NO: 751 - DNA, 40 bp, Artificial Sequence
  Synthesized de novo.
ataagaatttgataagtaccacttaaatttaactcccttg

SEQ ID NO: 752 - DNA, 40 bp, Artificial Sequence
  Synthesized de novo.
atcgtacgggtagaaggtgtgaaccccgagcgcgaggccg

SEQ ID NO: 753 - DNA, 40 bp, Artificial Sequence
  Synthesized de novo.
aataagaatttgataagtgctatttaagtctaaccttttc

SEQ ID NO: 754 - DNA, 40 bp, Artificial Sequence
  Synthesized de novo.
agtagttcaataaggacctatcaagtttgggcaatttttc

SEQ ID NO: 755 - DNA, 40 bp, Artificial Sequence
  Synthesized de novo.
aattaggatcaaagactccaatctactgggattgtctttg

SEQ ID NO: 756 - DNA, 40 bp, Artificial Sequence
  Synthesized de novo.
gaggccgggctcgatcctcacctttcattgtcgatagggg

SEQ ID NO: 757 - DNA, 40 bp, Artificial Sequence
  Synthesized de novo.
agggtcaaagtatccaccctgaagagcaggttccagaccc

SEQ ID NO: 758 - DNA, 40 bp, Artificial Sequence
  Synthesized de novo.
acgggttggttgaccgggcctttcaattcggactgttatc

SEQ ID NO: 759 - DNA, 40 bp, Artificial Sequence
  Synthesized de novo.
aaggtaaggggaaagaaatcctaagactgtaatcatgttg

SEQ ID NO: 760 - DNA, 40 bp, Artificial Sequence
  Synthesized de novo.
acttaggattaaagacattgactagaaggtcaagaaaagg

SEQ ID NO: 761 - DNA, 40 bp, Artificial Sequence
  Synthesized de novo.
acacttcttactaagccaatcaatactaactgccaaaatg

SEQ ID NO: 762 - DNA, 40 bp, Artificial Sequence
  Synthesized de novo.
aaatcgagcccagaagtggcaaagatcgctgtcgaatccg

SEQ ID NO: 763 - DNA, 40 bp, Artificial Sequence
  Synthesized de novo.
aattccgcggtcgacaacgaccaagaaacattgcttctgg

SEQ ID NO: 764 - DNA, 40 bp, Artificial Sequence
  Synthesized de novo.
aaagtaatactttaaagggacaagtcacagacatttgatc

SEQ ID NO: 765 - DNA, 40 bp, Artificial Sequence
  Synthesized de novo.
aacgattccagttttatactatctgatcattctctatctc

SEQ ID NO: 766 - DNA, 40 bp, Artificial Sequence
  Synthesized de novo.
aagaacaaggctagggttcagacctaccaatatggctagc

SEQ ID NO: 767 - DNA, 40 bp, Artificial Sequence
  Synthesized de novo.
aattggcacaggatttggataaaggttcacagtcatggcg

SEQ ID NO: 768 - DNA, 40 bp, Artificial Sequence
  Synthesized de novo.
attcaagatcctatcgactggagcaggcttaaggtaaagg

SEQ ID NO: 769 - DNA, 40 bp, Artificial Sequence
  Synthesized de novo.
atcagggacaagagcaggattagggatatccgagatggcc

SEQ ID NO: 770 - DNA, 40 bp, Artificial Sequence
  Synthesized de novo.
gggggaggaggaggagcaagatctttgactatggcgactc

SEQ ID NO: 771 - DNA, 40 bp, Artificial Sequence
  Synthesized de novo.
ggactccgggtccggagtcggtggacctgagtctagtagc

SEQ ID NO: 772 - DNA, 40 bp, Artificial Sequence
  Synthesized de novo.
ggcaccaaacctacaataatgtctggggtgctaagtgcac

SEQ ID NO: 773 - DNA, 40 bp, Artificial Sequence
  Synthesized de novo.
ggcttaggaacaaagtttcctatcgtgggatctggttccg

SEQ ID NO: 774 - DNA, 40 bp, Artificial Sequence
  Synthesized de novo.
gacaattgttcaaggttccaaaatgagtgatatatttgac

SEQ ID NO: 775 - DNA, 40 bp, Artificial Sequence
  Synthesized de novo.
aagaaatatatcatcatgagtgatatctttgaagaggcgg

SEQ ID NO: 776 - DNA, 40 bp, Artificial Sequence
  Synthesized de novo.
gggacttggttgctccacaatgtcgaaacttaataaggtg

SEQ ID NO: 777 - DNA, 40 bp, Artificial Sequence
  Synthesized de novo.
ggatctgggtttgggataaccaaaatgtcccgacttggac

SEQ ID NO: 778 - DNA, 40 bp, Artificial Sequence
  Synthesized de novo.
agtgatctatcatacaagcatgctatattaaaagagtctc

SEQ ID NO: 779 - DNA, 40 bp, Artificial Sequence
  Synthesized de novo.
acacaatcaaaagagatgtggggacaaccccagctgtcac

SEQ ID NO: 780 - DNA, 40 bp, Artificial Sequence
  Synthesized de novo.
ggagcttgattatggtggacgagctgcatggctggcattc

SEQ ID NO: 781 - DNA, 40 bp, Artificial Sequence
  Synthesized de novo.
agtgtaattcaagtcagattaaggaatatatatgataatg

SEQ ID NO: 782 - DNA, 40 bp, Artificial Sequence
  Synthesized de novo.
gatctcgatatcgatatctgttcttttttaagttcagacc

SEQ ID NO: 783 - DNA, 40 bp, Artificial Sequence
  Synthesized de novo.
aaactcgaggaagccttctgccaacatgtcttccgtattc

SEQ ID NO: 784 - DNA, 40 bp, Artificial Sequence
  Synthesized de novo.
aatttaactcccttggttagagatgggcagcaattcattg

SEQ ID NO: 785 - DNA, 40 bp, Artificial Sequence
  Synthesized de novo.
aaccccgagcgcgaggccgaagctcgaacctgagggaacc

SEQ ID NO: 786 - DNA, 40 bp, Artificial Sequence
  Synthesized de novo.
agtctaaccttttcaatcagaaatggggtgcaattcactg

SEQ ID NO: 787 - DNA, 40 bp, Artificial Sequence
  Synthesized de novo.
agtttgggcaatttttcgtccccgacacaaaaatgtcatc

SEQ ID NO: 788 - DNA, 40 bp, Artificial Sequence
  Synthesized de novo.
ggattgtctttgatcaattgtcataacaattatggagttg

SEQ ID NO: 789 - DNA, 40 bp, Artificial Sequence
  Synthesized de novo.
gataggggacattttgacactacctggaaaatgtcgtctg

SEQ ID NO: 790 - DNA, 40 bp, Artificial Sequence
  Synthesized de novo.
aagagcaggttccagacccttaactttgctgccaaagtac

SEQ ID NO: 791 - DNA, 40 bp, Artificial Sequence
  Synthesized de novo.
aattcggactgttatccaaattgctctcatcatgtcgagc

SEQ ID NO: 792 - DNA, 40 bp, Artificial Sequence
  Synthesized de novo.
agactgtaatcatgttgagtctattcgacacattcagtgc

SEQ ID NO: 793 - DNA, 40 bp, Artificial Sequence
  Synthesized de novo.
aaggtcaagaaaagggaactctataatttcaaaaatgttg

SEQ ID NO: 794 - DNA, 40 bp, Artificial Sequence
  Synthesized de novo.
atactaactgccaaaatgtcgtctgtgctgagtatgtttg

SEQ ID NO: 795 - DNA, 40 bp, Artificial Sequence
  Synthesized de novo.
aaagatcgctgtcgaatccgatagtgagattccgcttctg

SEQ ID NO: 796 - DNA, 40 bp, Artificial Sequence
  Synthesized de novo.
aagaaacattgcttctgggcacttgcacaggttgtctgtc

SEQ ID NO: 797 - DNA, 40 bp, Artificial Sequence
  Synthesized de novo.
aagtcacagacatttgatcttagtataaatttttataatg

SEQ ID NO: 798 - DNA, 40 bp, Artificial Sequence
  Synthesized de novo.
atctgatcattctctatctctattaaggatatttctagtc

SEQ ID NO: 799 - DNA, 40 bp, Artificial Sequence
  Synthesized de novo.
acctaccaatatggctagccttcttaaaagcctcacactg

SEQ ID NO: 800 - DNA, 40 bp, Artificial Sequence
  Synthesized de novo.
aaaggttcacagtcatggcgacacttcttcggagtctagc

SEQ ID NO: 801 - DNA, 40 bp, Artificial Sequence
  Synthesized de novo.
aggcttaaggtaaaggttctttaaaatggcttctctcttg

SEQ ID NO: 802 - DNA, 40 bp, Artificial Sequence
  Synthesized de novo.
gatatccgagatggccacacttttgaggagcttagcattg

SEQ ID NO: 803 - DNA, 40 bp, Artificial Sequence
  Synthesized de novo.
atctttgactatggcgactcttcttaaaagcttagcattg

SEQ ID NO: 804 - DNA, 40 bp, Artificial Sequence
  Synthesized de novo.
ggacctgagtctagtagcttccctgctgtgccaagatgtc

SEQ ID NO: 805 - DNA, 40 bp, Artificial Sequence
  Synthesized de novo.
gagttcaaagatgcaagacttgcatcaaaaggagagggtc

SEQ ID NO: 806 - DNA, 40 bp, Artificial Sequence
  Synthesized de novo.
gggatctggttccggttaactctacaaaccagataacatg

SEQ ID NO: 807 - DNA, 40 bp, Artificial Sequence
  Synthesized de novo.
aatgagtgatatatttgacgaggcggctagtttcagaagc

SEQ ID NO: 808 - DNA, 40 bp, Artificial Sequence
  Synthesized de novo.
atatctttgaagaggcggctagttttaggagttatcaatc

SEQ ID NO: 809 - DNA, 40 bp, Artificial Sequence
  Synthesized de novo.
aataaggtgttggatgagttccgtgacttcaaaaataacc

SEQ ID NO: 810 - DNA, 40 bp, Artificial Sequence
  Synthesized de novo.
aaatgtcccgacttggacctgcgttggatgagtttcgctc

SEQ ID NO: 811 - DNA, 40 bp, Artificial Sequence
  Synthesized de novo.
catattaagttaacggtttctgcgaagcgcttcgcaggaa

SEQ ID NO: 812 - DNA, 40 bp, Artificial Sequence
  Synthesized de novo.
acagttactattagtaacgatctgtcagatctgtatcttg

SEQ ID NO: 813 - DNA, 24 bp, Artificial Sequence
  Synthesized de novo.
ctgggtggccgagaaggaatggga

SEQ ID NO: 814 - DNA, 20 bp, Artificial Sequence
  Synthesized de novo.
ccctgggggtactttgactt

SEQ ID NO: 815 - DNA, 40 bp, Artificial Sequence
  Synthesized de novo.
ctggccagcactccggtgaggtaatgccgtcacgtggtcg

SEQ ID NO: 816 - DNA, 40 bp, Artificial Sequence
  Synthesized de novo.
gggtggcagctcaaagagctgccagacgacggccctctgg

SEQ ID NO: 817 - DNA, 35 bp, Artificial Sequence
  Synthesized de novo.
ccagacagttacattgaaatgatggctcaaccagg

SEQ ID NO: 818 - DNA, 40 bp, Artificial Sequence
  Synthesized de novo.
gcgcaccttcggcgctggtgttgggcgcttcgcgcttgct

SEQ ID NO: 819 - DNA, 32 bp, Artificial Sequence
  Synthesized de novo.
cctagctacgatgaagtattacttaacgctca

SEQ ID NO: 820 - DNA, 30 bp, Artificial Sequence
  Synthesized de novo.
ccggcggcatctgatttggtgtcttctttt

SEQ ID NO: 821 - DNA, 40 bp, Artificial Sequence
  Synthesized de novo.
gctgtgtggtacgaagtgccgcttcgcggcaccacacacg

SEQ ID NO: 822 - DNA, 20 bp, Artificial Sequence
  Synthesized de novo.
ccaataagagacagaatgtt

SEQ ID NO: 823 - DNA, 40 bp, Artificial Sequence
  Synthesized de novo.
actcatagttatataacacacttatgaatatgctaataca

SEQ ID NO: 824 - DNA, 20 bp, Artificial Sequence
  Synthesized de novo.
ccggtcatgtgacttccggt

SEQ ID NO: 825 - DNA, 40 bp, Artificial Sequence
  Synthesized de novo.
gcctcagatcgtcgatataagcggagcttttctgtgactg

SEQ ID NO: 826 - DNA, 40 bp, Artificial Sequence
  Synthesized de novo.
gccacgcccttccggttccggtgacgtgcttccggccacg

SEQ ID NO: 827 - DNA, 40 bp, Artificial Sequence
  Synthesized de novo.
ataaaataataaatattcacaaggaggagtggttatatga

SEQ ID NO: 828 - DNA, 40 bp, Artificial Sequence
  Synthesized de novo.
gggagtcgtcgaccttgacttcaaccgaaccatggttatt

SEQ ID NO: 829 - DNA, 40 bp, Artificial Sequence
  Synthesized de novo.
atatatagctatcaagtacagttctacttttgcattgacg

SEQ ID NO: 830 - DNA, 40 bp, Artificial Sequence
  Synthesized de novo.
acacatggcctttggccgtgtccatggtgtggtggtggtg

SEQ ID NO: 831 - DNA, 40 bp, Artificial Sequence
  Synthesized de novo.
atataataaaaagatagcaggtatccagtaggcgactagg

SEQ ID NO: 832 - DNA, 40 bp, Artificial Sequence
  Synthesized de novo.
aatgcgagcggctgcgccgctgcgcgcttcgcgcgcgcat

SEQ ID NO: 833 - DNA, 40 bp, Artificial Sequence
  Synthesized de novo.
acgtgtcgctcacggctagggggttgggttacgagtgtcg

SEQ ID NO: 834 - DNA, 29 bp, Artificial Sequence
  Synthesized de novo.
ccttctggtctactgacctttgaccttct

SEQ ID NO: 835 - DNA, 40 bp, Artificial Sequence
  Synthesized de novo.
gcccggcgaagccgagccgccgcgaagcggcgagcgactg

SEQ ID NO: 836 - DNA, 40 bp, Artificial Sequence
  Synthesized de novo.
acggcgagcagcgggccttcggccccccttcggggctgct

SEQ ID NO: 837 - DNA, 40 bp, Artificial Sequence
  Synthesized de novo.
cgaagcgcttcgcaggaaaccgttacaacctatgacgtca

SEQ ID NO: 838 - DNA, 40 bp, Artificial Sequence
  Synthesized de novo.
ctgtcagatctgtatcttggagtatccgtatcacgaaata

SEQ ID NO: 839 - DNA, 29 bp, Artificial Sequence
  Synthesized de novo.
ccaacatgtgcgccgtgattgacgggaac

SEQ ID NO: 840 - DNA, 40 bp, Artificial Sequence
  Synthesized de novo.
aaggccgtcagctgccgagcttcgctcggcaggccccaag

SEQ ID NO: 841 - DNA, 40 bp, Artificial Sequence
  Synthesized de novo.
gccagacgacggccctctggccgtcgcccccccaaacgag

SEQ ID NO: 842 - DNA, 40 bp, Artificial Sequence
  Synthesized de novo.
gggggccggtagcgacgcctttggcgtcgcggcccgagtg

SEQ ID NO: 843 - DNA, 40 bp, Artificial Sequence
  Synthesized de novo.
gccagacgacggccctctgggccgtcgcccccccaatcga

SEQ ID NO: 844 - DNA, 40 bp, Artificial Sequence
  Synthesized de novo.
aggggcccctagcgaccgcttcgcggtcgcggcccgagtg

SEQ ID NO: 845 - DNA, 40 bp, Artificial Sequence
  Synthesized de novo.
aagcaactgtataagtcagttacttatcttttctttcatt

SEQ ID NO: 846 - DNA, 40 bp, Artificial Sequence
  Synthesized de novo.
aaaggtctccagactgccggcctctggccggcagggccga

SEQ ID NO: 847 - DNA, 40 bp, Artificial Sequence
  Synthesized de novo.
aggaaatgggcgtggtttatggtatataagcaactactga

SEQ ID NO: 848 - DNA, 40 bp, Artificial Sequence
  Synthesized de novo.
gggcgcttcgcgcttgctaacttcatattggttgagaatt

SEQ ID NO: 849 - DNA, 40 bp, Artificial Sequence
  Synthesized de novo.
attgcgatgaccacgacgcgcgaagcgcgtcacttcgtgt

SEQ ID NO: 850 - DNA, 40 bp, Artificial Sequence
  Synthesized de novo.
aaattttggcgggctttttcccgccttatgcaaataagcg

SEQ ID NO: 851 - DNA, 40 bp, Artificial Sequence
  Synthesized de novo.
gcttcgcggcaccacacacgggccagtactgggggtgtag

SEQ ID NO: 852 - DNA, 40 bp, Artificial Sequence
  Synthesized de novo.
gctacgcgcgctgccttcggcagtcacacgtcaccatcag

SEQ ID NO: 853 - DNA, 40 bp, Artificial Sequence
  Synthesized de novo.
attttcgctgaccacgacgcgcgaaacgcgtcacttcgtg

SEQ ID NO: 854 - DNA, 40 bp, Artificial Sequence
  Synthesized de novo.
atgaatatgctaatacagagattagaatatccaatcatat

SEQ ID NO: 855 - DNA, 40 bp, Artificial Sequence
  Synthesized de novo.
caagttccggtcacatgcttccggtgacgcacatccggtg

SEQ ID NO: 856 - DNA, 40 bp, Artificial Sequence
  Synthesized de novo.
acgtgtctcctgtcacgtgacttccggtgacgcacttcct

SEQ ID NO: 857 - DNA, 40 bp, Artificial Sequence
  Synthesized de novo.
cgctacgcgcgctgccttcggcagtcacacgtcacttacg

SEQ ID NO: 858 - DNA, 40 bp, Artificial Sequence
  Synthesized de novo.
cgcttcgcgcgctgcctgcggcagtcacacgtcacttacg

SEQ ID NO: 859 - DNA, 40 bp, Artificial Sequence
  Synthesized de novo.
ctgcgcgcgcgccttcggacgtcacacgtcacttacgttt

SEQ ID NO: 860 - DNA, 40 bp, Artificial Sequence
  Synthesized de novo.
gctgcgcgcgctgccttcggcagtcacacgtcactagcgt

SEQ ID NO: 861 - DNA, 40 bp, Artificial Sequence
  Synthesized de novo.
cggagcttttctgtgactgtacgtagtgtattgatcttcg

SEQ ID NO: 862 - DNA, 40 bp, Artificial Sequence
  Synthesized de novo.
gacgtgcttccggccacgtcaacttccggccacgtcaact

SEQ ID NO: 863 - DNA, 40 bp, Artificial Sequence
  Synthesized de novo.
ggaggagtggttatatgatgtaatccataaccactcccag

SEQ ID NO: 864 - DNA, 40 bp, Artificial Sequence
  Synthesized de novo.
ctgcgcgcgctgcctacggcagtcacacgtcatacgtacg

SEQ ID NO: 865 - DNA, 40 bp, Artificial Sequence
  Synthesized de novo.
ccgaaccatggttatttacatttaatgaaatcaaccggtt

SEQ ID NO: 866 - DNA, 40 bp, Artificial Sequence
  Synthesized de novo.
ctacttttgcattgacgtcataagtcacgtgattttgtat

SEQ ID NO: 867 - DNA, 40 bp, Artificial Sequence
  Synthesized de novo.
ccatggtgtggtggtggtggttgtggtggggtatagcgaa

SEQ ID NO: 868 - DNA, 40 bp, Artificial Sequence
  Synthesized de novo.
atccagtaggcgactaggtgggggtgacgtcatcactatt

SEQ ID NO: 869 - DNA, 40 bp, Artificial Sequence
  Synthesized de novo.
cgcgcgcgcattgtaaggcctaatcgggcagccaatatgg

SEQ ID NO: 870 - DNA, 40 bp, Artificial Sequence
  Synthesized de novo.
atggcggacaattacgtcatttcctgtgacgtcatttcct

SEQ ID NO: 871 - DNA, 40 bp, Artificial Sequence
  Synthesized de novo.
gggttgggttacgagtgtcgaaaaaatttacataagagga

SEQ ID NO: 872 - DNA, 40 bp, Artificial Sequence
  Synthesized de novo.
ccgcgaagcggcaagggactgccgtcgtcgtcgtcggtgg

SEQ ID NO: 873 - DNA, 40 bp, Artificial Sequence
  Synthesized de novo.
gccgcggcagcttcgctgcctcgactgccgtcgtcgtcgt

SEQ ID NO: 874 - DNA, 40 bp, Artificial Sequence
  Synthesized de novo.
ggcgaagccgggccgccgcgaagcggcgagcgactgccgt

SEQ ID NO: 875 - DNA, 40 bp, Artificial Sequence
  Synthesized de novo.
aagcggcgagcgactgccgtcgtcgtcgtcggtggcgata

SEQ ID NO: 876 - DNA, 40 bp, Artificial Sequence
  Synthesized de novo.
gccccccttcggggctgctggagcctgataaggcttatcg

SEQ ID NO: 877 - DNA, 40 bp, Artificial Sequence
  Synthesized de novo.
cgttacaacctatgacgtcataggtcctatataagagatg

SEQ ID NO: 878 - DNA, 40 bp, Artificial Sequence
  Synthesized de novo.
agtatccgtatcacgaaataatatttcttttctatatcat

SEQ ID NO: 879 - DNA, 40 bp, Artificial Sequence
  Synthesized de novo.
cacgctgccgcgtcagcgctgacgtaaattacgtcatagg

SEQ ID NO: 880 - DNA, 40 bp, Artificial Sequence
  Synthesized de novo.
cgctcggcaggccccaagagagagcgcgcgcgatcactag

SEQ ID NO: 881 - DNA, 40 bp, Artificial Sequence
  Synthesized de novo.
ccgtcgcccccccaaacgagccagcgagcgagcgaacgcg

SEQ ID NO: 882 - DNA, 40 bp, Artificial Sequence
  Synthesized de novo.
aaaggtcgcccgacgcccgggctttgcccgggcggcctca

SEQ ID NO: 883 - DNA, 40 bp, Artificial Sequence
  Synthesized de novo.
ggcgtcgcggcccgagtgagcgagcgagcctgttttggaa

SEQ ID NO: 884 - DNA, 40 bp, Artificial Sequence
  Synthesized de novo.
ccgtcgcccccccaatcgagccagcgaacgagcgaacgcg

SEQ ID NO: 885 - DNA, 40 bp, Artificial Sequence
  Synthesized de novo.
cgcggtcgcggcccgagtgagcgagcgagcctgtcttgga

SEQ ID NO: 886 - DNA, 40 bp, Artificial Sequence
  Synthesized de novo.
cgcagacggcagagctctgctctgccggccccaccgagcg

SEQ ID NO: 887 - DNA, 40 bp, Artificial Sequence
  Synthesized de novo.
gccagacggacgtgctttgcacgtccggccccaccgagcg

SEQ ID NO: 888 - DNA, 40 bp, Artificial Sequence
  Synthesized de novo.
atcttttctttcattctgtgagttgagacgcacagagaga

SEQ ID NO: 889 - DNA, 40 bp, Artificial Sequence
  Synthesized de novo.
cctctggccggcagggccgagtgagtgagcgagcgcgcat

SEQ ID NO: 890 - DNA, 40 bp, Artificial Sequence
  Synthesized de novo.
atataagcaactactgaagtcagttacttatattttcttt

SEQ ID NO: 891 - DNA, 40 bp, Artificial Sequence
  Synthesized de novo.
catattggttgagaattaatccgtgtctttcctgtggaat

SEQ ID NO: 892 - DNA, 40 bp, Artificial Sequence
  Synthesized de novo.
cgaagcgcgtcacttcgtgtggtcactacgtatcgcaata

SEQ ID NO: 893 - DNA, 40 bp, Artificial Sequence
  Synthesized de novo.
ccgccttatgcaaataagcggccatgtttaatgttatatt

SEQ ID NO: 894 - DNA, 40 bp, Artificial Sequence
  Synthesized de novo.
ggccagtactgggggtgtagggtgtggtaaaatcgcaaat

SEQ ID NO: 895 - DNA, 40 bp, Artificial Sequence
  Synthesized de novo.
cagtcacacgtcaccatcagcaaagacagttggtcagttt

SEQ ID NO: 896 - DNA, 40 bp, Artificial Sequence
  Synthesized de novo.
gcgaaacgcgtcacttcgtgtggtcacttcgtagcgaaaa

SEQ ID NO: 897 - DNA, 40 bp, Artificial Sequence
  Synthesized de novo.
attagaatatccaatcatattgaaacacaagtactgcagt

SEQ ID NO: 898 - DNA, 40 bp, Artificial Sequence
  Synthesized de novo.
gacgcacatccggtgacgtagttccggtcacgtgcttcct

SEQ ID NO: 899 - DNA, 40 bp, Artificial Sequence
  Synthesized de novo.
acgcacttcctttgatgacgtatttccggttgtcaaggct

SEQ ID NO: 900 - DNA, 40 bp, Artificial Sequence
  Synthesized de novo.
gcagtcacacgtcacttacgtctcacatggttggttagtt

SEQ ID NO: 901 - DNA, 40 bp, Artificial Sequence
  Synthesized de novo.
gcagtcacacgtcacttacgtctcacatggttggtcagtt

SEQ ID NO: 902 - DNA, 40 bp, Artificial Sequence
  Synthesized de novo.
cacacgtcacttacgtttcacatggttggtcagttctaaa

SEQ ID NO: 903 - DNA, 40 bp, Artificial Sequence
  Synthesized de novo.
agtcacacgtcactagcgtttcacatggttggtcagttct

SEQ ID NO: 904 - DNA, 40 bp, Artificial Sequence
  Synthesized de novo.
acgtagtgtattgatcttcgtgttctggaactcaggtatg

SEQ ID NO: 905 - DNA, 40 bp, Artificial Sequence
  Synthesized de novo.
aacttccggccacgtcaacttccggtgacgtatttccgct

SEQ ID NO: 906 - DNA, 40 bp, Artificial Sequence
  Synthesized de novo.
ccataaccactcccaggaaatgacgtatgatagccaatca

SEQ ID NO: 907 - DNA, 40 bp, Artificial Sequence
  Synthesized de novo.
agtcacacgtcatacgtacgctccttggtcagttggttct

SEQ ID NO: 908 - DNA, 40 bp, Artificial Sequence
  Synthesized de novo.
aatgaaatcaaccggttcatggttgaagtcaaggtcgacg

SEQ ID NO: 909 - DNA, 40 bp, Artificial Sequence
  Synthesized de novo.
agtcacgtgattttgtattataaatagtataaatactcct

SEQ ID NO: 910 - DNA, 40 bp, Artificial Sequence
  Synthesized de novo.
ggggtatagcgaagctatggccaagcaccaaggggaaggg

SEQ ID NO: 911 - DNA, 40 bp, Artificial Sequence
  Synthesized de novo.
ggggtgacgtcatcactatttactcaagtgttttgttatt

SEQ ID NO: 912 - DNA, 40 bp, Artificial Sequence
  Synthesized de novo.
aatcgggcagccaatatggtggatgcaggaaatgagtaat

SEQ ID NO: 913 - DNA, 40 bp, Artificial Sequence
  Synthesized de novo.
cctgtgacgtcatttcctgtgacgtcacttccggtgggcg

SEQ ID NO: 914 - DNA, 40 bp, Artificial Sequence
  Synthesized de novo.
aaaaatttacataagaggaacgaatattaatgaggtggcg

SEQ ID NO: 915 - DNA, 40 bp, Artificial Sequence
  Synthesized de novo.
gccgtcgtcgtcgtcggtggcaatactcgtagagtataag

SEQ ID NO: 916 - DNA, 40 bp, Artificial Sequence
  Synthesized de novo.
cgtcgtcgtcggtggcgatactctaagagtataagcaagt

SEQ ID NO: 917 - DNA, 40 bp, Artificial Sequence
  Synthesized de novo.
ggcgagcgactgccgtcgtcgtcgtcggtggcaatactct

SEQ ID NO: 918 - DNA, 40 bp, Artificial Sequence
  Synthesized de novo.
cgtcgtcgtcggtggcgatactcttagagtataagcaagt

SEQ ID NO: 919 - DNA, 40 bp, Artificial Sequence
  Synthesized de novo.
gagcctgataaggcttatcgcggagctaggggcggtgcgt

SEQ ID NO: 920 - DNA, 22 bp, Artificial Sequence
  Synthesized de novo.
gtggtgctgaaatattgcaagc

SEQ ID NO: 921 - DNA, 40 bp, Artificial Sequence
  Synthesized de novo.
tactggggggtgtgtgggaccgtacctggagtgcacggta

SEQ ID NO: 922 - DNA, 21 bp, Artificial Sequence
  Synthesized de novo.
tggtggtggaagttgcctgat

SEQ ID NO: 923 - DNA, 40 bp, Artificial Sequence
  Synthesized de novo.
ttggaagctaggtactcgttacgcaagttttggattatct

SEQ ID NO: 924 - DNA, 24 bp, Artificial Sequence
  Synthesized de novo.
ggtcaagcacttctgtttccccgg

SEQ ID NO: 925 - DNA, 40 bp, Artificial Sequence
  Synthesized de novo.
ctggtactatgtacctttgtacgcctgtttctccccaacc

SEQ ID NO: 926 - DNA, 40 bp, Artificial Sequence
  Synthesized de novo.
tactctggtattacggtacctttgtacgcctgttttacaa

SEQ ID NO: 927 - DNA, 40 bp, Artificial Sequence
  Synthesized de novo.
ttgctgagtttctctaggagagtccctttcccagccagag

SEQ ID NO: 928 - DNA, 40 bp, Artificial Sequence
  Synthesized de novo.
actctggtatcaaggtacctttgtacgcctattttatttc

SEQ ID NO: 929 - DNA, 40 bp, Artificial Sequence
  Synthesized de novo.
tacactgatatcacggtacctttgtacgcctgttttatct

SEQ ID NO: 930 - DNA, 40 bp, Artificial Sequence
  Synthesized de novo.
ttgtacgcctattttatttcccccccctttttgaaactta

SEQ ID NO: 931 - DNA, 40 bp, Artificial Sequence
  Synthesized de novo.
acttggtattccggtacctttgtacacctatttacaaacc

SEQ ID NO: 932 - DNA, 40 bp, Artificial Sequence
  Synthesized de novo.
actctggtattacggtacctttgtacgcctattttacccc

SEQ ID NO: 933 - DNA, 40 bp, Artificial Sequence
  Synthesized de novo.
actctggtatcacggtacctttgtgcgcctgttttacatc

SEQ ID NO: 934 - DNA, 40 bp, Artificial Sequence
  Synthesized de novo.
gtactccggtaccccggtacccttgtacgcctgttttata

SEQ ID NO: 935 - DNA, 40 bp, Artificial Sequence
  Synthesized de novo.
cactctggtattacggtacctttgtgcgcctgttttattt

SEQ ID NO: 936 - DNA, 40 bp, Artificial Sequence
  Synthesized de novo.
gtaatctggtatcaggtacctttgtacgcctgttttatat

SEQ ID NO: 937 - DNA, 40 bp, Artificial Sequence
  Synthesized de novo.
tactctggttcgttagaacctttgtacgcctgttttcccc

SEQ ID NO: 938 - DNA, 40 bp, Artificial Sequence
  Synthesized de novo.
cacactggtatctcggtacctttgtgcgcctgttttatcc

SEQ ID NO: 939 - DNA, 40 bp, Artificial Sequence
  Synthesized de novo.
tgaggggacttgatacctcaccgccgtttgcctaggctat

SEQ ID NO: 940 - DNA, 40 bp, Artificial Sequence
  Synthesized de novo.
accctcccttccacataggacgaataaacggacttgagat

SEQ ID NO: 941 - DNA, 40 bp, Artificial Sequence
  Synthesized de novo.
aaagcagatagaggttctgaactggcaaactttacctcga

SEQ ID NO: 942 - DNA, 40 bp, Artificial Sequence
  Synthesized de novo.
ccacacctggttggttcccaggttcatacaataaccatca

SEQ ID NO: 943 - DNA, 40 bp, Artificial Sequence
  Synthesized de novo.
aattgcctgtagcgtcagtaaaacgcaatacacaagattt

SEQ ID NO: 944 - DNA, 40 bp, Artificial Sequence
  Synthesized de novo.
ggctgggtccgtgactacccactccccctttcaacgtgaa

SEQ ID NO: 945 - DNA, 40 bp, Artificial Sequence
  Synthesized de novo.
cccgccttaggtccattgaaaagaccaaacatgtcatccc

SEQ ID NO: 946 - DNA, 40 bp, Artificial Sequence
  Synthesized de novo.
gcggacggagatcatcccccggttaccccctttcgacgcg

SEQ ID NO: 947 - DNA, 40 bp, Artificial Sequence
  Synthesized de novo.
gcattgcactccacacttacgttgtgcgtacgcggggccc

SEQ ID NO: 948 - DNA, 40 bp, Artificial Sequence
  Synthesized de novo.
gcggtaaagaacaccccaggggtaacccctttgaacgcgg

SEQ ID NO: 949 - DNA, 40 bp, Artificial Sequence
  Synthesized de novo.
cttacgggagttagggccaaggatctgttgcataggcgtt

SEQ ID NO: 950 - DNA, 40 bp, Artificial Sequence
  Synthesized de novo.
gcgtcgcactccacacttacgtctctgcgagtgtaggaac

SEQ ID NO: 951 - DNA, 40 bp, Artificial Sequence
  Synthesized de novo.
cgatacactccacacttacgttcttgtgtgcgcgggaccc

SEQ ID NO: 952 - DNA, 40 bp, Artificial Sequence
  Synthesized de novo.
gcgctgcactccacacttacgtttgtgcacgcgcgggaac

SEQ ID NO: 953 - DNA, 40 bp, Artificial Sequence
  Synthesized de novo.
cggttgaaacgctactactcagacctctggctgtcgtacc

SEQ ID NO: 954 - DNA, 40 bp, Artificial Sequence
  Synthesized de novo.
tgcgactcacctcgcacttacgccatcgctcttcggtggc

SEQ ID NO: 955 - DNA, 40 bp, Artificial Sequence
  Synthesized de novo.
cttcttcggaacctgttcggaggaattaaacgggcaccca

SEQ ID NO: 956 - DNA, 40 bp, Artificial Sequence
  Synthesized de novo.
taaaggattatggacttatatgatgtgcccgacatggaat

SEQ ID NO: 957 - DNA, 40 bp, Artificial Sequence
  Synthesized de novo.
gcgcatgttcgcgtcgtcgtaagtctggattcccaaggcc

SEQ ID NO: 958 - DNA, 40 bp, Artificial Sequence
  Synthesized de novo.
aacgccttggtggatgctcaaagaagattactcttgatgc

SEQ ID NO: 959 - DNA, 40 bp, Artificial Sequence
  Synthesized de novo.
agaagattactcttgatgcttggctctcagaaagaatggc

SEQ ID NO: 960 - DNA, 40 bp, Artificial Sequence
  Synthesized de novo.
ctctcctgccccttcccctgagccggggatcttggctcat

SEQ ID NO: 961 - DNA, 40 bp, Artificial Sequence
  Synthesized de novo.
cgtacctggagtgcacggtatatatgcattcccgcatggc

SEQ ID NO: 962 - DNA, 40 bp, Artificial Sequence
  Synthesized de novo.
gctcttgtatcccggtacacttgcacgccagtttgcctct

SEQ ID NO: 963 - DNA, 40 bp, Artificial Sequence
  Synthesized de novo.
acgcaagttttggattatcttgtgcccaacattagttctc

SEQ ID NO: 964 - DNA, 40 bp, Artificial Sequence
  Synthesized de novo.
actctgttattacggtaactttgtacgccagtttttccca

SEQ ID NO: 965 - DNA, 40 bp, Artificial Sequence
  Synthesized de novo.
acgcctgtttctccccaaccacccttccttaaaattccca

SEQ ID NO: 966 - DNA, 40 bp, Artificial Sequence
  Synthesized de novo.
tttgtacgcctgttttacaacccttcccccatgtaactta

SEQ ID NO: 967 - DNA, 40 bp, Artificial Sequence
  Synthesized de novo.
agtccctttcccagccagaggtggctggtcaaacaatacc

SEQ ID NO: 968 - DNA, 40 bp, Artificial Sequence
  Synthesized de novo.
ttgtacgcctattttatttcccttcccccacagtaactta

SEQ ID NO: 969 - DNA, 40 bp, Artificial Sequence
  Synthesized de novo.
tttgtacgcctgttttatctccctacccccatcgtaactt

SEQ ID NO: 970 - DNA, 40 bp, Artificial Sequence
  Synthesized de novo.
ccccccctttttgaaacttagaagttaataataaacacgc

SEQ ID NO: 971 - DNA, 40 bp, Artificial Sequence
  Synthesized de novo.
tgtacacctatttacaaaccctaccccttgtaaccttaga

SEQ ID NO: 972 - DNA, 40 bp, Artificial Sequence
  Synthesized de novo.
ttgtacgcctattttacccccttccccttgtaacttagaa

SEQ ID NO: 973 - DNA, 40 bp, Artificial Sequence
  Synthesized de novo.
tacactggtatgccttacctcggtattacggtaccgatgt

SEQ ID NO: 974 - DNA, 40 bp, Artificial Sequence
  Synthesized de novo.
ttgtgcgcctgttttacatcccctccccaaattgtaattt

SEQ ID NO: 975 - DNA, 40 bp, Artificial Sequence
  Synthesized de novo.
ccttgtacgcctgttttatactccctttcccaagtaactt

SEQ ID NO: 976 - DNA, 40 bp, Artificial Sequence
  Synthesized de novo.
taccctggtacgctagtacctttgtacgcctgtttttccc

SEQ ID NO: 977 - DNA, 40 bp, Artificial Sequence
  Synthesized de novo.
tactctggtacgctagtacctttgtacgcctgttttcccc

SEQ ID NO: 978 - DNA, 40 bp, Artificial Sequence
  Synthesized de novo.
tttgtgcgcctgttttatttcccttccccattgtaacttt

SEQ ID NO: 979 - DNA, 40 bp, Artificial Sequence
  Synthesized de novo.
tttgtacgcctgttttatatcccttcccccgtaactttag

SEQ ID NO: 980 - DNA, 40 bp, Artificial Sequence
  Synthesized de novo.
cactctgattctacggaatccttgtgcgcctgttttatgt

SEQ ID NO: 981 - DNA, 40 bp, Artificial Sequence
  Synthesized de novo.
tttgtacgcctgttttcccctccttaaacaaattaagatc

SEQ ID NO: 982 - DNA, 40 bp, Artificial Sequence
  Synthesized de novo.
tttgtgcgcctgttttatccaccctaaaccccgttgtaac

SEQ ID NO: 983 - DNA, 40 bp, Artificial Sequence
  Synthesized de novo.
gtactccggtattgcggtacccttgtacgcctgttttata

SEQ ID NO: 984 - DNA, 40 bp, Artificial Sequence
  Synthesized de novo.
ccgccgtttgcctaggctataggctaaattttccctttcc

SEQ ID NO: 985 - DNA, 40 bp, Artificial Sequence
  Synthesized de novo.
cgaataaacggacttgagattaaggcaagtacataaggta

SEQ ID NO: 986 - DNA, 40 bp, Artificial Sequence
  Synthesized de novo.
actggcaaactttacctcgaaacacgcccgtttttctgct

SEQ ID NO: 987 - DNA, 40 bp, Artificial Sequence
  Synthesized de novo.
ggttcatacaataaccatcaataaacttttaacatctaag

SEQ ID NO: 988 - DNA, 40 bp, Artificial Sequence
  Synthesized de novo.
gcatgcatgcatcgactgcttgggggtgtccctgaccccc

SEQ ID NO: 989 - DNA, 40 bp, Artificial Sequence
  Synthesized de novo.
aaacgcaatacacaagatttgagcctgtagcgtcagtaaa

SEQ ID NO: 990 - DNA, 40 bp, Artificial Sequence
  Synthesized de novo.
tatgatctcaccgcagcctgcttggggttattcccaaacc

SEQ ID NO: 991 - DNA, 40 bp, Artificial Sequence
  Synthesized de novo.
actccccctttcaacgtgaaggctacgatagtgccagggc

SEQ ID NO: 992 - DNA, 40 bp, Artificial Sequence
  Synthesized de novo.
aagaccaaacatgtcatcccttggatgctggctaatcaga

SEQ ID NO: 993 - DNA, 40 bp, Artificial Sequence
  Synthesized de novo.
ggttaccccctttcgacgcgggtactgcgatagtgccacc

SEQ ID NO: 994 - DNA, 40 bp, Artificial Sequence
  Synthesized de novo.
gttgtgcgtacgcggggcccgatggaccatcgttcaccca

SEQ ID NO: 995 - DNA, 40 bp, Artificial Sequence
  Synthesized de novo.
ggtaacccctttgaacgcgggactgcgatagtgccacccc

SEQ ID NO: 996 - DNA, 40 bp, Artificial Sequence
  Synthesized de novo.
ggatctgttgcataggcgttgtatcccctaaccttttacc

SEQ ID NO: 997 - DNA, 40 bp, Artificial Sequence
  Synthesized de novo.
gtctctgcgagtgtaggaaccgacggactgtcgctcaccc

SEQ ID NO: 998 - DNA, 40 bp, Artificial Sequence
  Synthesized de novo.
ttcttgtgtgcgcgggacccgatggactttcgttcaccca

SEQ ID NO: 999 - DNA, 40 bp, Artificial Sequence
  Synthesized de novo.
gtttgtgcacgcgcgggaaccgatggactttcgttcaacc

SEQ ID NO: 1000 - DNA, 40 bp, Artificial Sequence
  Synthesized de novo.
agacctctggctgtcgtacctctattaggcaggcaggaac

SEQ ID NO: 1001 - DNA, 40 bp, Artificial Sequence
  Synthesized de novo.
agacctctggctgtcgtacctctattaggcagacaggaac

SEQ ID NO: 1002 - DNA, 40 bp, Artificial Sequence
  Synthesized de novo.
cgccatcgctcttcggtggcccagatggacttccgttcac

SEQ ID NO: 1003 - DNA, 40 bp, Artificial Sequence
  Synthesized de novo.
aggaattaaacgggcacccatactccccccaccccccttt

SEQ ID NO: 1004 - DNA, 40 bp, Artificial Sequence
  Synthesized de novo.
tgtgcccgacatggaattcgggaaatctggatctaagggt

SEQ ID NO: 1005 - DNA, 40 bp, Artificial Sequence
  Synthesized de novo.
aagtctggattcccaaggcccactcggttcaacttcggtt

SEQ ID NO: 1006 - DNA, 40 bp, Artificial Sequence
  Synthesized de novo.
tggctctcagaaagaatggcacctcaaagttttgagaccc

SEQ ID NO: 1007 - DNA, 40 bp, Artificial Sequence
  Synthesized de novo.
tggctctcagaaagaatggcacctcaatgttttgagaccc

SEQ ID NO: 1008 - DNA, 23 bp, Artificial Sequence
  Synthesized de novo.
tcatttatttagtattaaatgac

SEQ ID NO: 1009 - DNA, 23 bp, Artificial Sequence
  Synthesized de novo.
gcaggcggaacttctcgcaggtg

SEQ ID NO: 1010 - DNA, 20 bp, Artificial Sequence
  Synthesized de novo.
taaaaaatttaattaattta

SEQ ID NO: 1011 - DNA, 22 bp, Artificial Sequence
  Synthesized de novo.
tttttatattatccattagatc

SEQ ID NO: 1012 - DNA, 24 bp, Artificial Sequence
  Synthesized de novo.
ttgaaattaatcatatacaactct

SEQ ID NO: 1013 - DNA, 40 bp, Artificial Sequence
  Synthesized de novo.
gcttttacatccaacgtgtttaaaacagattaattaattg

SEQ ID NO: 1014 - DNA, 40 bp, Artificial Sequence
  Synthesized de novo.
tgaatgcccttgaggacgggcgtccgcagaaacgcgactc

SEQ ID NO: 1015 - DNA, 40 bp, Artificial Sequence
  Synthesized de novo.
gtttttaatgaaaaacggcttttaaagccaacgtaaatag

SEQ ID NO: 1016 - DNA, 40 bp, Artificial Sequence
  Synthesized de novo.
gttaatttacttaccttaggtatagataaatataatcatc

SEQ ID NO: 1017 - DNA, 40 bp, Artificial Sequence
  Synthesized de novo.
gtgctgatttaactagcgaaatatcgttgtcagaaacgag

SEQ ID NO: 1018 - DNA, 40 bp, Artificial Sequence
  Synthesized de novo.
tcattcaatcttttaagtctaattgaagccaatttaaatc

SEQ ID NO: 1019 - DNA, 40 bp, Artificial Sequence
  Synthesized de novo.
caattaagtagaagccaattaaacctaataagtagaagcc

SEQ ID NO: 1020 - DNA, 40 bp, Artificial Sequence
  Synthesized de novo.
gaaaggaggtaatatggaggagttttagagacctttcttc

SEQ ID NO: 1021 - DNA, 40 bp, Artificial Sequence
  Synthesized de novo.
gagggatttagagacctttcttccacgttagaacgacgac

SEQ ID NO: 1022 - DNA, 40 bp, Artificial Sequence
  Synthesized de novo.
gaataaaactacccgaatgatgggtttattcctttatgaa

SEQ ID NO: 1023 - DNA, 40 bp, Artificial Sequence
  Synthesized de novo.
ttctccctctctttccggaggctaaatttgagcctatttc

SEQ ID NO: 1024 - DNA, 40 bp, Artificial Sequence
  Synthesized de novo.
gcacgtacaaagggcgccctgacggcactaaggacgagag

SEQ ID NO: 1025 - DNA, 40 bp, Artificial Sequence
  Synthesized de novo.
ctatagaaattttagaaattatatttaattatacagatac

SEQ ID NO: 1026 - DNA, 40 bp, Artificial Sequence
  Synthesized de novo.
gcattatatctaaaatacatcaaatacaatttaaaataca

SEQ ID NO: 1027 - DNA, 40 bp, Artificial Sequence
  Synthesized de novo.
ccatacggttttacataaaataatactatatctaatttcc

SEQ ID NO: 1028 - DNA, 40 bp, Artificial Sequence
  Synthesized de novo.
tctccagtgttaacgagtgttacgaggtaacgagtgttac

SEQ ID NO: 1029 - DNA, 40 bp, Artificial Sequence
  Synthesized de novo.
ggctgactcgagaactcgggaggcggtcgtgcggacgcac

SEQ ID NO: 1030 - DNA, 40 bp, Artificial Sequence
  Synthesized de novo.
cagattaattaattgctaaaaatgtccatcaagctctcca

SEQ ID NO: 1031 - DNA, 40 bp, Artificial Sequence
  Synthesized de novo.
gtccgcagaaacgcgactccgcggaagaggactccgactc

SEQ ID NO: 1032 - DNA, 40 bp, Artificial Sequence
  Synthesized de novo.
ccaacgtaaatagaattttttgttttaattgttaaaaatg

SEQ ID NO: 1033 - DNA, 40 bp, Artificial Sequence
  Synthesized de novo.
tcatctattatttttattaaaaataataatttataaacgg

SEQ ID NO: 1034 - DNA, 40 bp, Artificial Sequence
  Synthesized de novo.
gttgtcagaaacgaggtctcgaagcaataccaacactttc

SEQ ID NO: 1035 - DNA, 40 bp, Artificial Sequence
  Synthesized de novo.
ttgaagccaatttaaatctaattataaaagccaattaaac

SEQ ID NO: 1036 - DNA, 40 bp, Artificial Sequence
  Synthesized de novo.
gttttagagacctttcttccacgttaggacgaaagcgtga

SEQ ID NO: 1037 - DNA, 40 bp, Artificial Sequence
  Synthesized de novo.
ccacgttagaacgacgacgtaaggacgaaagggaggtttc

SEQ ID NO: 1038 - DNA, 40 bp, Artificial Sequence
  Synthesized de novo.
ggtttattcctttatgaaggtatgggaaagggataaaatg

SEQ ID NO: 1039 - DNA, 40 bp, Artificial Sequence
  Synthesized de novo.
gaatggtttgcatttattgtagacgtaataatgcactaca

SEQ ID NO: 1040 - DNA, 40 bp, Artificial Sequence
  Synthesized de novo.
gctaaatttgagcctatttctaagggcctccggacgccgc

SEQ ID NO: 1041 - DNA, 40 bp, Artificial Sequence
  Synthesized de novo.
gacggcactaaggacgagagtccttacggcactaggagaa

SEQ ID NO: 1042 - DNA, 40 bp, Artificial Sequence
  Synthesized de novo.
gtaaattatatatataattttataattaatttaattttac

SEQ ID NO: 1043 - DNA, 40 bp, Artificial Sequence
  Synthesized de novo.
gtgtctagaaaaaaatgtgtgacccacgaccgtaggaaac

SEQ ID NO: 1044 - DNA, 40 bp, Artificial Sequence
  Synthesized de novo.
gctttatagagaccatcagaaagaggtttaatattttttg

SEQ ID NO: 1045 - DNA, 40 bp, Artificial Sequence
  Synthesized de novo.
tttttttacgactccatcagaaagaggtttaatatttttg

SEQ ID NO: 1046 - DNA, 40 bp, Artificial Sequence
  Synthesized de novo.
ctatcagaaagaggtttaatatttttgtgagaccatcgaa

SEQ ID NO: 1047 - DNA, 40 bp, Artificial Sequence
  Synthesized de novo.
catacataaaattataatttatatatttaaaatatttaga

SEQ ID NO: 1048 - DNA, 40 bp, Artificial Sequence
  Synthesized de novo.
caaatacaatttaaaatacatcaaatacaatttaaaatac

SEQ ID NO: 1049 - DNA, 40 bp, Artificial Sequence
  Synthesized de novo.
tctaatttccttccggaaaatattttataaagctacccaa

SEQ ID NO: 1050 - DNA, 40 bp, Artificial Sequence
  Synthesized de novo.
cgaggtaacgagtgttacgagaaatctcaaatgttacctc

SEQ ID NO: 1051 - DNA, 20 bp, Artificial Sequence
  Synthesized de novo.
ccattaggaagaagagatgt

SEQ ID NO: 1052 - DNA, 40 bp, Artificial Sequence
  Synthesized de novo.
cgaaatttatcatatacttctctcgtttataataatccaa

SEQ ID NO: 1053 - DNA, 20 bp, Artificial Sequence
  Synthesized de novo.
cacgccaagcaaggagtgta

SEQ ID NO: 1054 - DNA, 21 bp, Artificial Sequence
  Synthesized de novo.
gaatacattatggaatggaaa

SEQ ID NO: 1055 - DNA, 40 bp, Artificial Sequence
  Synthesized de novo.
cgagtggtcgaacgcttttatccagggatagcatttgata

SEQ ID NO: 1056 - DNA, 40 bp, Artificial Sequence
  Synthesized de novo.
gagctgcagaacggatattaaatggaatcaaattaaggag

SEQ ID NO: 1057 - DNA, 40 bp, Artificial Sequence
  Synthesized de novo.
gaagaggtggatctactgaacaaatttgaagatagtcatt

SEQ ID NO: 1058 - DNA, 40 bp, Artificial Sequence
  Synthesized de novo.
gaatttctaaattacaaagctgttgttgaattacagaaat

SEQ ID NO: 1059 - DNA, 40 bp, Artificial Sequence
  Synthesized de novo.
cgatgatttgaagactattgataaatgggagaaacaacaa

SEQ ID NO: 1060 - DNA, 22 bp, Artificial Sequence
  Synthesized de novo.
ccaccgagcacaccgccaataa

SEQ ID NO: 1061 - DNA, 40 bp, Artificial Sequence
  Synthesized de novo.
gaataaggaaccaatgatgaaacgcaagaacaaacgataa

SEQ ID NO: 1062 - DNA, 40 bp, Artificial Sequence
  Synthesized de novo.
ccatcaccgaaattctcaatgactcaaacacaccacagat

SEQ ID NO: 1063 - DNA, 40 bp, Artificial Sequence
  Synthesized de novo.
cgaatgacgtgtttgaagatgcagcaaaagcattctctat

SEQ ID NO: 1064 - DNA, 40 bp, Artificial Sequence
  Synthesized de novo.
catttcaggaattattgatcagtctaatgatatatttgag

SEQ ID NO: 1065 - DNA, 40 bp, Artificial Sequence
  Synthesized de novo.
gcgacagtacgtcgtacttacttaccaaacagatacgata

SEQ ID NO: 1066 - DNA, 40 bp, Artificial Sequence
  Synthesized de novo.
cgaaataatgaagagaaacataaacaaccagaagctaacg

SEQ ID NO: 1067 - DNA, 40 bp, Artificial Sequence
  Synthesized de novo.
gcatcccatcacggcatctttaccacaattttatcattct

SEQ ID NO: 1068 - DNA, 40 bp, Artificial Sequence
  Synthesized de novo.
gacgaagatattgatacgttcgagaaaagagataatgaaa

SEQ ID NO: 1069 - DNA, 40 bp, Artificial Sequence
  Synthesized de novo.
cggatatcattccgcatttgctatgcctcttccaagagat

SEQ ID NO: 1070 - DNA, 40 bp, Artificial Sequence
  Synthesized de novo.
cgcaaatgtctaatacggatttacagttttgtaccacagt

SEQ ID NO: 1071 - DNA, 40 bp, Artificial Sequence
  Synthesized de novo.
cccttacactgcaacagattacaaaacgactacacttact

SEQ ID NO: 1072 - DNA, 40 bp, Artificial Sequence
  Synthesized de novo.
cgtttacatttaacctgattgcgcgctacatatcacacta

SEQ ID NO: 1073 - DNA, 40 bp, Artificial Sequence
  Synthesized de novo.
ctttacatgaagtacacggtagatttgaaacgtcgggttt

SEQ ID NO: 1074 - DNA, 40 bp, Artificial Sequence
  Synthesized de novo.
cagatgtcgagtcatacatatttccgcgtatccgggagat

SEQ ID NO: 1075 - DNA, 40 bp, Artificial Sequence
  Synthesized de novo.
cttgatctggtacgcagagaactcacggacacaccacaaa

SEQ ID NO: 1076 - DNA, 40 bp, Artificial Sequence
  Synthesized de novo.
gactcagtaaacaagtttgaaattgatttaaaaagaattt

SEQ ID NO: 1077 - DNA, 25 bp, Artificial Sequence
  Synthesized de novo.
ccgatcttatccataatggtgtacc

SEQ ID NO: 1078 - DNA, 40 bp, Artificial Sequence
  Synthesized de novo.
gccttatccctgaaatgcaagcaactaatacattcatcaa

SEQ ID NO: 1079 - DNA, 40 bp, Artificial Sequence
  Synthesized de novo.
caataccttatccctgaaatgcaagcaactgacacatacg

SEQ ID NO: 1080 - DNA, 40 bp, Artificial Sequence
  Synthesized de novo.
ccgtttgtcgagcaaaagagaaatgcctagaaaaatacaa

SEQ ID NO: 1081 - DNA, 40 bp, Artificial Sequence
  Synthesized de novo.
cttgctagtagatatcttaaatttgtttatgattttgaaa

SEQ ID NO: 1082 - DNA, 40 bp, Artificial Sequence
  Synthesized de novo.
cgtttataataatccaaaagtcgcaattgtagagttactg

SEQ ID NO: 1083 - DNA, 40 bp, Artificial Sequence
  Synthesized de novo.
ctcgatctcttcgccgatcaggtcccccctttaccgggag

SEQ ID NO: 1084 - DNA, 40 bp, Artificial Sequence
  Synthesized de novo.
cattcatatataattcacaatccgcagttcaaattccaat

SEQ ID NO: 1085 - DNA, 40 bp, Artificial Sequence
  Synthesized de novo.
cctggagctccctatttggatggtgacgtgttatccagag

SEQ ID NO: 1086 - DNA, 40 bp, Artificial Sequence
  Synthesized de novo.
ccagggatagcatttgatataaatgaaggagcatgttata

SEQ ID NO: 1087 - DNA, 40 bp, Artificial Sequence
  Synthesized de novo.
gggctttaaatcgattatttaagtatgggaggatagatgg

SEQ ID NO: 1088 - DNA, 40 bp, Artificial Sequence
  Synthesized de novo.
ggaatcaaattaaggagaaacgccgcccaagatttttatt

SEQ ID NO: 1089 - DNA, 40 bp, Artificial Sequence
  Synthesized de novo.
gctgctcgaattctacctggaatacatttcaaccagaatg

SEQ ID NO: 1090 - DNA, 40 bp, Artificial Sequence
  Synthesized de novo.
caaatttgaagatagtcattttaaacaattagaagtattt

SEQ ID NO: 1091 - DNA, 40 bp, Artificial Sequence
  Synthesized de novo.
ccaaactaaataaattatttccaggaaaacgacaaatctt

SEQ ID NO: 1092 - DNA, 40 bp, Artificial Sequence
  Synthesized de novo.
gggagaaacaacaattgtccgtttatgatgagttatatgg

SEQ ID NO: 1093 - DNA, 40 bp, Artificial Sequence
  Synthesized de novo.
caccgcgactgtccgacgtccgcttaggctacgtcgatat

SEQ ID NO: 1094 - DNA, 40 bp, Artificial Sequence
  Synthesized de novo.
cgcaagaacaaacgataacaatcaattaatgaaataataa

SEQ ID NO: 1095 - DNA, 40 bp, Artificial Sequence
  Synthesized de novo.
caaacacaccacagattcttcttcattatgcgaacatcgt

SEQ ID NO: 1096 - DNA, 40 bp, Artificial Sequence
  Synthesized de novo.
gagagcatttcaggtatcactgatcaatcgaatgacgtgt

SEQ ID NO: 1097 - DNA, 40 bp, Artificial Sequence
  Synthesized de novo.
gatatatttgaggaggcagcaaaggcgttttcggcattta

SEQ ID NO: 1098 - DNA, 40 bp, Artificial Sequence
  Synthesized de novo.
cctcattgaccgcctcaccaaccatacacaacacaacgta

SEQ ID NO: 1099 - DNA, 40 bp, Artificial Sequence
  Synthesized de novo.
gcagcaaaagcattctctatgtttactcgcagcgacgtct

SEQ ID NO: 1100 - DNA, 40 bp, Artificial Sequence
  Synthesized de novo.
cacctctacgacacgtcgtacatttttacctctcagattt

SEQ ID NO: 1101 - DNA, 40 bp, Artificial Sequence
  Synthesized de novo.
caaccagaagctaacggcagtgcagataatggagaaggag

SEQ ID NO: 1102 - DNA, 40 bp, Artificial Sequence
  Synthesized de novo.
cattctacaccaatcgctgattccatccaaccgactgtta

SEQ ID NO: 1103 - DNA, 40 bp, Artificial Sequence
  Synthesized de novo.
caaattgaaaaaaatgaaccaaaaccgagagaatcaactt

SEQ ID NO: 1104 - DNA, 40 bp, Artificial Sequence
  Synthesized de novo.
ctatgcctcttccaagagataatccaagccaacatccaaa

SEQ ID NO: 1105 - DNA, 40 bp, Artificial Sequence
  Synthesized de novo.
cagttcttaacaatcagattcttcttcctttaattgcatt

SEQ ID NO: 1106 - DNA, 40 bp, Artificial Sequence
  Synthesized de novo.
caaaacgactacacttacttatttccacgcaacataatct

SEQ ID NO: 1107 - DNA, 40 bp, Artificial Sequence
  Synthesized de novo.
cgctacatatcacactataaaactactattataacgaccg

SEQ ID NO: 1108 - DNA, 40 bp, Artificial Sequence
  Synthesized de novo.
gatttgaaacgtcgggtttaaatttgacgagtttgacaag

SEQ ID NO: 1109 - DNA, 40 bp, Artificial Sequence
  Synthesized de novo.
gcgtatccgggagattctgactggtggaatttctggaatt

SEQ ID NO: 1110 - DNA, 40 bp, Artificial Sequence
  Synthesized de novo.
ctcacggacacaccacaaacccaagacttacaaaaactaa

SEQ ID NO: 1111 - DNA, 40 bp, Artificial Sequence
  Synthesized de novo.
gattaaaaagttacagactaagaccaaaccaaccaagcat

SEQ ID NO: 1112 - DNA, 40 bp, Artificial Sequence
  Synthesized de novo.
ggcagacctagaacggagaacgtttggatcatataaaata

SEQ ID NO: 1113 - DNA, 40 bp, Artificial Sequence
  Synthesized de novo.
gcagaaatttgcttaaagaaatttgaatcaatccaacaat

SEQ ID NO: 1114 - DNA, 40 bp, Artificial Sequence
  Synthesized de novo.
caactaatacattcatcaattacaaatgattttacaacaa

SEQ ID NO: 1115 - DNA, 40 bp, Artificial Sequence
  Synthesized de novo.
caagcaactgacacatacgaatacaagtactgatctgtct

SEQ ID NO: 1116 - DNA, 40 bp, Artificial Sequence
  Synthesized de novo.
cctagaaaaatacaagaacatactaaaatacaaagaacaa

SEQ ID NO: 1117 - DNA, 40 bp, Artificial Sequence
  Synthesized de novo.
cttatcaaaataattacttcgccacagataaatttaaaaa

SEQ ID NO: 1118 - DNA, 40 bp, Artificial Sequence
  Synthesized de novo.
cgcaattgtagagttactggataataaagaagcgttcttt

SEQ ID NO: 1119 - DNA, 40 bp, Artificial Sequence
  Synthesized de novo.
ccccctttaccgggaggtgattcacgggctctatcccgag

SEQ ID NO: 1120 - DNA, 40 bp, Artificial Sequence
  Synthesized de novo.
cagttcaaattccaatttactattcttccaatagtgaatt

SEQ ID NO: 1121 - DNA, 40 bp, Artificial Sequence
  Synthesized de novo.
ggtgacgtgttatccagagataatggggctctactatcaa

SEQ ID NO: 1122 - DNA, 40 bp, Artificial Sequence
  Synthesized de novo.
gagcatgttatatatataagttttctgatcatatacgacg

SEQ ID NO: 1123 - DNA, 40 bp, Artificial Sequence
  Synthesized de novo.
ggaggatagatggaactaagatgtattatgaatattacag

SEQ ID NO: 1124 - DNA, 40 bp, Artificial Sequence
  Synthesized de novo.
cgccgcccaagatttttattacaaatactctgaattacgg

SEQ ID NO: 1125 - DNA, 40 bp, Artificial Sequence
  Synthesized de novo.
catttcaaccagaatgaagggacgacttactactacaaat

SEQ ID NO: 1126 - DNA, 40 bp, Artificial Sequence
  Synthesized de novo.
caattagaagtattttatacaaacagtcaagctgaccatg

SEQ ID NO: 1127 - DNA, 40 bp, Artificial Sequence
  Synthesized de novo.
cgacaaatcttgattgtaaacgatccaacacatgagttcg

SEQ ID NO: 1128 - DNA, 40 bp, Artificial Sequence
  Synthesized de novo.
gatgagttatatggaactgaaactgctgagtttgtacttg

SEQ ID NO: 1129 - DNA, 40 bp, Artificial Sequence
  Synthesized de novo.
cgcttaggctacgtcgatatgattcctgcattactacttt

SEQ ID NO: 1130 - DNA, 40 bp, Artificial Sequence
  Synthesized de novo.
caagacagaacaagtaagagataaacacatatttacacag

SEQ ID NO: 1131 - DNA, 40 bp, Artificial Sequence
  Synthesized de novo.
cattatgcgaacatcgttaatggttctactcctgtgcact

SEQ ID NO: 1132 - DNA, 40 bp, Artificial Sequence
  Synthesized de novo.
gcagcaaaagcattctctatgtttactcgcagcgatgtct

SEQ ID NO: 1133 - DNA, 40 bp, Artificial Sequence
  Synthesized de novo.
gcgttttcggcatttactagaagcgacgtatataaagcat

SEQ ID NO: 1134 - DNA, 40 bp, Artificial Sequence
  Synthesized de novo.
ccatacacaacacaacgtactccaccgcgcattggacttt

SEQ ID NO: 1135 - DNA, 40 bp, Artificial Sequence
  Synthesized de novo.
ctcgcagcgacgtctacaaggcgctggatgaaataccttt

SEQ ID NO: 1136 - DNA, 40 bp, Artificial Sequence
  Synthesized de novo.
catttttacctctcagatttgacctactcctcgatcgctt

SEQ ID NO: 1137 - DNA, 40 bp, Artificial Sequence
  Synthesized de novo.
gcagataatggagaaggagcgtcaggaacacgcaatcaaa

SEQ ID NO: 1138 - DNA, 40 bp, Artificial Sequence
  Synthesized de novo.
ccatccaaccgactgttacagatagtggatctggttgttg

SEQ ID NO: 1139 - DNA, 40 bp, Artificial Sequence
  Synthesized de novo.
gagagaatcaacttcagaaagagtcgagagacgcgagact

SEQ ID NO: 1140 - DNA, 40 bp, Artificial Sequence
  Synthesized de novo.
ccaagccaacatccaaaaagtatctgaggcgtacgatttg

SEQ ID NO: 1141 - DNA, 40 bp, Artificial Sequence
  Synthesized de novo.
cttcttcctttaattgcattgacacttgtattgttgctaa

SEQ ID NO: 1142 - DNA, 40 bp, Artificial Sequence
  Synthesized de novo.
ccacgcaacataatctgacctcctcaaagcaagatacact

SEQ ID NO: 1143 - DNA, 40 bp, Artificial Sequence
  Synthesized de novo.
ctactattataacgaccgttcatctaacagtgatcttgtg

SEQ ID NO: 1144 - DNA, 40 bp, Artificial Sequence
  Synthesized de novo.
gacgagtttgacaagtcgtgtaagtgcgcttgaatctggt

SEQ ID NO: 1145 - DNA, 40 bp, Artificial Sequence
  Synthesized de novo.
ggtggaatttctggaattcgagaagcatacattaatgagt

SEQ ID NO: 1146 - DNA, 40 bp, Artificial Sequence
  Synthesized de novo.
ccaagacttacaaaaactaactgaacgtattatttcgctt

SEQ ID NO: 1147 - DNA, 40 bp, Artificial Sequence
  Synthesized de novo.
gaccaaaccaaccaagcatagtgaacattctaataagact

SEQ ID NO: 1148 - DNA, 40 bp, Artificial Sequence
  Synthesized de novo.
cgtttggatcatataaaatagaagaaataacaattaaaaa

SEQ ID NO: 1149 - DNA, 40 bp, Artificial Sequence
  Synthesized de novo.
gaatcaatccaacaatttagacaaaagagacaacaacaag

SEQ ID NO: 1150 - DNA, 40 bp, Artificial Sequence
  Synthesized de novo.
gattttacaacaactgacaaagcacaacaaagtacctttt

SEQ ID NO: 1151 - DNA, 40 bp, Artificial Sequence
  Synthesized de novo.
ctgatctgtcttcatccaactcagcgaaaccaacaacctt

SEQ ID NO: 1152 - DNA, 40 bp, Artificial Sequence
  Synthesized de novo.
ctaaaatacaaagaacaactagcaaaacaagatcaaaaag

SEQ ID NO: 1153 - DNA, 30 bp, Artificial Sequence
  Synthesized de novo.
gaaggcttcatttggtgaccccgacgtgat

SEQ ID NO: 1154 - DNA, 21 bp, Artificial Sequence
  Synthesized de novo.
cccagggaccaccgacccacc

SEQ ID NO: 1155 - DNA, 40 bp, Artificial Sequence
  Synthesized de novo.
tgttgtaggcgtagcgagggaaacgaggtgtgttgtaggc

SEQ ID NO: 1156 - DNA, 20 bp, Artificial Sequence
  Synthesized de novo.
gagagtataaatatgggaca

SEQ ID NO: 1157 - DNA, 40 bp, Artificial Sequence
  Synthesized de novo.
gcagctgcaagcctttccaactgtgctaatcactatgcca

SEQ ID NO: 1158 - DNA, 40 bp, Artificial Sequence
  Synthesized de novo.
cgtattagcttctgtaatcatgcttgcttgccttagccgc

SEQ ID NO: 1159 - DNA, 40 bp, Artificial Sequence
  Synthesized de novo.
ggggaactgtggggtttttatgaggggttttataaatgat

SEQ ID NO: 1160 - DNA, 24 bp, Artificial Sequence
  Synthesized de novo.
gaaggaaaagaaattaaaaataaa

SEQ ID NO: 1161 - DNA, 40 bp, Artificial Sequence
  Synthesized de novo.
cttgctcccgagaccttctggtcggctatccggcagcggt

SEQ ID NO: 1162 - DNA, 40 bp, Artificial Sequence
  Synthesized de novo.
ggcactggctcggttgggtagccagcctttcgggtaataa

SEQ ID NO: 1163 - DNA, 21 bp, Artificial Sequence
  Synthesized de novo.
gaccaccaacaccatgggtaa

SEQ ID NO: 1164 - DNA, 40 bp, Artificial Sequence
  Synthesized de novo.
tgtctcttgttcccttcaattcccactccctcctccaggt

SEQ ID NO: 1165 - DNA, 40 bp, Artificial Sequence
  Synthesized de novo.
ctccccgccaaaagcatgccccgggcgtggtggcgggcca

SEQ ID NO: 1166 - DNA, 40 bp, Artificial Sequence
  Synthesized de novo.
cgtctccgctcgtcacttatccttcactttccagagggtc

SEQ ID NO: 1167 - DNA, 40 bp, Artificial Sequence
  Synthesized de novo.
tagctgaatcatccgtctgagggccgtctcacactaggat

SEQ ID NO: 1168 - DNA, 40 bp, Artificial Sequence
  Synthesized de novo.
ggggtggagatggggcaccatgctccttgggatgttgatg

SEQ ID NO: 1169 - DNA, 40 bp, Artificial Sequence
  Synthesized de novo.
gattgccttactgccgagtggagagtgattactgagcggc

SEQ ID NO: 1170 - DNA, 40 bp, Artificial Sequence
  Synthesized de novo.
tcctgcctgcctgaaaagctcaataaaggagttggctgat

SEQ ID NO: 1171 - DNA, 40 bp, Artificial Sequence
  Synthesized de novo.
tgactgtggagacaataaaggagttactttacaactgcgc

SEQ ID NO: 1172 - DNA, 40 bp, Artificial Sequence
  Synthesized de novo.
ggactgtttacgaacaaatgataaaaggaaatagctgagc

SEQ ID NO: 1173 - DNA, 40 bp, Artificial Sequence
  Synthesized de novo.
ttgcgcttgaagtgagtctctccctgagaggctaccagat

SEQ ID NO: 1174 - DNA, 40 bp, Artificial Sequence
  Synthesized de novo.
gccttgaacgagtggggaataatagatgattggcaagctt

SEQ ID NO: 1175 - DNA, 40 bp, Artificial Sequence
  Synthesized de novo.
tttactgttatactgtgtgtctgctatattatattgtatt

SEQ ID NO: 1176 - DNA, 40 bp, Artificial Sequence
  Synthesized de novo.
gtaccagaatacctttactctgaataaactgcagattgtt

SEQ ID NO: 1177 - DNA, 40 bp, Artificial Sequence
  Synthesized de novo.
ctagaaaaagaggaagggataataccagattggcagaatt

SEQ ID NO: 1178 - DNA, 40 bp, Artificial Sequence
  Synthesized de novo.
gcttgggtaagattttgatatgtattttgcttgaatatta

SEQ ID NO: 1179 - DNA, 40 bp, Artificial Sequence
  Synthesized de novo.
ttgagcctgagtcgtactttcaccgtttacagtggcgagc

SEQ ID NO: 1180 - DNA, 40 bp, Artificial Sequence
  Synthesized de novo.
gcccggaggattggctggagtgtgaggaagatagtgagaa

SEQ ID NO: 1181 - DNA, 40 bp, Artificial Sequence
  Synthesized de novo.
tactgaagtacaagaatggttccagatggaggatgtagat

SEQ ID NO: 1182 - DNA, 40 bp, Artificial Sequence
  Synthesized de novo.
gatattaataaagtgtataacagacaaatgtgactggcct

SEQ ID NO: 1183 - DNA, 40 bp, Artificial Sequence
  Synthesized de novo.
tgtgaatatgatcaccgtggattttttcctatggttccaa

SEQ ID NO: 1184 - DNA, 40 bp, Artificial Sequence
  Synthesized de novo.
gagacgcataccgttggggatatttccccttagttcccaa

SEQ ID NO: 1185 - DNA, 40 bp, Artificial Sequence
  Synthesized de novo.
gaaggaggagaagaacctcactacccaaatactccagctc

SEQ ID NO: 1186 - DNA, 40 bp, Artificial Sequence
  Synthesized de novo.
gatgagttagcaacatgccttataaggaaagaaaaagcac

SEQ ID NO: 1187 - DNA, 40 bp, Artificial Sequence
  Synthesized de novo.
tcgattccctgacgactacgaacacctaaatgaagcggaa

SEQ ID NO: 1188 - DNA, 40 bp, Artificial Sequence
  Synthesized de novo.
tgatcgttagggaatagtggtcggccacaggcgtggcgat

SEQ ID NO: 1189 - DNA, 40 bp, Artificial Sequence
  Synthesized de novo.
cttttgctgttgcatccgaatcgtggtctcgctgatcctt

SEQ ID NO: 1190 - DNA, 40 bp, Artificial Sequence
  Synthesized de novo.
ggtgtgttgtaggcgtagcgagggaaacgaggtgtgacgc

SEQ ID NO: 1191 - DNA, 40 bp, Artificial Sequence
  Synthesized de novo.
ttgagtccctaacgattgcgaacacctgaatgaagcggaa

SEQ ID NO: 1192 - DNA, 40 bp, Artificial Sequence
  Synthesized de novo.
cggaaaattaccctggtaaaaagcccaaagcataggggaa

SEQ ID NO: 1193 - DNA, 40 bp, Artificial Sequence
  Synthesized de novo.
gatgagttagcaatatgccttacaaggaaagaaaaggcac

SEQ ID NO: 1194 - DNA, 40 bp, Artificial Sequence
  Synthesized de novo.
gagggtctcctctgagtgattgactacccacgacgggggt

SEQ ID NO: 1195 - DNA, 40 bp, Artificial Sequence
  Synthesized de novo.
ctcttgcagttgcatccgacttgtggtctcgctgttcctt

SEQ ID NO: 1196 - DNA, 40 bp, Artificial Sequence
  Synthesized de novo.
tgcaaggcatggaaaaataccaaaccaagaatagggaagt

SEQ ID NO: 1197 - DNA, 40 bp, Artificial Sequence
  Synthesized de novo.
ttgattccctgacgactacgagcacctgcatgaagcagaa

SEQ ID NO: 1198 - DNA, 40 bp, Artificial Sequence
  Synthesized de novo.
ctcttattttcttagcggggatgctccgttctctccttat

SEQ ID NO: 1199 - DNA, 40 bp, Artificial Sequence
  Synthesized de novo.
gtctttttttctcagcgagggcgctccgttctttccttat

SEQ ID NO: 1200 - DNA, 40 bp, Artificial Sequence
  Synthesized de novo.
ttctcagtttcttagcggggaccgtccgttctctccctgt

SEQ ID NO: 1201 - DNA, 40 bp, Artificial Sequence
  Synthesized de novo.
ctgtgctaatcactatgccacccttcttgtaataacataa

SEQ ID NO: 1202 - DNA, 40 bp, Artificial Sequence
  Synthesized de novo.
tcttgctgattgcatccggagccgtggtctcgttgttcct

SEQ ID NO: 1203 - DNA, 40 bp, Artificial Sequence
  Synthesized de novo.
gccttttgctgtttgcatccgaaacgtggcctcgctgttc

SEQ ID NO: 1204 - DNA, 40 bp, Artificial Sequence
  Synthesized de novo.
gccttttgctgtttgcatccgaagcgtggcctcgctgttc

SEQ ID NO: 1205 - DNA, 40 bp, Artificial Sequence
  Synthesized de novo.
tgtacttgatatatttcgctgatatcatttctcggaatca

SEQ ID NO: 1206 - DNA, 40 bp, Artificial Sequence
  Synthesized de novo.
ctcttgctgttgcatccgactcgtggtctcgctgttcctt

SEQ ID NO: 1207 - DNA, 40 bp, Artificial Sequence
  Synthesized de novo.
tgaggggttttataaatgattataagagtaaaaagaaagt

SEQ ID NO: 1208 - DNA, 40 bp, Artificial Sequence
  Synthesized de novo.
cgcttctgtaaaaccgcttatgcgccccaccctaaccgct

SEQ ID NO: 1209 - DNA, 40 bp, Artificial Sequence
  Synthesized de novo.
gtcggctatccggcagcggtcaggtaaggcaaaccacggt

SEQ ID NO: 1210 - DNA, 40 bp, Artificial Sequence
  Synthesized de novo.
ggcatggaaaattactcaagtatgttcccatgagatacaa

SEQ ID NO: 1211 - DNA, 40 bp, Artificial Sequence
  Synthesized de novo.
gccagcctttcgggtaataaaggcttgttggcattcggca

SEQ ID NO: 1212 - DNA, 40 bp, Artificial Sequence
  Synthesized de novo.
gccggttgagtcgcgttctgccgcctcccgcctgtggtgc

SEQ ID NO: 1213 - DNA, 40 bp, Artificial Sequence
  Synthesized de novo.
ctcctccaggttcctactgttgatcccgcgggtcgggaca

SEQ ID NO: 1214 - DNA, 40 bp, Artificial Sequence
  Synthesized de novo.
gcgtggtggcgggccaccaatggaggacctgatcacgggc

SEQ ID NO: 1215 - DNA, 40 bp, Artificial Sequence
  Synthesized de novo.
tcactttccagagggtccccccgcagaccccggtgaccct

SEQ ID NO: 1216 - DNA, 40 bp, Artificial Sequence
  Synthesized de novo.
gtcatcagcttaaaaggtcacgctgtctcacacaaacaat

SEQ ID NO: 1217 - DNA, 40 bp, Artificial Sequence
  Synthesized de novo.
gggccgtctcacactaggattgtgcccaaaaagaacacca

SEQ ID NO: 1218 - DNA, 40 bp, Artificial Sequence
  Synthesized de novo.
ggtcagaccgtctcacacaaacaatcccaagtaaaggctc

SEQ ID NO: 1219 - DNA, 40 bp, Artificial Sequence
  Synthesized de novo.
ggaacccactgcttaagcctcaataaagcttgccttgagt

SEQ ID NO: 1220 - DNA, 40 bp, Artificial Sequence
  Synthesized de novo.
gagtgattactgagcggccggtgtatcgggagtcgtccct

SEQ ID NO: 1221 - DNA, 40 bp, Artificial Sequence
  Synthesized de novo.
gttggctgatatctgagcttgcctggttattatcgggatt

SEQ ID NO: 1222 - DNA, 40 bp, Artificial Sequence
  Synthesized de novo.
gttactttacaactgcgctagcctggttattatcgggatt

SEQ ID NO: 1223 - DNA, 40 bp, Artificial Sequence
  Synthesized de novo.
gaaatagctgagcatgactcatagttaaagcgctagcagc

SEQ ID NO: 1224 - DNA, 40 bp, Artificial Sequence
  Synthesized de novo.
gagaggctaccagattgagcctgggtgttctctggtgagt

SEQ ID NO: 1225 - DNA, 40 bp, Artificial Sequence
  Synthesized de novo.
gatgattggcaagcttactcaccaggcccggggataaggt

SEQ ID NO: 1226 - DNA, 40 bp, Artificial Sequence
  Synthesized de novo.
gcactagcaggtagagcctgggtgttccctgctagactct

SEQ ID NO: 1227 - DNA, 40 bp, Artificial Sequence
  Synthesized de novo.
ctgctatattatattgtatttccttgctcagctattttgc

SEQ ID NO: 1228 - DNA, 40 bp, Artificial Sequence
  Synthesized de novo.
ctgcagattgttaaactttaactcctcgtctgatctgatc

SEQ ID NO: 1229 - DNA, 40 bp, Artificial Sequence
  Synthesized de novo.
tggcagaattatactcatgggccaggagtaaggtacccaa

SEQ ID NO: 1230 - DNA, 40 bp, Artificial Sequence
  Synthesized de novo.
tgtattttgcttgaatattatttgccttgctcaaaattaa

SEQ ID NO: 1231 - DNA, 40 bp, Artificial Sequence
  Synthesized de novo.
cgtttacagtggcgagccagccaggagccttttcttcata

SEQ ID NO: 1232 - DNA, 40 bp, Artificial Sequence
  Synthesized de novo.
tgtgaggaagatagtgagaatgaggaactcagtgtttctc

SEQ ID NO: 1233 - DNA, 40 bp, Artificial Sequence
  Synthesized de novo.
tccagatggaggatgtagatgatagagcaagagaaccact

SEQ ID NO: 1234 - DNA, 40 bp, Artificial Sequence
  Synthesized de novo.
gtgactggcctgggctgctttcctttcttcgaacatggat

SEQ ID NO: 1235 - DNA, 40 bp, Artificial Sequence
  Synthesized de novo.
tttttcctatggttccaaacaagctgtctcctacctgggt

SEQ ID NO: 1236 - DNA, 40 bp, Artificial Sequence
  Synthesized de novo.
tttccccttagttcccaataagcatcatcctgggtggact

SEQ ID NO: 1237 - DNA, 40 bp, Artificial Sequence
  Synthesized de novo.
tactccagctcctcataaaaagacctgggaggagagacat

SEQ ID NO: 1238 - DNA, 40 bp, Artificial Sequence
  Synthesized de novo.
ggaaagaaaaagcaccgtgcatgccgattggtggaagtaa

SEQ ID NO: 1239 - DNA, 40 bp, Artificial Sequence
  Synthesized de novo.
cgacgtgatagttagggaatagtggtcggccacagacggc

SEQ ID NO: 1240 - DNA, 40 bp, Artificial Sequence
  Synthesized de novo.
tcggccacaggcgtggcgatcctgccctcatccgtctcgc

SEQ ID NO: 1241 - DNA, 40 bp, Artificial Sequence
  Synthesized de novo.
gtggtctcgctgatccttgggagggtctcctcagagtgat

SEQ ID NO: 1242 - DNA, 40 bp, Artificial Sequence
  Synthesized de novo.
gggaaacgaggtgtgacgcgtgcaggttcctatgccacct

SEQ ID NO: 1243 - DNA, 40 bp, Artificial Sequence
  Synthesized de novo.
cgacgtgatcgttagggaatagtggtcggccacaggcggc

SEQ ID NO: 1244 - DNA, 40 bp, Artificial Sequence
  Synthesized de novo.
gcataggggaagtacagctaaaggtcaagtcgagaaaaac

SEQ ID NO: 1245 - DNA, 40 bp, Artificial Sequence
  Synthesized de novo.
tgactacccacgacgggggtctttcatttgggggctcgtc

SEQ ID NO: 1246 - DNA, 40 bp, Artificial Sequence
  Synthesized de novo.
gtggtctcgctgttccttgggagggtctcctctgagtgat

SEQ ID NO: 1247 - DNA, 40 bp, Artificial Sequence
  Synthesized de novo.
gaatagggaagttcagatcaagggcgggtacacgaaaaca

SEQ ID NO: 1248 - DNA, 40 bp, Artificial Sequence
  Synthesized de novo.
tgctccgttctctccttatacaggtgtaacttttgtccgt

SEQ ID NO: 1249 - DNA, 40 bp, Artificial Sequence
  Synthesized de novo.
cgctccgttctttccttatacaggtgcattccttgtcagt

SEQ ID NO: 1250 - DNA, 40 bp, Artificial Sequence
  Synthesized de novo.
gtccgttctctccctgtgcaggtgcgactcttgtttgtgc

SEQ ID NO: 1251 - DNA, 40 bp, Artificial Sequence
  Synthesized de novo.
cttcttgtaataacataacaactgtgtgctctctgtccaa

SEQ ID NO: 1252 - DNA, 40 bp, Artificial Sequence
  Synthesized de novo.
gccgtggtctcgttgttccttgggagggtttctcctaact

SEQ ID NO: 1253 - DNA, 40 bp, Artificial Sequence
  Synthesized de novo.
gtggcctcgctgttccttgggagggtctcctctgagtgat

SEQ ID NO: 1254 - DNA, 40 bp, Artificial Sequence
  Synthesized de novo.
gtggcctcgctgttccttgggagggtctcctcagagtgat

SEQ ID NO: 1255 - DNA, 40 bp, Artificial Sequence
  Synthesized de novo.
ctcttgctgttgcatccgacttgtggtctcgctgttcctt

SEQ ID NO: 1256 - DNA, 40 bp, Artificial Sequence
  Synthesized de novo.
tatcatttctcggaatcagcatcatttctcggaatcggca

SEQ ID NO: 1257 - DNA, 40 bp, Artificial Sequence
  Synthesized de novo.
gtggtctcgctgttccttgggagggtctcctcagagtgat

SEQ ID NO: 1258 - DNA, 40 bp, Artificial Sequence
  Synthesized de novo.
tataagagtaaaaagaaagttgctgatgctctcataacct

SEQ ID NO: 1259 - DNA, 40 bp, Artificial Sequence
  Synthesized de novo.
tgcgccccaccctaaccgctttcatttcgcttctgtaaaa

SEQ ID NO: 1260 - DNA, 40 bp, Artificial Sequence
  Synthesized de novo.
gcaaaccacggtttggagggtggttctcggctgagaccgc

SEQ ID NO: 1261 - DNA, 40 bp, Artificial Sequence
  Synthesized de novo.
tatgttcccatgagatacaaggaagttagaggctaaaaca

SEQ ID NO: 1262 - DNA, 40 bp, Artificial Sequence
  Synthesized de novo.
ggcttgttggcattcggcatctacccgtgcctcctgtctt

SEQ ID NO: 1263 - DNA, 40 bp, Artificial Sequence
  Synthesized de novo.
cgcctcccgcctgtggtgcctcctgaactacgtccgccgt

SEQ ID NO: 1264 - DNA, 40 bp, Artificial Sequence
  Synthesized de novo.
tgatcccgcgggtcgggacagttggcgcccaacgtggggc

SEQ ID NO: 1265 - DNA, 40 bp, Artificial Sequence
  Synthesized de novo.
tggaggacctgatcacgggcaagacatgcctcagggccac

SEQ ID NO: 1266 - DNA, 40 bp, Artificial Sequence
  Synthesized de novo.
gcagaccccggtgaccctcaggtcggccgactgcggcagc

SEQ ID NO: 1267 - DNA, 40 bp, Artificial Sequence
  Synthesized de novo.
gctgtctcacacaaacaatcccgggaacaggctctgacgt

SEQ ID NO: 1268 - DNA, 40 bp, Artificial Sequence
  Synthesized de novo.
tgtgcccaaaaagaacaccaaggctctgacgtctctccct

SEQ ID NO: 1269 - DNA, 40 bp, Artificial Sequence
  Synthesized de novo.
ggctctgacgtctccccctttttttaggaactgaaaccac

SEQ ID NO: 1270 - DNA, 40 bp, Artificial Sequence
  Synthesized de novo.
ctgaaaaacatttccgcgaaacagaagtctgaaaaggtca

SEQ ID NO: 1271 - DNA, 40 bp, Artificial Sequence
  Synthesized de novo.
gcttgccttgagtgcttcaagtagtgtgtgcccgtctgtt

SEQ ID NO: 1272 - DNA, 40 bp, Artificial Sequence
  Synthesized de novo.
tgtatcgggagtcgtcccttaatctgtgcaataccagagc

SEQ ID NO: 1273 - DNA, 40 bp, Artificial Sequence
  Synthesized de novo.
gcctggttattatcgggattcgttactaattccgtgcaac

SEQ ID NO: 1274 - DNA, 40 bp, Artificial Sequence
  Synthesized de novo.
gcctggttattatcgggattcgtcactaattctgtgcaac

SEQ ID NO: 1275 - DNA, 40 bp, Artificial Sequence
  Synthesized de novo.
tagttaaagcgctagcagctgcctaaccgcaaaaccacat

SEQ ID NO: 1276 - DNA, 40 bp, Artificial Sequence
  Synthesized de novo.
ctgggtgttctctggtgagtcttggaaggagtgcctgctt

SEQ ID NO: 1277 - DNA, 40 bp, Artificial Sequence
  Synthesized de novo.
ggcccggggataaggtacccgagagtctttggcttctgct

SEQ ID NO: 1278 - DNA, 40 bp, Artificial Sequence
  Synthesized de novo.
ggtgttccctgctagactctcaccagcacttggccggtgc

SEQ ID NO: 1279 - DNA, 40 bp, Artificial Sequence
  Synthesized de novo.
ttgctcagctattttgcaataccatatatcctgtccccaa

SEQ ID NO: 1280 - DNA, 40 bp, Artificial Sequence
  Synthesized de novo.
ctcctcgtctgatctgatccttgaccggctcgctagccta

SEQ ID NO: 1281 - DNA, 40 bp, Artificial Sequence
  Synthesized de novo.
ggagtaaggtacccaatgtacttcgggtggctgtggaagc

SEQ ID NO: 1282 - DNA, 40 bp, Artificial Sequence
  Synthesized de novo.
tttgccttgctcaaaattaaataaattggcttttctttca

SEQ ID NO: 1283 - DNA, 40 bp, Artificial Sequence
  Synthesized de novo.
ggagccttttcttcataaagagattcgagaaacgaagcgt

SEQ ID NO: 1284 - DNA, 40 bp, Artificial Sequence
  Synthesized de novo.
tgaggaactcagtgtttctcccctcacaggctgggagcct

SEQ ID NO: 1285 - DNA, 40 bp, Artificial Sequence
  Synthesized de novo.
gatagagcaagagaaccactagatggcagtgaaacacatc

SEQ ID NO: 1286 - DNA, 40 bp, Artificial Sequence
  Synthesized de novo.
tcctttcttcgaacatggatataatttagataagtgaatt

SEQ ID NO: 1287 - DNA, 40 bp, Artificial Sequence
  Synthesized de novo.
gctgtctcctacctgggtgagacatgctgccccctactgt

SEQ ID NO: 1288 - DNA, 40 bp, Artificial Sequence
  Synthesized de novo.
tcatcctgggtggactagacatttaactaagttcaagatt

SEQ ID NO: 1289 - DNA, 40 bp, Artificial Sequence
  Synthesized de novo.
ctgggaggagagacataaggttcttaagctgtccccattc

SEQ ID NO: 1290 - DNA, 23 bp, Artificial Sequence
  Synthesized de novo.
tatgaaaaaaactaacagagatc

SEQ ID NO: 1291 - DNA, 20 bp, Artificial Sequence
  Synthesized de novo.
tagatagaaaaaaatggcac

SEQ ID NO: 1292 - DNA, 40 bp, Artificial Sequence
  Synthesized de novo.
aagccttaacgggaactcccgtattgccaagatgagtttg

SEQ ID NO: 1293 - DNA, 40 bp, Artificial Sequence
  Synthesized de novo.
tctctcgacattcaaaatgtcaacagatatcatatctgaa

SEQ ID NO: 1294 - DNA, 40 bp, Artificial Sequence
  Synthesized de novo.
agatggcacgtaagttgcaaagagtttcagtttaccaaaa

SEQ ID NO: 1295 - DNA, 26 bp, Artificial Sequence
  Synthesized de novo.
tatagacattggggtcatccttatat

SEQ ID NO: 1296 - DNA, 40 bp, Artificial Sequence
  Synthesized de novo.
gaaatgcaacacccctacaatggatgctgacagaattgtc

SEQ ID NO: 1297 - DNA, 40 bp, Artificial Sequence
  Synthesized de novo.
atgtaacacctctacaatggatgccgacaagattgtattc

SEQ ID NO: 1298 - DNA, 40 bp, Artificial Sequence
  Synthesized de novo.
aaaatgtaacactcctacaatggagtctgacaagattgtg

SEQ ID NO: 1299 - DNA, 40 bp, Artificial Sequence
  Synthesized de novo.
atgttctgcatttccctctgaatgggtgctttgggggtaa

SEQ ID NO: 1300 - DNA, 40 bp, Artificial Sequence
  Synthesized de novo.
tgtgggaagatccgcccgcaacctgctcaataacacatga

SEQ ID NO: 1301 - DNA, 40 bp, Artificial Sequence
  Synthesized de novo.
gcttatacagatcccctaagtttggatgctgagctagcgc

SEQ ID NO: 1302 - DNA, 40 bp, Artificial Sequence
  Synthesized de novo.
agctcaaaatctgggtattggttcgggaaaagagtgagaa

SEQ ID NO: 1303 - DNA, 40 bp, Artificial Sequence
  Synthesized de novo.
aggtgcaatggccccaatctgcggattaaaataaaacctg

SEQ ID NO: 1304 - DNA, 40 bp, Artificial Sequence
  Synthesized de novo.
tctgtttttttgctcgcgtaaccggcaggacgaactcctg

SEQ ID NO: 1305 - DNA, 40 bp, Artificial Sequence
  Synthesized de novo.
ggatcctccatatggtggattcgggcaccgtcctgggccc

SEQ ID NO: 1306 - DNA, 40 bp, Artificial Sequence
  Synthesized de novo.
aggcatagaatacaaccatggttataagatagagcaggtg

SEQ ID NO: 1307 - DNA, 40 bp, Artificial Sequence
  Synthesized de novo.
aggtctctttccttcatcatgtactgcacattgaataaga

SEQ ID NO: 1308 - DNA, 40 bp, Artificial Sequence
  Synthesized de novo.
aaaaatggtaacagacatcatgagtgtcattcggatcaaa

SEQ ID NO: 1309 - DNA, 40 bp, Artificial Sequence
  Synthesized de novo.
ttcagttgtacactgataacgtgttatagacactagaaac

SEQ ID NO: 1310 - DNA, 40 bp, Artificial Sequence
  Synthesized de novo.
aagaaaaaggtggcacttcagttgtaacctgataacgtgc

SEQ ID NO: 1311 - DNA, 40 bp, Artificial Sequence
  Synthesized de novo.
agtagcaaaaagttttcaagtttgaaattccaagaatttg

SEQ ID NO: 1312 - DNA, 40 bp, Artificial Sequence
  Synthesized de novo.
agtaatcaaaatgtctgttacagtcaagagaatcattgac

SEQ ID NO: 1313 - DNA, 40 bp, Artificial Sequence
  Synthesized de novo.
gtattgccaagatgagtttgtcacggttgtactctaagaa

SEQ ID NO: 1314 - DNA, 40 bp, Artificial Sequence
  Synthesized de novo.
aacagatatcatatctgaatcttcaagaatggaacaccaa

SEQ ID NO: 1315 - DNA, 40 bp, Artificial Sequence
  Synthesized de novo.
agagtttcagtttaccaaaacagaaagccctagaaacaag

SEQ ID NO: 1316 - DNA, 40 bp, Artificial Sequence
  Synthesized de novo.
taagccggaggtgatagtagatcagtatgaatataagtac

SEQ ID NO: 1317 - DNA, 40 bp, Artificial Sequence
  Synthesized de novo.
ggatgctgacagaattgtcttcaaagtccataaccagttg

SEQ ID NO: 1318 - DNA, 40 bp, Artificial Sequence
  Synthesized de novo.
tgccgacaagattgtattcaaagtcaataatcaggtggtc

SEQ ID NO: 1319 - DNA, 40 bp, Artificial Sequence
  Synthesized de novo.
gagtctgacaagattgtgttcaaggtgaataaccaagttg

SEQ ID NO: 1320 - DNA, 40 bp, Artificial Sequence
  Synthesized de novo.
gtaacacccctacaatggatgttaacaaggttgtttttaa

SEQ ID NO: 1321 - DNA, 40 bp, Artificial Sequence
  Synthesized de novo.
tgggtgctttgggggtaatgcccttgtacgtgccccttaa

SEQ ID NO: 1322 - DNA, 40 bp, Artificial Sequence
  Synthesized de novo.
tgctcaataacacatgatcaggaagtgacacaatctgcga

SEQ ID NO: 1323 - DNA, 40 bp, Artificial Sequence
  Synthesized de novo.
tttggatgctgagctagcgcggtagtgtattggtgagtcc

SEQ ID NO: 1324 - DNA, 40 bp, Artificial Sequence
  Synthesized de novo.
tcgggaaaagagtgagaaaccacattaagtcatacccttc

SEQ ID NO: 1325 - DNA, 40 bp, Artificial Sequence
  Synthesized de novo.
ggattaaaataaaacctgagatcgccactctcattaatca

SEQ ID NO: 1326 - DNA, 40 bp, Artificial Sequence
  Synthesized de novo.
gcaggacgaactcctgctgctagtggctgacgttttggtg

SEQ ID NO: 1327 - DNA, 40 bp, Artificial Sequence
  Synthesized de novo.
gggcaccgtcctgggccccgctgtagtcgtgctggctagc

SEQ ID NO: 1328 - DNA, 40 bp, Artificial Sequence
  Synthesized de novo.
gttataagatagagcaggtgtatctggggtaacggcggag

SEQ ID NO: 1329 - DNA, 40 bp, Artificial Sequence
  Synthesized de novo.
gtactgcacattgaataagaaagagatcaaggctgttaag

SEQ ID NO: 1330 - DNA, 40 bp, Artificial Sequence
  Synthesized de novo.
tgagtgtcattcggatcaaaacaaatgctaccgttgctgc

SEQ ID NO: 1331 - DNA, 40 bp, Artificial Sequence
  Synthesized de novo.
gtgttatagacactagaaaccaagtctaagtgatatattc

SEQ ID NO: 1332 - DNA, 40 bp, Artificial Sequence
  Synthesized de novo.
gttgtaacctgataacgtgctttagacactataaaccgag

SEQ ID NO: 1333 - DNA, 40 bp, Artificial Sequence
  Synthesized de novo.
tttgaaattccaagaatttggaaagtgaaagttgaacaca

SEQ ID NO: 1334 - DNA, 40 bp, Artificial Sequence
  Synthesized de novo.
agtcaagagaatcattgacaacacagtcatagttccaaaa

SEQ ID NO: 1335 - DNA, 40 bp, Artificial Sequence
  Synthesized de novo.
tcacggttgtactctaagaagactcagtcatcttacaatg

SEQ ID NO: 1336 - DNA, 40 bp, Artificial Sequence
  Synthesized de novo.
tcaagaatggaacaccaaatcatcaggagagtgtctactg

SEQ ID NO: 1337 - DNA, 40 bp, Artificial Sequence
  Synthesized de novo.
agaaagccctagaaacaagcgtgagatatcagaatctgac

SEQ ID NO: 1338 - DNA, 40 bp, Artificial Sequence
  Synthesized de novo.
atcagtatgaatataagtaccctgcaatcaaagatcagag

SEQ ID NO: 1339 - DNA, 40 bp, Artificial Sequence
  Synthesized de novo.
aaagtccataaccagttggtgtctgtaaagccagaagtaa

SEQ ID NO: 1340 - DNA, 40 bp, Artificial Sequence
  Synthesized de novo.
agtcaataatcaggtggtctctttgaagcctgagattatc

SEQ ID NO: 1341 - DNA, 40 bp, Artificial Sequence
  Synthesized de novo.
aaggtgaataaccaagttgtttctttgaagcctgaggtca

SEQ ID NO: 1342 - DNA, 40 bp, Artificial Sequence
  Synthesized de novo.
ttaacaaggttgtttttaaggtccataatcagctggtctc

SEQ ID NO: 1343 - DNA, 40 bp, Artificial Sequence
  Synthesized de novo.
tgccccttaacaatcatgtcaccaagacctgatatgttaa

SEQ ID NO: 1344 - DNA, 40 bp, Artificial Sequence
  Synthesized de novo.
ggaagtgacacaatctgcgactattaacaaaaacccaacc

SEQ ID NO: 1345 - DNA, 40 bp, Artificial Sequence
  Synthesized de novo.
ggtagtgtattggtgagtccttctcccttagctacggtcc

SEQ ID NO: 1346 - DNA, 40 bp, Artificial Sequence
  Synthesized de novo.
ttaagtcatacccttctaattgtataccctgtgttatttc

SEQ ID NO: 1347 - DNA, 40 bp, Artificial Sequence
  Synthesized de novo.
gccactctcattaatcacaactaatatttggaagttttca

SEQ ID NO: 1348 - DNA, 40 bp, Artificial Sequence
  Synthesized de novo.
tggctgacgttttggtgattttaactgattagtagattaa

SEQ ID NO: 1349 - DNA, 40 bp, Artificial Sequence
  Synthesized de novo.
tgtagtcgtgctggctagcggtcacacaaaacgagtgtcc

SEQ ID NO: 1350 - DNA, 40 bp, Artificial Sequence
  Synthesized de novo.
tatctggggtaacggcggagacccgtgacggcgccgctac

SEQ ID NO: 1351 - DNA, 40 bp, Artificial Sequence
  Synthesized de novo.
aagagatcaaggctgttaagccaactgatgctatccctcc

SEQ ID NO: 1352 - DNA, 40 bp, Artificial Sequence
  Synthesized de novo.
ccaaatgaaggtaaccgtggacgttgaggctgatagccca

SEQ ID NO: 1353 - DNA, 40 bp, Artificial Sequence
  Synthesized de novo.
ccgcagtgagagataaacaacccagaatgaaggtcactgt

SEQ ID NO: 1354 - DNA, 40 bp, Artificial Sequence
  Synthesized de novo.
gacttagacgcagacagcccattcgtcaagtcactgcaaa

SEQ ID NO: 1355 - DNA, 40 bp, Artificial Sequence
  Synthesized de novo.
ggagaagccagtagtaaacgtagacgtagacccccagagt

SEQ ID NO: 1356 - DNA, 40 bp, Artificial Sequence
  Synthesized de novo.
gctaaactagccccaatcatcgaaaatggagaaaccgaca

SEQ ID NO: 1357 - DNA, 40 bp, Artificial Sequence
  Synthesized de novo.
gagattaagaacccatcatggatcctgtgtacgtggacat

SEQ ID NO: 1358 - DNA, 40 bp, Artificial Sequence
  Synthesized de novo.
ctgcattgcaagagattaaagtacccatcatggattcagt

SEQ ID NO: 1359 - DNA, 40 bp, Artificial Sequence
  Synthesized de novo.
cccgcggaccacccggccctgaaccagttcaagactgcgt

SEQ ID NO: 1360 - DNA, 40 bp, Artificial Sequence
  Synthesized de novo.
ggccttataacttaaccgtcggcagttgggtaagagacca

SEQ ID NO: 1361 - DNA, 40 bp, Artificial Sequence
  Synthesized de novo.
cgaaagtctttgtagacatcgaggccgagagcccgttttt

SEQ ID NO: 1362 - DNA, 40 bp, Artificial Sequence
  Synthesized de novo.
ctcggctacgcgagagattaaccacccacgatggccgcca

SEQ ID NO: 1363 - DNA, 40 bp, Artificial Sequence
  Synthesized de novo.
cgttgacatcgaggaagacagcccattcctcagagcttta

SEQ ID NO: 1364 - DNA, 40 bp, Artificial Sequence
  Synthesized de novo.
gcccgtatgtcaagtcgttacagcggacgtttccacaatt

SEQ ID NO: 1365 - DNA, 40 bp, Artificial Sequence
  Synthesized de novo.
cgaaaccagttgtgaagatcgacgtggaacctgaaagcca

SEQ ID NO: 1366 - DNA, 40 bp, Artificial Sequence; identical to SEQ ID NO: 1352
  Synthesized de novo.

SEQ ID NO: 1367 - DNA, 40 bp, Artificial Sequence; identical to SEQ ID NO: 1353
  Synthesized de novo.

SEQ ID NO: 1368 - DNA, 40 bp, Artificial Sequence; identical to SEQ ID NO: 1354
  Synthesized de novo.

SEQ ID NO: 1369 - DNA, 40 bp, Artificial Sequence; identical to SEQ ID NO: 1355
  Synthesized de novo.

SEQ ID NO: 1370 - DNA, 40 bp, Artificial Sequence; identical to SEQ ID NO: 1356
  Synthesized de novo.

SEQ ID NO: 1371 - DNA, 40 bp, Artificial Sequence; identical to SEQ ID NO: 1357
  Synthesized de novo.

SEQ ID NO: 1372 - DNA, 40 bp, Artificial Sequence; identical to SEQ ID NO: 1358
  Synthesized de novo.

SEQ ID NO: 1373 - DNA, 40 bp, Artificial Sequence; identical to SEQ ID NO: 1359
  Synthesized de novo.

SEQ ID NO: 1374 - DNA, 40 bp, Artificial Sequence
  Synthesized de novo.
gagaccacgtccgatcaattgtcgagggcgcgtgggaagt

SEQ ID NO: 1375 - DNA, 40 bp, Artificial Sequence
  Synthesized de novo.
gaggccgagagcccgtttttaaaatcactacaaagagcat

SEQ ID NO: 1376 - DNA, 40 bp, Artificial Sequence
  Synthesized de novo.
ggccgccaaagtgcatgttgatattgaggctgacagccca

SEQ ID NO: 1377 - DNA, 40 bp, Artificial Sequence
  Synthesized de novo.
gcccattcctcagagctttacaacggagcttcccgcagtt

SEQ ID NO: 1378 - DNA, 40 bp, Artificial Sequence
  Synthesized de novo.
cggacgtttccacaatttgagatcgaagcaaggcaggtca

SEQ ID NO: 1379 - DNA, 40 bp, Artificial Sequence
  Synthesized de novo.
cgtggaacctgaaagccatttcgctaagcaggtccagagt

SEQ ID NO: 1380 - DNA, 40 bp, Artificial Sequence
  Synthesized de novo.
gaggctgatagcccattccttaaggcccttcagaaggcgt

SEQ ID NO: 1381 - DNA, 40 bp, Artificial Sequence
  Synthesized de novo.
gaggctgacagcccatttttgaaggcccttcagaaagcat

SEQ ID NO: 1382 - DNA, 40 bp, Artificial Sequence
  Synthesized de novo.
cgtcaagtcactgcaaagatgctttccacattttgagata

SEQ ID NO: 1383 - DNA, 40 bp, Artificial Sequence
  Synthesized de novo.
gacgtagacccccagagtccgtttgtcgtgcaactgcaaa

SEQ ID NO: 1384 - DNA, 40 bp, Artificial Sequence
  Synthesized de novo.
ggagaaaccgacagtgcacgttgacgtagacccccaaagt

SEQ ID NO: 1385 - DNA, 40 bp, Artificial Sequence
  Synthesized de novo.
gatcctgtgtacgtggacatagacgctgacagcgcctttt

SEQ ID NO: 1386 - DNA, 40 bp, Artificial Sequence
  Synthesized de novo.
cccatcatggattcagtgtatgtagacatagatgctgaca

SEQ ID NO: 1387 - DNA, 40 bp, Artificial Sequence
  Synthesized de novo.
gcgtttccagggttcgaagtggtggccagcaaccggtcgt

SEQ ID NO: 1388 - DNA, 40 bp, Artificial Sequence
  Synthesized de novo.
gcgtttccagggttcgaagtggtggccagcaataggtcgt

SEQ ID NO: 1389 - DNA, 22 bp, Artificial Sequence
  Synthesized de novo.
atggattctcgtcctcagaaaa

SEQ ID NO: 1390 - DNA, 22 bp, Artificial Sequence
  Synthesized de novo.
tcactgatgatgttgcaggatt

SEQ ID NO: 1391 - DNA, 22 bp, Artificial Sequence
  Synthesized de novo.
atggatttacacagtttgttgg

SEQ ID NO: 1392 - DNA, 21 bp, Artificial Sequence
  Synthesized de novo.
tcatcgcaacatgtctccttc

SEQ ID NO: 1393 - DNA, 21 bp, Artificial Sequence
  Synthesized de novo.
ggctcgacagatcttaaggct

SEQ ID NO: 1394 - DNA, 21 bp, Artificial Sequence
  Synthesized de novo.
gcctcttcgctattacgccag

SEQ ID NO: 1395 - DNA, 20 bp, Artificial Sequence
  Synthesized de novo.
aagcaactccaacaatatgc

SEQ ID NO: 1396 - DNA, 107 bp, Artificial Sequence
  Synthesized de novo.
gagaacagtatcaacaactcagagaggctgccactgaggctgagaagcaactccaacaatatgcagagtctcgcgaacttgaccatcttggacttgatgatcaggaa

SEQ ID NO: 1397 - DNA, 108 bp, Artificial Sequence
  Synthesized de novo.
ggcgaacaatatcaacaactacgagaggcggcacatgatgcggaagtaaaactacaaaggcgacatgaacatcaggaaattcaagctattgccgaggatgacgaggaa

SEQ ID NO: 1398 - DNA, 20 bp, Artificial Sequence
  Synthesized de novo.
aagcaactccaacaatatgc

(19) United States
(12) Patent Application Publication
(10) Pub. No.: US 2010/0211327 A1
(43) Pub. Date: Aug. 19, 2010

(54) Methods and Systems for Viral Diagnosis

(75) Inventors: Nick Hahner, San Francisco, CA (US); Vishwanath Lingappa, San Francisco, CA (US); Vinod Asundi, Foster City, CA (US)

Correspondence Address: DAVID P. LENTINI, 53 Clark Road, North Berwick, ME, 03906-6310, US

(73) Assignee: Prosetta Bioconformatics, Inc., San Francisco, CA (US)

(21) Appl. No.: 12/699,831

(22) Filed: Feb. 3, 2010

Related U.S. Application Data
(60) Provisional application No. 61/149,384, filed on Feb. 3, 2009.

(51) Int. Cl. G06F 17/18; G06F 19/00

(52) U.S. Cl. 702/19

(57) ABSTRACT

Methods, apparatus, and software for identifying sets of genomic oligonucleotides that identify a viral family and for determining sets of probes and primers that can be used to identify members of viral families in a sample are provided. In one embodiment, the method of the present invention includes normalizing viral genomic oligonucleotide sequence data from at least one viral family, and identifying at least one oligonucleotide sequence that is unique to each viral family. An array of the identified oligonucleotide sequences is made. Primers provided by the present invention are used to amplify viral family genomic sequences in a biological sample of interest, and probes provided using the present invention, e.g., attached to an array or biochip, are then used to detect the presence of the corresponding virus(es) present in the sample by hybridization.

### 1 CROSS-REFERENCE TO RELATED U.S. PATENT APPLICATION

The present application claims priority under 35 U.S.C. §119(e) to provisional U.S. Patent Application Ser. No. 61/149,384, filed 3 Feb. 2009, which application is incorporated herein by reference in its entirety and for all purposes.

### 2 BACKGROUND OF THE INVENTION

2.1 Field of the Invention

The present invention provides compounds, software, systems, devices and methods for diagnosing viral infections. More particularly, the present invention provides compounds, software, systems, devices and methods for diagnosing viral infections by identifying the family of the virus infecting a mammalian, more specifically human, host. The present invention has applications in the areas of public health, virology, immunology, medicinal chemistry, medicine, and computer science.

2.2 The Related Art

Every day thousands of people suffer aches, fatigue, and lethargy associated with the onset of a viral disease. But these initial symptoms are usually so nondescript that the underlying disease cannot be diagnosed quickly. Instead, the afflicted must endure these discomforts as the viral infection progresses to cause more pronounced and specific symptoms that can be associated with a specific disease. During that interim, however, the virus is replicating and causing damage to the afflicted.

Making an early diagnosis of a viral infection is difficult, because many different viruses present the same, or substantially the same, nondescript symptoms in the early stages of infection. In addition, traditional medical practice has focused exclusively on rendering diagnoses of viral infections in terms of specific viruses or diseases, ignoring as irrelevant any attempt to diagnose an illness in terms of the more general family that encompasses the virus causing the illness. This approach would appear only reasonable in view of the fact that the few available anti-viral drugs are directed to act on specific viruses, not across viral families. The only treatments available during the phase before the virus can be positively identified are palliatives, like aspirin and decongestants, to help comfort the patient.

The traditional insistence on identifying and treating viral diseases carries a large price in addition to the above-mentioned suffering of the afflicted. Potentially catastrophic is that many of those infected are themselves viral vectors during the interim phase before diagnosis. During this time, the afflicted can spread the virus through common contact in public and private spaces. While this often is a nuisance for those in the vicinity of the sick, the growing concern over biological terrorism and warfare, and the expected return of such devastating “natural” viruses like avian influenza or the so-called “Spanish flu” pandemic of 1918, make the need for rapid diagnoses of viral infections all the more urgent.

Perhaps the greatest factor forcing health care givers to wait for a set of symptoms sufficient to support a diagnosis of a single virus (or one of a few closely related possibilities) is the lack of any “broad spectrum” anti-viral drugs, i.e., drugs that are clinically effective against a variety of viruses in a manner akin to certain antibiotics that have efficacy against a variety of bacterial infections. Recently, however, a number of such broad-spectrum anti-viral compounds were reported in PCT Application Serial No. WO 2008/124550, titled: Phenothiazin Derivatives for Antiviral Treatments.

In addition to the development of new anti-virals, methods and apparatus for detecting viruses in biological samples have been described that could aid in the rapid detection of viral infections and public outbreaks. For example, Briese, et al. (“Diagnostic System for Rapid and Sensitive Differential Detection of Pathogens”, Emerging Infectious Diseases 11(2) February 2005 310-314) describe an apparatus for using Mass Tag PCR techniques to identify viruses in samples. Similarly, Jabado, et al. (“Comprehensive viral oligonucleotide probe design using conserved protein re-Bions”, Nucleic Acids Research, 36(1) 2008 e3) describes the use of arrays of oligonucleotide probes to identify viruses in samples. Griffiths, et al. also describe using arrays of primers to identify viral infections in WO 02/099130. However, none of these publications describes the identification of viral families in biological samples.

Thus, although the compounds described in the above-referenced publication hold the promise of a new era in treating diseases, their use is hampered by the lack of diagnostic methods and systems that are capable of identifying viruses by familial or other generic qualities. The present invention meets these and other needs.

### 3 SUMMARY OF EMBODIMENTS OF THE INVENTION

In a first aspect, the present invention provides methods, apparatus, and software for identifying sets of genomic oligonucleotides that identify a viral family and for determining sets of probes and primers that can be used to identify members of viral families in a sample, such as a biological sample.

In one embodiment, the method of the present invention includes normalizing viral genomic oligonucleotide sequence data from at least one viral family, and identifying at least one oligonucleotide sequence that is unique to each viral family. In more specific embodiment, at least three such unique oligonucleotide sequences are identified. An array of the identified oligonucleotide sequences is made. Primers provided by the present invention are used to amplify viral family genomic sequences in a biological sample of interest, and probes provided using the present invention, e.g., attached to an array or biochip, are then used to detect the presence of the corresponding virus(es) present in the sample by hybridization. More particularly, the above-described method is implemented using an electronic computing device that is configured to execute the method on an electronic database of viral oligonucleotide sequences that have been electronically encoded and stored in a electronic memory device in electronic communication with the electronic computing device.

In a second aspect, the present invention provides arrays of oligonucleotides (including related probes and primers) configured to identify the viral family corresponding to a virus in a biological sample exposed to the array.

In a third aspect, the present invention provides methods for identifying the viral family of a virus in a biological sample, comprising exposing the sample to an array of oligonucleotides configured to identify the viral family corresponding to a virus in a biological sample exposed to the array.

In a fourth aspect, the present invention provides methods for treating a viral infection in a mammal suffering from a viral infection, comprising exposing a biological sample from the infected animal to an array of oligonucleotides configured to identify the viral family of the virus, identifying the viral family of the virus, and administering a medication effective to treat viruses in the family identified.

### 4 BRIEF DESCRIPTION OF THE FIGURES

FIG. 1 is a flowchart illustrating a method for identifying oligonucleotide sequences unique to a viral family according to one embodiment of the invention.

FIG. 2 is a schematic diagram of an exemplary electronic computing device configured to implement the methods of the invention.

FIG. 3 is a restriction map of the plasmid expression vector pTnT. cDNA sequences encoding various nucleocapsid genes were cloned into the Kpn I and Not I sites of the pTnT plasmid as described in the Examples.

FIG. 4 is an image of a electrophoresis gel illustrating the successful PCR amplification of viral sequences in accordance with the present invention.

FIG. 5 is a photograph of a gel demonstrating the successful detection of the PCR product for the EBOV-NP alone by the biotinylated probe as described in the Examples.

FIG. 6 is a CLUSTALW sequence alignment of the EBOV-NP and MARV-NP sequences and the EBOV-NP probe sequence used in the Southern blot analysis described in the Example.

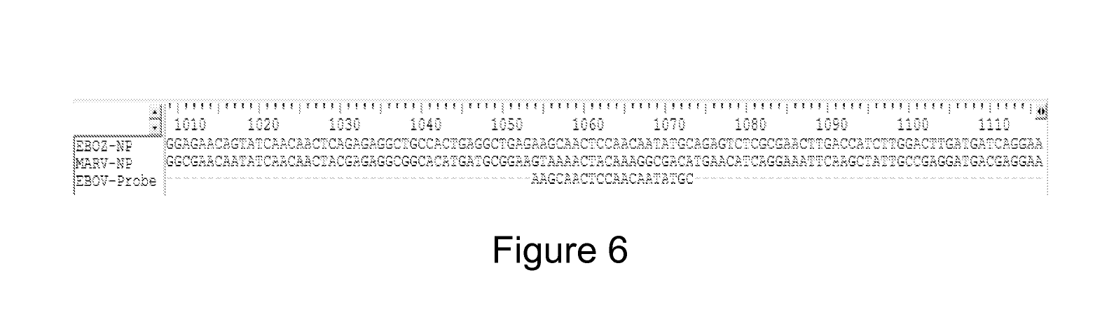

### 5 DETAILED DESCRIPTION OF SOME EMBODIMENTS OF

### 5.1 Software and Programmed Electronic Computer Devices and Systems for Identifying Viral Family Genomic Probes

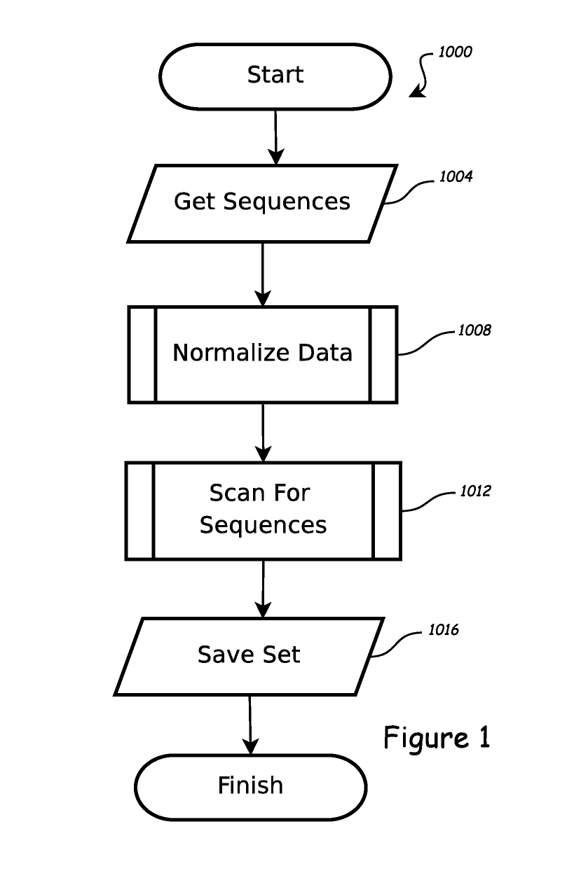

In a first aspect, the present invention provides methods for identifying sets of oligonucleotide sequences that uniquely identify a viral family. One embodiment of the invention is illustrated at 1000 in FIG. 1. Viral genomic sequences are obtained (1004) from a suitable source, such as the available from the National Center for Biotechnology Information (“NCBI”) or other suitable database. Preferably, the database includes a complete, or substantially complete, set of genomic oligonucleotide sequence for every virus or interest. In some embodiments, the database includes substantially every genomic sequence for every known virus. In other embodiments, the database includes substantially every genomic sequence for a set of viruses of interest. In still other embodiments, the database includes a number of genomic sequences sufficient to identify a virus of interest, as can determined by a person having ordinary skill in the art. In one some embodiments, the set of viruses include (but is not limited to) one or more of the following, individually or in any combination:

Adenoviridae

Arenaviridae

Astroviridae

Bornaviridae

Bunyaviridae

Coronaviridae

Flaviviridae

Filoviridae

Hepadnaviridae

Herpesviridae

Orthomyxoviridae

Papillomaviridae

Paramyxoviridae

Parvoviridae

Picornaviridae

Poxviridae

Reoviridae

Retroviridae

Rhabdoviridae

Togaviridae

In some embodiments, the above-described database is computerized, such as the NCBI database. Generally, such databases provide the viral genomic sequence data as a formatted set of encoded electronic signals that are stored either as corresponding formatted electronic signals, or magnetic domains, in the electronic or magnetic memory (respectively) of a electronic computer device. The provision, manipulation, and transmission of such data is understood by those having ordinary skill in the art.

In some embodiments, that above-described viral genomic data is normalized (1008) to facilitate processing as described below. For example, in more specific embodiments normalization includes truncation of lines to 80 characters. In other more specific embodiments, any comments provided with the data are removed. In still other embodiments, the lines are truncated and the comments are removed; in still more particular embodiments, the comments are removed and stored in separate directory. Still other embodiments, which can be included with any of the foregoing embodiments, include the removal of newline characters. In yet other embodiments, the viral genomic data is organized into an array such that one genomic sequence is assigned to a unique array element. In still other embodiments, the entire genome for a single virus is provided as a single string; with the genomes for segmented viruses including spacer characters (e.g., a space) as appropriate. Any of the foregoing normalizing operations, alone or in combination, can be performed on the viral genomic data encoded as electronic signals using methods and implements, including programmable electronic computing devices, known to those having ordinary skill in the art.

Following normalization (if any), the set of genomic viral sequence is searched to identify at least one sequence that is unique to each viral family the set of viral genomic families (1012). In some embodiments, the set is searched for more than once such unique sequence in order to increase the robustness of the identification of the presence of a member of a viral family in a biological sample as described below. In more specific embodiments, at least three (3) unique sequences are determined and saved (1016). The choice of a suitable number of unique sequences can be made by those having ordinary skill in the art. In some embodiments, the search is performed using a programmable computer that is configured to process the viral genomic sequence data in electronic format using the methods described herein.

In some embodiments, the size of the search window for the unique sequence(s) (i.e., the number of characters searched in each oligonucleotide) is between about 20 characters and about 40 characters. Other window sizes will be apparent to those having ordinary skill in the art. In other embodiments, the array of viral sequences is arranged from the longest to the shortest. Other arrangements will be familiar to those having ordinary skill in the art.

In some embodiments, two sets of inputs are created: one for the sequences of the viral family of interest, and one for all sequences of the other viral families. In those embodiments in which the processing is performed using a programmed electronic computing device, each input is a directory created on a storage device, such as a magnetic disk. Still other methods for managing output will be apparent to those having ordinary skill in the art.

In some embodiments, a subsequence is created starting from the first position of the first sequence, and having a length equal to a first value between about 40 and about 20. The subsequence is then compared against each sequence of the other viral families, e.g., using the well known Basic Local Alignment Search Tool (“BLAST”) methodology. If the subsequence is common among the family of interest, then it is stored in a “results” array and a results counter is incremented. The length value is then decremented by one, and the comparison is repeated. Alternative methods for searching the desired window sizes will be apparent to those having ordinary skill in the art. In some embodiments, allowances are made for near matches of sequence elements, i.e., counting different sequence elements as the same if they are considered to have relative equivalence. Such methods are known to those having ordinary skill in the art. In still more specific embodiments, a limit for the number of such equivalences is also provided, e.g., about 25%. Again, such limits are familiar to those having ordinary skill in the art.

In some embodiments, sequences each of the sequences stored in the results array is compared against each of the non-family sequences to determine if the sequence is unique to the family. This can be accomplished in substantially the same manner as just described for determining the common in-family sequences. Sequences that are not unique to the family are discarded. The remaining sequences thus are both common among all sequences in a family, but they are also unique to that family. In some embodiments, the foregoing search is continued until at least one, in more specific embodiments at least two, and in still more specific embodiments at lest three unique sequences are identified. In some embodiments, the number of sequences is chosen to provide substantially enough unique sequences to provide robust identification of the viral family in a biological sample.

In a second search embodiment, the same two files of family and non-family viral genomic sequences are created and manipulated as described above. However, the second embodiment includes two additional data elements. One holds the following data obtained when searching against the family: (a) a Boolean; whether or not it is found; (b) an integer; where it is found (if it is found); and (c) other information relating to the error of the string matches. A second holds information relating to segments that match multiple family members: (a) a string: the matching segment; (b) an integer: how many family members it identified; and (c) other information used for the search against the non-family list.

In this second search embodiment, the search for common sequences and subsequences that are unique to a viral family genome includes searching through the whole genome of the smallest organism looking only for matches of length 20. Information relating to this search, e.g., whether and where a match is found for a given genomic sequence, is stored in an array comprised of the first data structure described above. In a more specific embodiment, if the number of matches for a window size greater than or equal to 20 is two or more, then a check of the characters at the position immediately after the match (i.e., character 21) is made for family members which were matched by the sequence of length 20, to determine how many match a sequence or subsequence having a length of 21 characters. This process is continued by analogous extension until the number matched by 20+(n+1) is no longer equal to number matched by 20+n. The match of length 20+n is then added to an array of matches, and the search continues starting at the next character in the sequence; thereby defining a substantially minimal set of common genomic sequences to verify as unique to the viral family. These operations can be implemented by those having ordinary skill in the art.

Once the set of common viral genomic sequences is found, those sequences are searched against the non-family genomic sequences as follows. First, the best match is searched against the non-family list. If that sequence is found in the non-family list, then a record is made of where it is found, and how long the match was in the list of failed matches. The second best match is then searched against the non-family sequences. If the second best match comes from a different place in the shortest family members genome, then the search starts from the beginning. If it has already been matched against the non-family list, then the search starts at the point where the shorter match failed. If the search of the second-best sequence also fails, then the third-best is tried. This pattern is continued until a unique sequence or subsequence is identified. These operations can be implemented by those having ordinary skill in the art.

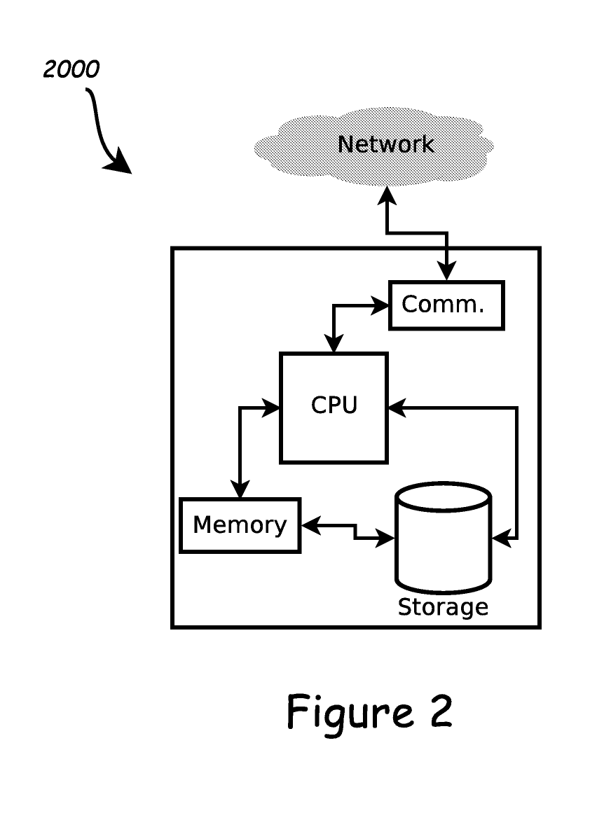

The methods described herein can be encoded on a computer-readable medium as computer-readable program code devices that configured to enable a general purpose electronic computing machine (FIG. 2 at 2000) to perform the methods provided by the invention on a electronic dataset of viral family genomic sequences. In one embodiment, the methods described above were performed on a computer using an electronic dataset obtained from the NCBI. The family-specific genomic sequence probes identified by the processing of the NCBI viral genomic electronic dataset are provided below. Three sets of unique viral genomic sequences were obtained for each viral family. Those having ordinary skill in the art will understand how to generate primers (e.g., for PCR) using the sequences listed below.

TABLE 1
Adenoviridae Set I

TCTGCTTTCTCTTTTGCTGCTATGTTAA
GATGAAAGGTCTAGATGGGG
TACATGCCGCAGATGTCGTA
TCCCCTTTGTTGCAGATCACGG
TTGTCTGCTTTTTCTTTGGC
TCTGGGGTTCATGTTGTGCAG
TCAAAGATGTAATCGTTGCAG
TTCCATGCATTCGTCCATAAT
TCGGGTACAAATTATGAATTCGATCTTTGGACTTTTCGAC
TCCACCAAAGTATTTCCGTGATACAAAGTCCGGACTGGGC

TABLE 2
Adenoviridae Set II

TTGATTTTTGGGATTAAATTCAGTTTTGTGGAGGTTTTAA
TTTGTTTTCTGGTTATTTTACGTTTAAATTGTCTAATTGC
TTTTGTGCTCAGCGGTCGCATTTACTAGCGGGGACGGCGC
TGGAATTTACAAAGAAGTAAGTTGTTGGATCTTTATTCAC
TTTAAAAAGTTTTTGTTTGATTGTTTTGACAAGGTTACAC
TGATGTTGAGTTTTTATACATGTTTGTGTGTGTTTTGTGC
TGCGTAAGAATACAAGTTTTGTGTGAAAAATTTATTAAAA
TGTACGGGCGCGTCGGGGTTTTCCCGGCGGGCGGGCGCGC
TGGGAAACTTGACCTTTGAACGGGCGCGGTGAAGTGGCAC
TTAAGAGCTTTATTGGAATTTTATATAAAATTTATGAGAC
TTGCAAGTGCCACGTCGTCGTGGGCGTGTCTTTTGTGACC
TTGGGGGCGGCGGGCGGTGATTGGTGGAGAGGGGTGTGAC
TGGGTGGAGGTGTGGCTTTGGCGTGCTTGTAAGTTTGGGC
TCTGGGAGGGGCGGGGAGTGTCCGTGTGCGTGCGAGCGGC
TTGGGCGGGTTTTTGTAACTTTTGGCCATTTTGGCGCGAA
TCGGGGAGGAGCGCGGGGCGGGGCGGGCGTGTCGCGCGGC
TTTGCCACGTCATTTATGACGCAACGACGGCGAGCGTGGC
TTTATACCGGAAGTTGGGTAATTTGGGCGTATACTTGTAA
TGTGGATCGTGTGGTGATTGGCTGTGGGGTTAACGGCTAA
TTTGTGACGTGGCGCGGGGCGTGGGAACGGGGCGGGTGAC
TTCGTTAGGGGCGGGGCAGGTGACGTTTTGATGACGCGAC
TTTGGACTTTTCGACGCGCCCAGTGACTGTACTTTATTGC
TCTGGCACCGATAGCAATAAATGGGCGTTCCCTTGCGTGC
TTGGACGAGAGAAGACGATGCAAATGACGTCACGACGCAC

TABLE 3
Adenoviridae Set III

TTTTGTGGAGGTTTTAAAGGTTAAAATTTTTATTTGGTGC
TTGATTTGTTCGTTTTCTGTTTGAATTGTGGGCGGTTAAA
TTTACTAGCGGGGACGGCGCGTTACTGCACCTTGGGCGCA
TTACTTCACATGATATTTTACTTAAATTTTGTACATACAA
TTGTTTTGACAAGGTTACACCCTGTTCAGGGCGTTTCCCA
TTTTGTGCTTGTGTAAAGGAGTTTTGGTTTTTTACTTTGC
TGTGAAAAATTTATTAAAAATGAAGTTTAAAGAATATTAA
TTCCCGGCGGGCGGGCGCGCCCCGTGGCGTGCGAGGCGGC
TGAAGTGGCACGTGATGACGCAGCACTGCGGACCTTTGCC
TCAAGTTTTAATATTATTGTCATCATGTAAGTTTTTGTAA
TTGTGACCTTTGGACGGGCGTTTCGCTGGCCGGGTTCCCA
TGACGTAGCGTGGGAACGTGACGTCGCGTGGGAAAATGAC
TGGGCGGATGAGGAAGTGGGGCGCGGCGTGGGAGCCGGGC
TGTATTTATGATGGGGTGTTTAGGGTATCAGCTGTTGGAC
TTTTGGCGCGAAAACTGAGTAATGAGGACGTGGGACGAAC
TTTTTATTCATTTTGCAAGTTTTTCTGTACATTTTGGCGC
TGAGGGCGGCGGGGGCGGCGCGCGGGGCGGCGCGCGGGGC
TTGGGCGTATACTTGTAAGTTTTGTGTAATTTGGCGCGAA
TTAACGGCTAAAAGGGGCGGTGCGACCGTGGGAAAATGAC
TGACGTTTTTGGTGTGCGCCGGTGTATACGGGAAGTGACA
TCTGGTGGGGAAAAGTGACGTCAAACGAGGTGTGGTTTAA
TCACCACGCCCGGGAGATTTCGAAATTGCTATTTCCGTGC
TCCCTTGCGTGCGGAATTGCGCCGGCACAGTCCCAATGGC
TCGCGGGGCTGATGACGTATAAAAAAGCGGACTTTAGACC

TABLE 4
Arenaviridae Set I

CCCTCAATGTCAATCCATGT
CAAGTGATGATCAAATAACAATG
AGAGAAGAGTTGTATATTGT
CACTCACTTTGTTTAACAAT
CCCAATGGGTCTTAGATATTCAAGAGAGGTCAAACAACGG
AAAACAAAGATTTCTTAAGG
ACACACAAATCCAAAAACTT
CTGTGTGAGGCCCATCCACCTATTTGACCAACATGGGGTT
CACCCATGACAAAAAATCTTGA
AAGCATGGGCAACTGCAATCGAACTCAGAAACCCAGTTCG
CCCCCCGGGGGGACCCCCCGCCGGG

TABLE 5

Arenaviridae Set II
AGAGAGTTATGTTTAAACTATATAGAACAGGATGAGAGGT
CAACTACACAAAGTTTTGGTATGT
AGATCTTGTGAGAAAGTGGGTCCCTGATGACCTGGAACTG
AAAGACATGGTAAGAAAATGGGTTCCAGAATGGGAAGAGT
CCTAACTCACAGGCATTTGT
CTACCATTTTTGAACCCCTT
CTCAAAACACTTGATCTGATCAGT
CTCAAAGCACTTAATCTGATCTGTCAA
CATCACTAGAGGTATATGATGT
AACATGGGGTTGAGGTACTCCAAAGCAGTCAAAGACAAAT
AGTTCGTCTTCTAACAACCTCGAGAAGCCACCACAAGCTG
CCGTGCAAGACAGCGCAGAGCTCCCCACAATGGGCAACTG
CACTACTTTAGGACCTTATTTTCACCAATGGGTCTGAGAT
AAACAAGCAAGCCAAAGCCCCAGAATCAAAAGACAGTCCG
AAGCACTCACACAAGTCCCGCAACCACCACACCTACAAGG
CAACACCACATCTCCAATTTCATCAGCAACGAGGCAAGAT
CCTCAGGAAACACTTTCCTGCTAAAGAGGAGATCAGTCGT

TABLE 6
Arenaviridae Set III

AGAACAGGATGAGAGGTTGTCAAGGCAGAAACTCAACTTT
CCCCCCAGTCCGCGGCCTGG
CCCTGATGACCTGGAACTGTCAGAACAGAAAAACATTATG
AGAATGGGAAGAGTTATCTGAGCAGAAGAATAACGTGCTT
CCATTGTTCACAGCCATCTTCAT
AAAGATTTTGTTAGAAAACAGATACCTGATAGACCAGAGT
CCCCTCTGACAAAGTTTTTTGAAAG
AGATACTCAAAGGCTGTCAGAGACAGATATGGAGAGAGGG
CCCAGTGTCAGAACAGATTGCAATAATGGGGCTTAGGTAT
CTACAGCAAAGAGGTGAGAGAGAGACACGGAGACAAAGAT
AAGCAGTCAAAGACAAATATGGAGATCGAGAAATTGAAGG
AGCACCAGATTTCATCTAATGGGTAACTCCAAGTCAAAAT
ACCACAAGCTGCAGAATTTAGAAGAACGGCAGAGCCCAGT
CCCAACACACAAACATCATCCAACCAACCCTCAGCAGAGT
CCCCAAACCGCTCCAGCTCCCACAACCAAGAGTGTCCCTG
CAGCACAAATCTCCTCAAGGAGACAGAACCAAGGCATCCA
AGAATCAAAAGACAGTCCGAGAGCCAGCCTGATCCCAGAT
CCACCACACCTACAAGGACCCGCCAACAGTCCCGCCAAAT
AACGAGGCAAGATCACCCCTTATCATGGGACAGAAGCCTT
CAGTCGTCAGATCACTGTTGTCACCTCACAAACTGAAATG

TABLE 7
Astroviridae Set I

GTTATGAATCTGGGTTCAGCTCGCTCACGTGAGTGGCTTA
CAGGCATTTGAGTATGCCTAT
TTTCTCTGACCGTTTACCACACAATTAACAACAATATGGC
CCCCAAAGGCTTTCACTGCTCAGGCCGGACTGGCCAAATT
CCAAGGCTCTTGCTCCAGCTGATGGGCCCATAGTGGCCGG
TTTGCATCCCTTGATCAACGGCGGGAGCGCCAAGAAGAAC

TABLE 8
Astroviridae Set II

CGCTCACGTGAGTGGCTTAATGAGCTACCCAGCACAGCAC
TGTCTATGACAAAGTGCTGCAGTTCGGCTCTAAGAAGGCC
TTCACCCTCGTGGCTCTGGCCAGCGCTGTGTCTATGACAC
ACAATTAACAACAATATGGCATACGGTGAGCCATACTATA
CAGGCCGGACTGGCCAAATTGGTCAATCCGGCCGGCTTAA
GATGGGCCCATAGTGGCCGGCCTCGACAAACTAGTGAACC
GCGGGAGCGCCAAGAAGAACAGGCGCAGTCCGGCCTTGAC

TABLE 9
Astroviridae Set III

TGAGCTACCCAGCACAGCACTCAACCAGCTGCGTGACATC
AGTTCGGCTCTAAGAAGGCCAGAGCTCGTGGCATGGCCCT
CAGCGCTGTGTCTATGACACAGTGCTCCGGTTTGGGGACC
TACGGTGAGCCATACTATAGCTCTAAACCTGACAAAGATT
GGTCAATCCGGCCGGCTTAAATAGCATCCTCGCTAGAGGG
CCTCGACAAACTAGTGAACCTGGAAGGGGTTCACGACTTG
AGGCGCAGTCCGGCCTTGACAAGGTGTTCTACTTCCAAGG

TABLE 10
Bornaviridae Set I

GCAATGCCACCCAAGAGACGCCTGGTTGATGACGCCGATG

TABLE 11
Bornaviridae Set II

CCTGGTTGATGACGCCGATGCCATGGAGGATCAAGATCTA

TABLE 12
Bornaviridae Set III

CCATGGAGGATCAAGATCTATATGAACCCCCAGCGAGCCT

TABLE 13
Buynnaviridae Set I

AACAGGGTCTTAACTGCCCTCCAGCTGTGACCTTTACCTC
AGATGATAAAGCATGATTGGTCTGA
GTTTATGATGATGGTGCACC
GGTGCAAGTGGAGTTTATCCTTCATT
GGGCCTTATGAAGATTTAGC
TCAATATCGTGCTAGGATCAACGATGCAAATGATCCAGAA
AGATATTCATGAGAGAGTCAAGGAGGCAGTCCCAGGGGAA
AAGACTGGTTTTGTTAGAGTGCCAATCAAGCATTTTGACT
ATTAAATCCAACAGAAGGTCATTAAAGGCTCTTTAATGAT
TGTAAGAGCATTAACCATTCATCCACTGAGGAGGTATGAA
ACAAAAATTAATAGAAAATGGAACCACTTTACTGTTGTCT
AAACTAATATTAAGATCAAAATTATGGCACTATTTGCTCT
GTATTAAATCTGCATTCAGCATCAA
ATACTATCTAAGGCTCTGGTACTGTGTTTAATAGGTTGTA
AATTTATGATACAAAGAAATACTATTTATGGTTTTTGGAA
TAGACAGTCTAATTTGGGAAAGGGTTGTTGATGAACAATA
TAGTGGTCTTTCCTTTTGTGAAACCATGGACTTCTTGAGA

TABLE 14
Buynaviridae Set II

TGTGACCTTTACCTCCAGCCATATGAGACCGCCAATTCCA
GGAGCATCACCTCAGGTTGC
GGGTTTACTATTGACAATGATTTTGATCGATTTTGGGGCA
GAGAAATTCACAATAAACTTAAGGAGTTCTCTCCTGGTAC
GGTTTTGAATGGGGTAAGCCTAAT
ACTGTTGCTCAACCAATATCGGAATAGGATATTGCACTGC
ACGATGCAAATGATCCAGAAACTGCTAAAGATATATTAGC
AGGCAGTCCCAGGGGAAACATCAGCAGTAGAATGTTTAGA
GATCCACAATAGAATGAGAGAATGTGTGCCAGGGGAGGTA
AATCAAGCATTTTGACTGTACAATGCTAACTCTGGCACTT
TAAAGGCTCTTTAATGATTGAGTTGGAATTTCATGATGTC
GATTCATCAAAGAGTCAAGGAGATTCCTCCTGGGGGGGCT
ATCCACTGAGGAGGTATGAATCATCAATCTATGACACACC
ATATATGCATAATGGACTATCAAGAGTATCAACAATTCTT
GAACCACTTTACTGTTGTCTATTGAGGATTGTGTAGGTTC
ATTATGGCACTATTTGCTCTTTCAGTTGTATGGCTACTTA
GGGATTAAAACATATAAAGC
ACTGTGTTTAATAGGTTGTAACATTCTTTGCTGCGTTCCA
ACTATTTATGGTTTTTGGAACGCATGTAGTTCTAATCCTT
ATAAGAAATACTATTTCTGACACTAATGTCTGGTTTAGAA
AGGGTTGTTGATGAACAATATATCACTAACCCAACATTTT
TGGACTTCTTGAGAAGCCTTGACTGGACTCAAGTGATTGC

TABLE 15
Bunyaviridae Set III

ATATGAGACCGCCAATTCCATCATTTCTGCTCTGGACTGA
ATTCAAGATGCAGAGATATTATGAGATTAGAGATAGGATA
TTTTGATCGATTTTGGGGCATCCTTAAGGAATGTCTATGA
GGTGAAAAAAAGATTCTTGC
GGAGTTTGCTATTACTGGCCGCTTTAGTTGGCCAAGGCTT
GGAATAGGATATTGCACTGCCGTGAACCTGAGATAGCAAA
ACTGCTAAAGATATATTAGCTGATCTATTAATGGATCGAC
GTAGAATGTTTAGATTTATTGGATAGATTGTATGCAGTGA
ATGTGTGCCAGGGGAGGTATCTGCAGTAGAGTGCCTGGAT
GATTCATCAGAGAGTTAGGGACCTTGCACCTGGAACGGTA
ATGCTAACTCTGGCACTTCCAACATTTGATGTTTCCAAGA
AGTTGGAATTTCATGATGTCGCTGCTAACACCAGCAGTAC
AGATTCCTCCTGGGGGGGCTTCTGCATTAGAATGTTTAGA
TCATCAATCTATGACACACCAATACCAGCCTATGTGATCA
ATCAACAATTCTTGGCTAGGATTAATACTGCAAGGGATGC
TGAGGATTGTGTAGGTTCTAACCACGATCTAGCTTTGGAT
TTCAGTTGTATGGCTACTTATGCTAGATGCTCATGTAAAA
GTTTTGAGCTTGATTGTTGCT
ACATTCTTTGCTGCGTTCCACTTAAACATCATTAACTATT
ATGTAGTTCTAATCCTTATCTACCTTACATTACATTGCTA
ACTAATGTCTGGTTTAGAACTTGCAACTAGACTGCATCCT
TATCACTAACCCAACATTTTGTGTTAGTGACTATTTTGAA
GACTGGACTCAAGTGATTGCTGGTCAATATGTGTCCAACC

TABLE 16
Coronaviridae Set I

TCTAGTGCAGCTCGACTAGA
TATCCTAAGTGTGATAGAGC
GGCCACGCGGAGTACGATCGAGGGTACAG
TTTTGGTTTGCCCACCATACGGGCAGTTTTCAGACCGCAG
TAAGCATTTTAGTATGATGAT
TTTGATTTTAACGAACTTAAATAATAGCCTTGCTGTGTGC
TTTGTTTTTAACGAACTTAAATAATAGCCCTGCTGGTTTG
TAGTTTAAATCTAATCTAATCTAAACTTTATAAACGGCAC

TABLE 17
Coronaviridae Set II

TCTACTCTTCTCAACTAAACGAAATTTACGTCTTTTTGTG
GTGTCTACTTTTCTCAACTAAACGAAATTTTTGCTATGGC
TGTCTACTCTTCTCAACTAAACGAAATTTTTCTAGTGCTG
TTAACTTAACAAAACGGACTTAAATACCTACAGCTGGTCC
TAAATACCTACAGCTGGTCCTCATAGGTGTTCCATTGCAG
TACTCAATTCAACTAAACAGAAATTTTGTCCTTCCTTCCG
TTTGTCTACTCGATTCAACTAAACGAAATTTTGTCCTTCA
TCCCCTCAACTAAACGAAATTTTTGCCATATGTTTATGGC
GGGCAGTTTTCAGACCGCAGTGTCTTGTCAGGGAGGTCCA
TAGCCTTGTGCTAGATTTTGTCTTCGGACACCAACTCGAA
GTCTAATCCCCTCAACTAAACGAAATTTTTGCCATACTTG
GTACGAATCACTCTTGAACGAACTTAAAATTGCATCATAC
TAGCCTTGTGCTAGATTTGTCTTCGGACACCAACTCGAAC
TCTGTTCTTTAAACGAACTTTAAAATCTGTGTGGCTGTCG
TCTGTTCTCTAAACGAACTTTAAAATCTGTGTGGCTGTCG
TCTGTTCTCTAAACGAACTTTAAAATCTGTGTAGCTGTCG
TAAATCTAAACTTTTTAAACAAGATTCCCTGTTATCCATG
TAATAGCCTTGCTGTGTGCGTGTTGTGTTGTGGTCTGCAG
TTTGTAATCTAAACTTTATAAAAACATCCACTCCCTGTAG
TAATAGCCCTGCTGGTTTGCGTGCTGCGATACCTTTCTGC
TCTAAACTTTATAAAAACATCCACTCCCTGTAATCTATGC
TCTCTTTTAATCTAAACTTTATAAAAACACCCACTCCCTG
TTCATAATCTAAACTTTATAAAAACATCCACTCCCTGTAG
GTTTAAATCTAATCTAAACTTTATAAACGGCACTTCCTGC
TATAAACGGCACTTCCTGCGTGTCCATGCCCGTGGGCCTG
TGTGGCAAACAACCCAAATTAAACAAAACGGACTTGGGTG

TABLE 18
Coronaviridae Set III

TTACGTCTTTTTGTGTATGCTACGCATGCACAATTAGATG
TTTTGCTATGGCCGGCATCTTTGATGCTGGAGTCGTAGTG
TCTAGTGCTGTCATTTGTTATGGCAGTCCTAGTGTAATTG
TAGGTGTTCCATTGCAGTGCACTTTAGTGCCCTGGATGGC
TTTTGTCCTTCCTTCCGGCCGCATGTTCATGCTGCTGGAA
TTTTGTCCTTCAGCACACATGTCTATGTGTGCTGAAGTGA
TTGCCATATGTTTATGGCTAATTGAAATTTCAGTCGGTTG
TGTCTTGTCAGGGAGGTCCAGCCTTGACTTTACTTCTCCG
TTGCCATATGTTTATGGCGAATTGAAATTTCAGTCGGTTG
TCGAACTAAACGAAATATTTGTCTTTCTATGAAATCATAG
TTTTTGCCATACTTGTATGGCGGATTGAAATTTCCCTAGG
TAAAATTGCATCATACGTCACGGTAGGTTTCGTCTTGCTG
TCGAACTAAACGAAATATTTGTCTCTCTATGAAACCATAG
TAAAATCTGTGTGGCTGTCGCTTGGCTGTATGCCTAGTGC
TAAAATCTGTGTGGCTGTCGCTCGGCTGCATGCCTAGCGC
TAAAATCTGTGTAGCTGTCGCTTGGCTGCATGCCTAGTGC
TAAAATCTGTGTAGCTGTCGCTCGGCTGCATGCCTAGTGC
TGTTATCCATGCTTGTGAGTGTGGTTTAATCATAATCTTG
TGTTGTGTTGTGGTCTGCAGCGTTTAGGCGCCGGGCTTCA
TGTAGTCTATGCTTGTGGGCGTAGATTTTTCATAGTGGTG
TGCTGCGATACCTTTCTGCTGCGTCATAGGCGCCGGACTG
TGTAATCTATGCTTGTGGGCGTAGATTTTTCATAGTGGTG
TGTAATCTATGCTTGCGAGCTTAGACTTTTCATAGTGGTG
TGTAGTCTATGCCTGTGGGCGTAGATTTTTCATAGTGGTG
TATAAACGGCACTTCCTGCGTGTCCATGCCCGCGGGCCTG
TGTCCATGCCCGTGGGCCTGGTCTTGTCATAGTGCTGACA
TTGGGTGTGTTTCCTGACCGCACGCGAGTGGGGGGTGGCA

TABLE 19
Filoviridae Set I

AAGCAACTCCAACAATATGC
GAATATTAACATTGACATTGAGACTTGTCAGTCTGTTAAT

TABLE 20
Filoviridae Set II

AAGATTAAAACCTTCATCATCCTT
ACTATGAGGAAGATTAACAGTTTTCCTCAGTTTAAGATAT
AGACTTGTCAGTCTGTTAATATTCTTGAAGAGATGGATTT

TABLE 21
Filoviridae Set II

GTTGCATTGAGCCACATGATTGGACAAAAAA
ACTATGAGGAAGATTAATAATTTTCCTCTCATTGAAATTT
ATTCTTGAAGAGATGGATTTACACAGTTTGTTGGAGTTGG

TABLE 22
Flaviaviridae Set I

CCCCCCCTCCCGGGAGAGCCATAGT
ACCGACGCCTATCTAAGTAGACGCAATGACTCGGCGCCGA
CCCCCCCTAGCAGGGCGTGGGGGATTTCCCCTGCCCGTCT
GTACGTCTATCGGTCCGGCTGGCCCGAAAGGCGGTGGATC
TCAGAAAAACAAAATTAAATTGGTTAATAAAAAATTGCAA
ACCACCTCAGGGCCGAGGAGGGCAGGTCAAACAAAAACCC
CCGGCCTCCCAAAGGGAAAGCCATGGGCATGGGACTGATT
AAAGCGCGGTGCGTCCCGCGCGCTTGGTCCAATGATCAAG
GAAACGCGGGCCGTCCCGTGTTCCGAATCCAGTGGATTTG
AAAACGCCTGGCTAGCGTGTCCCCCTCAAGGGGGCGAAGA
AAAGCGTACGGCGGCCAACGCAGCCAGCCCCTTGGGGCTG
TGGATACATTGTACCAGAGATTAACACGTTGAAATTATTT
TGACAGTTGGTTGGGATCAAATTTGTTCTGTGCGCGTCAC
CTTAACACAGTTCTAACAGTTTGTTTGAATAGAGAGCAGA
GGGGGGCAACCCCCCTCGGCAAAAGCCGAAAGTGGTTGCA
GTGGGAAAGTTTTGAAGCGTTAACGTGTTGAGGAAAAGAC
GGACATTGCCGAGTTGAAACCTTGGTTTCCGGCTGGAAAC
TTTTCAGAGCTTAAGTTGTTTTTAATTTTTGCCGAGAGAC
CTTAACGTAGTGCTGACAGTTTTTTATTAGAGAGCAGATC
GCTCAACGTAGTTCTAACAGTTTTTTAATTAGAGAGCAGA
CTTAACGTAGTTCTAACAGTTTTTTATTAGAGAGCAGATC
AGGGTTGGTGGAAGGAATTGCCCGCATCAGCCAGTCGTGA
TGTTAAGTTGTTAACACGTTTGAATAATTTCTACTGAAAG
CAAGGCTTGAGTTGTTTATAATAGTCGTTTTTCTCGCAGA
CTGTTGAACGTGAGTGTGTTGAGAAAAAGACAGCTTAGGA
TAGTGATCTAAAGTGAGGAGTTATTCTTACTGTCATCAAA
TAGGCAATAAACACATTTGGATTAATTTTAATCGTTCGTT
TTGAAAGAGACATTTTTTTTTCTTTCATCAGCCGTGAACG
TAATAACTTAACTTGACTGCGAACAGTTTTTTAGCAGGGA
TGTGATTGTGGATATTCTTTCTGCAAGTTTTGTCGTGAAC
AGAGATTAGTGCAGTTTAAACAGTTTTTTAGAACGGAAGA
TTGATTAACGCGGTTTGAACAGTTTTTTGGAGCTTTTGAT
GTGAGATTAACACAGTGCCGGCAGTTTCTTTGAGCGTTGA
TGGTTTGAAAGAGATATTCTTTTGTTTCTACCAGTCGTGA
AATTTTAAATCAAAGGAGTTGTTCGGAAAAGTGACCTTGG
TCAGCGAAGGCCGAAAAGAGGCTAGCCATGCCCTTAGTAG
TCAATTTGGTTCAGGGCCTCCCTCCAGCGACGGCCGAACT
CCAATTCGGTTAGGGCCCCTCCCAGCGACGGCCGAACCGG
CGATTGGGTTAGGGAGCCCTCCTAGCGACGGCCGAACCGT
ATAGATTTGGCATAGGCAACACCCCGATGCGAAGGCCGAA
cAAGGCTTGAGTTGTTTATAATAGTCGTTTTTCTCGCAGA

TABLE 23
Flaviaviridae Set II

ATAGTGGTCTGCGGAACCGGTGAGTACACCGGAATTGCCG
ATAGTGGTCTTCGGAACCGGTGAGTACACCGGAATCGCCG
ACGCAATGACTCGGCGCCGACTCGGCGACCGGCCAAAAGG
GGGATTTCCCCTGCCCGTCTGCAGAAGGGTGGAGCCAACC
AACTTCTGTCTTCACGCGGAAAGCGCCTAGCCATGGCGTT
GGCCCGAAAGGCGGTGGATCCTGTGTGTTAGGGTTCGTAG
AACTACTGTCTTCACGCAGAAAGCGTCTAGCCATGGCGTT
TGGTTAATAAAAAATTGCAAACTTTCTTTATGGCCTTCTT
GGCAGGTCAAACAAAAACCCGGTGCTGCTATTGTGGGAGT
CCATGGGCATGGGACTGATTCTCGGAATCATGAACTACGC
CGCTTGGTCCAATGATCAAGCTTAAGAGGATGCTTTTTGG
TTCCGAATCCAGTGGATTTGGTAAAGAGGACGGTTGGAAA
CCCCCTCAAGGGGGCGAAGAACTATTCGGAGAATGCTAGA
CAGCCAGCCCCTTGGGGCTGGCAAAAAGGCTGCTTGGAGA
TTAACACGTTGAAATTATTTCTGAAAACAGAAAATCAGAA
ATTTGTTCTGTGCGCGTCACGCCACTTTTTGTGGCGGGAA
TTGTTTGAATAGAGAGCAGATCTCTGGAAAAATGAACCAA
AAAAGCCGAAAGTGGTTGCAAAGAAATCGCGGCAGCGACC
TAACGTGTTGAGGAAAAGACAGCTTAGGAGAACAAGAGCT
CTTGGTTTCCGGCTGGAAACCACGTCGCTCTTCGTCAAAT
TTTAATTTTTGCCGAGAGACCGTGAGGTTGAACCCGGCAA
TTTTTATTAGAGAGCAGATCTCTGATGAACAACCAACGGA
TTTTTTAATTAGAGAGCAGATCTCTGATGAATAACCAACG
CCCGCATCAGCCAGTCGTGAACGTGTTGAGAAAAAGACAG
TGAATAATTTCTACTGAAAGGGTAGAGAAAAGGAGTTTTG
ATAGTCGTTTTTCTCGCAGAAATGGGAAAGGACGACGGTA
GAGAAAAAGACAGCTTAGGAGAACAAGAGCTGGGAGTGGT
TTATTCTTACTGTCATCAAACACTACAAATAAACACGTTG
ATTAATTTTAATCGTTCGTTGAGCGATTAGCAGAGAACTG
TCTTTCATCAGCCGTGAACGTGTTGAGAAAAAGACAGCTT
GAACAGTTTTTTAGCAGGGAATTACCCAATGTCTAAAAAA
CTGCAAGTTTTGTCGTGAACGTGTTGAGAAAAAGACAGCT
CAGTTTTTTAGAACGGAAGATAACCATGACTAAAAAACCA
AGTTTTTTGGAGCTTTTGATTTCAAATGTCTAAAAAACCA
GCAGTTTCTTTGAGCGTTGATTTTCAATGTCTAAGAAACC
TTTGTTTCTACCAGTCGTGAACGTGTTGAGAAAAAGACAG
GTTCGGAAAAGTGACCTTGGTTCGTTATGAATAGAGGAAG
GCTAGCCATGCCCTTAGTAGGACTAGCAAAAGGAGGGGAC
CCTCCAGCGACGGCCGAACTGGGCTAGCCATGCCCACAGT
CCCAGCGACGGCCGAACCGGGTTAGCCATACCCGTAGTAG
CCTAGCGACGGCCGAACCGTGTTAACCATACACGTAGTAG
TAATAATTAGGCCTAGGGAACAAATCCCTCTCAGCGAAGG
ACCCCGATGCGAAGGCCGAAAAGGGCTAACCATGCCCTTA
cAGCCAGCCCCTTGGGGCTGGCAAAAAGGCTGCTTGGAGA

TABLE 24
Flaviviridae Set III

TGAGTACACCGGAATTGCCGGGATGACCGGGTCCTTTCTT
TGAGTACACCGGAATCGCCGGGATGACCGGGTCCTTTCTT
CTCGGCGACCGGCCAAAAGGTGGTGGATGGGTGATGACAG
GCAGAAGGGTGGAGCCAACCACCTTAGTATGTAGGCGGCG
AAGCGCCTAGCCATGGCGTTAGTACGAGTGTCGTGCAGCC
CTGTGTGTTAGGGTTCGTAGGTGGTAAATCCCAGCACAGG
AAGCGTCTAGCCATGGCGTTAGTATGAGTGTCGTGCAGCC
AAGCGTCTAGCCATGGCGTTAGTATGAGTGTCGTACAGCC
ACTTTCTTTATGGCCTTCTTCCAAATTCTGCTGGCGGTGT
GGTGCTGCTATTGTGGGAGTCATGCATTACGTGACCCACC
CTCGGAATCATGAACTACGCCTCCCACATCGCTCTTGGCA
CTTAAGAGGATGCTTTTTGGCCTGCTGGATGGGAGGGGGC
GTAAAGAGGACGGTTGGAAAACTGATCAATGGCGTTGGTC
ACTATTCGGAGAATGCTAGATGTGAGAGGAGCACCAAGAT
GCAAAAAGGCTGCTTGGAGACGCGTTTGCTGGTAGGGGAC
CTGAAAACAGAAAATCAGAATCAGACGCGATGAATAATCG
GCCACTTTTTGTGGCGGGAATGTGCGAAAATAACAGGAAA
TCTCTGGAAAAATGAACCAACGAAAAAAGGTGGTTAGACC
AAGAAATCGCGGCAGCGACCGACTGCTTTGCCAAGAGCAT
AGCTTAGGAGAACAAGAGCTGGGGATGGCCAAAGGAGCCG
CACGTCGCTCTTCGTCAAATGACGAAAGGCAAAATGAAAA
CGTGAGGTTGAACCCGGCAAGAAATGAAGAGGAAGGATTT
TCTGATGAACAACCAACGGAAGAAGACGGGAAAACCGTCT
TCTCTGATGAATAACCAACGGAAAAAGGCGAAAAACACGC
TCTGATGAACAACCAACGGAAAAAGACGGGTCGACCGTCT
GAAAAAGACAGCTTAGGAGAACAAGAGCTGGGGATGGCCG
GGTAGAGAAAAGGAGTTTTGCTTCTCATGGCAACAAGAGG
AATGGGAAAGGACGACGGTAAGAAGAAGAAGGGGCCGGGC
GAACAAGAGCTGGGAGTGGTTATGATGACCACTTCTAAAG
CACTACAAATAAACACGTTGAAATTATTTCCGGAAGAACA
GAGCGATTAGCAGAGAACTGACCAGAACATGTCTGGTCGT
GAGAAAAAGACAGCTTAGGAGAACAAGAGCTGGGGATGGG
ATTACCCAATGTCTAAAAAACCAGGAAAACCCGGTAGAAA
GAGAAAAAGACAGCTTAGGAGAACAAGAGCTGGGAATGGC
TAACCATGACTAAAAAACCAGGAGGGCCCGGTAAAAACCG
TTCAAATGTCTAAAAAACCAGGAGGACCCGGGAAGCCCCG
TTTTCAATGTCTAAGAAACCAGGAGGGCCCGGAAGAAACC
GAGAAAAAGACAGCTTAGGAGAACAAGAGCTGGGGATGGT
TTCGTTATGAATAGAGGAAGCTTGAAGAAGGGGCCTCCGG
GACTAGCAAAAGGAGGGGACTAGCGGTAGCAGTGAGTTCA
GGGCTAGCCATGCCCACAGTAGGACTAGCAAACGGAGGGA
GTTAGCCATACCCGTAGTAGGACTAGCAAACGGGAGGACT
GTTAACCATACACGTAGTAGGACTAGCAGACGGGAGGACT
GCTAGCCATGCCCTTAGTAGGACTAGCATAATGAGGGGGG
AAGGGCTAACCATGCCCTTAGTAGGACTAGCAAAAAATCG
ATCTCGATGTCTAAGAAACCAGGAGGGCCCGGCAAGAGCC

TABLE 25
Hepadnaviridae Set I

ACCATTGAAGCAATCACTAGACCAATCCA
TTCAAGCCTCCAAGCTGTGCCTTGG

TABLE 26
Hepadnaviridae Set II

CGTGCGGGCTCCCCTCTCCC
TTTGTATTAGGAGGCTGTAGGCATAAAT
TTTTCCTGCTGGTGGCTCCAGTTCCGGAACAGTAAACCCT
TTGGATGGCTTTGGGACATGGACATAGATCCCTATAAAGA

TABLE 27
Hepadnaviridae Set III

AGCTAGGAGATTGCTTTGGTGGCATTATAACTGTTTATTG
GGCTAGACGATTGCTTTGGTGGCATTACAACTGTTTACTG
GGCTAGGAGATTGCTTTGGTGGCATTACAACTGTTTACTG
GCTCGCAGATTGCTTTGGTGGCATTACAATTGCCTCCTCT
GGCTAGGAGATTGCTTTGGTGGCATTATAATTGTTTACTG
TTTCCTGCTGGTGGCTCAACTTCAAGCATTGTCAACCCTG
TCCGGAACAGTAAACCCTGTTCCGACTACTGCCTCACCCA
GACATAGATCCCTATAAAGAATTTGGTTCATCCTACCAGT
GACATAGATCCCTATAAAGAATTTGGTTCTTCTTATCAGT
GAGATCAAGGGAGAAAGCCTACTCCTCCAACTCCACCTCT

TABLE 28
Herpesviridae Set I

CCTCCTCTTCCTCCTCTTCC
GTTTTTAAATACTGACAGTA
TTATAACATGTATTTTGAAAA
GTGGACTTTGCCAGCCTGTACCC
GATAATTACGATTACAGGCATCTTT
GACACCATCTACCAGTGCTACAACAGC
TTACTTCCGGGGCGTAACCCGAAAGTTCTCACCACACCCA
GTGGCCATGAGCCGCCGCTACGA
TGAGATTTTTTCTCAGCATACAAAGGTTACTGATCTGAAT
GGCGTCCTGGCCGTGGTCCAT
GGGGGAGCTAACCCTAACCCTAGCTCTAACCCTAACCCTA
GTTGGACCTGTTATATAGAAGA
GGGTTCGACCCTAAACCCTACCATCCTTCGGCCGACAGCA
GAACGAGCGCTTATTTGCTCGGTCACGGACCAAATCGTAT
GTGATTACATTGGGAGAACAGGGGTACAA
GGTCATGTTCATCAACAACAAGCG
GCCCGCGATCCCGCCAATACCCATAATGCACCTGGGCACT
GGAACCAAACGGACGCGTTATTTTTCGCGGTCGGCGGAGA
GACGGAGACGGGGTCCAGCACAGCAGACAGACACGGGGCA
TTAGGAAGTAGATGATTTTTGCAGGAAGTTCATTATGTGA
GACGGCGTGAAACAGCCCCAAGTAGGGTGTCCGCACCACA

TABLE 29
Herpesviridae Set II

GAACAGTTTTCGTGTCTCACAGATAGCTTTATCATTTCAT
TTGACTGTGGTGGGTGGTATGTCTTTGTCTATGTGTATCA
GCCCCCTCCCCTAGTACACAGAGCCCAGCAGGCAGCTACA
GACCATTCGATGCAAATGTTGGGTGTGTGCACCCCACTAT
GGGCGCAGTGGGGGTTGGGTTGTATGGGGGTTAGGTTGCA
GCGGGGCGACCATCGGGGGGGATGGGATTTTTTGCCGGGA
GGGAAGGTGACAGAGGGTAAAAGGGCTCTCTGCCGTGCGA
GTGGCGGGGGACAGAGGGGAACGTGTGCGTGCTTGTGGAA
GGCTGCCTGCCTGCTCGCTGGCCTGCTTGCTGAGGGGACA
GAAAGTTCTCACCACACCCACTTCCAGGGCGTAACCCGAA
TGGCGGCCAGTCCCAAGATGTCGGGACCAGCCCCGCAAAA
GGCGGGCGGGGGCGGGGTGGGGGATGGGCGCGGAGCGCGA
GGCCCTTGTGTAAACCTGTCTTTCAGACCTTGTTGGACAT
GCGGGGTGGGGGAGGGGCGCGCTTAGGTGGCGGGGCGCGA
TTTCCATTGGGGTGAATGGGGAGGGGGTGGGGGATGGGCA
TCGCCATCGTGATAAGCACACGTTATGGGCGGTGGGGGAT
TCAATAGAAGCGAACGGGCGCTGGCGAGATTCGGCCCAAA
GTTACTGATCTGAATAGCCTCTCTTTATTTTAGCCAGCCA
GCGACGGCCTCGAAGAAAACCGTAGAGGGGAGTGGGGGAT
GGGCGGGGCCGGGACCGCGGGGCGGGGCCGGCCCCGCCCA
GTGCGCGCGCGCGGCGGGCGTGGGGGGCGGGGCCGCGGGA
TCTAACCCTAACCCTAACCCTAGCTCTAACCCTAACCCTA
GAGGGGCGGCGCCCGCGGGGGAGCGGCCGGCTCCGGGGGA
GGGCCGCGGCGAGCGCGCCGGGACGCGCGCCGGGACGCGA
GCGGGCGCGGCGGCGCGGCGCCACGCGCGCGCACTCGCGA
TTTATACCCCCGGGGTTAACAGGTACCCGTCTTATTTCAA
GCTAGCCCTAACCCTAACCCTAACCCTAGGTCTAGCCCTA
GGGGTATTAACCCTAACCCTAACCCTAGGCCCTAACCCTA
TCACGGACCAAATCGTATTAGTCGCCCTGCAGAGATAGCT
TGTCGGCTACAGGCAGAATGAACGCGCAGCATTGCGCGGA
GCTCTTAAACCTTTGCAAAATTTTTGCGTGCCGTTTTGCA
GCCTGTAATTGTTGCGCCCTACCTCTTTTGGCTGGCGGCT
GCCTGTAATTGTTGCGCCCTACCTGTTTTGGCTGGCGGCT
GCACGGGTAGCGGAAGGAAATCAGGAACGCGCCCTCTACA
GGGGGGCCACAAAGGGCGGCCGAGGAGAGGGGCCCGGGAA
GGCGGCGCGTCGGCCGGTCCGGCGGTCGGTCGGGGCGGCT
TGCACCTGGGCACTCTCTTTTTTCCTTTCCTTATCCAAGA
TCGCGGTCGGCGGAGAGAGCCGCCGTGGGGGGCTTTCGCT
GACACGGGGCACTGGGAAAGCACAGAACAACACACGGAGA
GGGGGGCTTTGCGGCGTCGGTCGCGGGCGCGAGGAGGCGA
GGGGGGCTATATTTTTGTCCTCTAGAGGGCGCTGTTGCAT
GTTGCGTGTGTGGACGGCGACTAGTTGCGTGTGGTGCGGA
GTTCATTATGTGATGGTGTGTAGTGTTTTGTTGGTGTGTA
GGGTGAAATTTGGAGTTGCGTGTGTGGACGGCGACGGCGA
TTGGCGCAAGGTTGCGCGTGTCGCTTGCCGCGGGCGTGCA
GTGTCCGCACCACACGACGGTCATTTGCTGGGTGGGAGGA

TABLE 30
Herpesviridae Set III

GATAGCTTTATCATTTCATTAACAGGAACAGAAAACCTAA
GTCTTTGTCTATGTGTATCAAAAAATAAAAATCATGAAAA
GCAGCTACAGCCGCTCAACGCGAGTCCCTCCCCTTGCTCA
GTGTGTGCACCCCACTATCTCTGGTTCTGCAAAGCTTGCT
TGTATGGGGGTTAGGTTGCATAGGATGGGGGCTGGGTGCA
GGGATTTTTTGCCGGGAAACCCCCCCCCGCCAGCCTTTAA
GGGCTCTCTGCCGTGCGAGGCTCCTCACAGACACACAGCA
GTGTGCGTGCTTGTGGAACACTATGGCCTGCTGGCCTGCT
TGCTGAGGGGACAGTAGGCCTGCTTGCTCGCTGGCCTGCT
GAAAGTTCTCACCACACCCACTTCCGGGGCGTAACCCGAA
TGGCGGCCAGTCCCAAGATGTCGGGACCGGCCCCGCAAAA
GATGGGCGCGGAGCGCGAGGGTAGGGTTGGCACACTGCCA
GACCTTGTTGGACATCCTGTACAATCAAGATGTTCCTGTA
TTAGGTGGCGGGGCGCGAGGCTAGGGTTGGCACCAAGCCA
GACCTTGTTGGACATCCCGTACAATCAAGATGTTCCTGTA
GGTGGGGGATGGGCACTCACTAAGAATTGGCAAGGTGCCA
GTTATGGGCGGTGGGGGATGGGATTTCAATGGAGGCCACA
GAGATTCGGCCCAAATCCTCGGATAAATTTTCGCCTCGAA
TCTTTATTTTAGCCAGCCACCGCCCCCCTTAGGTGCGCAT
GGGGAGTGGGGGATGGGATTTTTTTATTAGGCCACGCCCA
GCCGGCCGCGGCCGCGGGGGCGGGGCGCGGGGCGCGGGGA
GGGGGGCGGGGCCGCGGGAGCGGGGGGAGGAGCGGGGGGA
TCTAACCCTAACCCTAACCCTAAGTCTAACCCTGACCCTA
GCCCGCCCGCCGCCGCCGCCCGCCTTCGCGCCCCCCCCCA
GCGCGCCGGGACGCGAAAAACGCGCCCCCCCAAACGCCGA
GCGCGCGGGGCCGGGAGCCCGCCCGGGAGCCCGCCCGGGA
GGTACCCGTCTTATTTCAAACCCTAAACCTAACCACGACT
TCTAGCCCTAACCCTAACCCTAACCCTAGGTCTAGCCCTA
TCTAACCCTAACCCTAACCCTAACCCTAGGTCTAACCCTA
GCCCTGCAGAGATAGCTAGCCCATGGAGCTCCGCGGGCCA
GCAGCATTGCGCGGACACAGTGGGTGACCGAAGCACACCA
GCCGTTTTGCACGTTCATAACGTTTTCCTTTGGTTTCCTA
TTGGCTGGCGGCTATTGCCGCCTCGTGTTTCACGGCCTCA
GGAACGCGCCCTCTACATGACCGCGCATGCGCGGGGCCGA
GGAGAGGGGCCCGGGAAACCCCCCCTCGGGGCCCTCCCAA
GCGTCCGCCGTGGGCGTTGTGGGCGTGTGCCGGGGCGGCT
TTTCCTTTCCTTATCCAAGATGTCCGCCCATTGCCAGGTA
GCCGTGGGGGGCTTTCGCTCCGCCCCGTCGCCGGGCCCGA
GACACACAGAGACCCGCACAGAGGCGACACCGTTCACACA
TCGCGGGCGCGAGGAGGCGAGAGGCGGCGGGGGGAGAGGA
GAGGGCGCTGTTGCATCGATGGTCGTGAGGGTGCTCCTGA
TGCGTGTGGTGCGGAGGACGGCGACGGCGAATAAAAGCGA
GTGTTTTGTTGGTGTGTAGTGACCACGTGGGGTTCCTAAT
GGACGGCGACGGCGACTAGTTGCGTGTGCTGCGGTGGGTA
GGGCGTGCAGGGAGGCCGAAGCGGCGGCCGGAGCCGTGCA
TCATTTGCTGGGTGGGAGGAGCCTAAATGGCCTTAAAACT

TABLE 31
Orthomyxoviridae Set I

TTAAGAGCTCTTGTAGAAGAGTACAATGGAGCATGCAAGG
AAAGAAGAGCAATTGCAACACCCGGTATG
GTTCTTTGTGAACCTTGTATTTGTGAGAACCCAACATGTC
TAGCATACTTACTGACAGCCAGACAGCGACCAAAAGAATT
GATGTACCTATACAGGCAGCAATTTCAACAACATTCCCAT

TABLE 32
Orthomyxoviridae Set II

GTACAATGGAGCATGCAAGGAAGCACCGAAAGAGATGTCG
ACAAATTTAATGGCATTTGTAGCCACAAAAATGTTAGAGA
TTGTGAGAACCCAACATGTCTAGGAATAACAATCCCACAG
GAATCTGATGTCGCAGTCTCGCACTCGCGAGATACTAACA
AGGCACCAAACGATCCTATGAACAGATGGAAACTGGTGGA
AAATCTAATGTCGCAGTCTCGCACCCGCGAGATACTCACA
AGATCTAATGTCGCAGTCCCGCACTCGCGAGATACTAACA
GAACCTGATGTCGCAGTCTCGCACTCGCGAGATACTGACA
AATTTCAACAACATTCCCATACACCGGTGTTCCCCCTTAT

TABLE 33
Orthomyxoviridae Set III

AAGCACCGAAAGAGATGTCGAAGCAATTCACAGACTACAA
AGCCACAAAAATGTTAGAGAGACAAGAAGATTTAGACACA
TAGGAATAACAATCCCACAGGCAGGTTTCGTAAGAAGCGC
GCACTCGCGAGATACTAACAAAAACCACAGTGGACCATAT
AACAGATGGAAACTGGTGGAGAACGCCAGAATGCCACTGA
GCACCCGCGAGATACTCACAAAAACCACCGTGGACCATAT
GCACTCGCGAGATACTAACAAAAACCACTGTGGATCATAT
GCACTCGCGAGATACTGACAAAAACCACAGTGGACCATAT
ACACCGGTGTTCCCCCTTATTCTCATGGAACGGGAACAGG

TABLE 34
Papillomaviridae Set I

TTTGAAAATCCCGCCTTTGA
TATTCAGGATGGTGATATGG
CATTATACTTTTATAAAACA
CTTTTTTTGAAAGGCTTTGG
CCGTAAAAAGAAGGGAGTTGCA
CCATGCTGTAACCCACTTGCTAATGCAGCTGCAGGAACAA
TATGACCAGAAGAGGTATATATAAATAGCTGAGACGTTCG
TTTTGCCGAAGTATGCAGATGGAGGATTCTTATCTACCAA
TAAGTGACCAAGAAGACGAGG
TTACTTTGGATACTCTTATGCTACCTTGCCATTTTTGCAG
CCGCTTTTACCACGGACGCTACGAGAACTCTGTGTGTGGA
CTGGAAATCTTTTTTTAAAAGG
CCTTTAGATGAGGAAGGGAA
TCAGGCAAAATATGTAAAAGA
CGTCCGTGACCTGTGCTTGGAACTAGACATAGAAGTCGGA
CTCAGCGACCAAGAGGACGAGG
TAGAGGAACGGATTGGTACACCACAGATGGCATCAACAAG
TATATAAGAAGACCCCATTGGCTATGGATTTGTTACTGCG
TTACTTTTGGAGATTTATACCTACCTTGTGCATTTTGCAA
TTTTTAAAGGGTATACCAAA
CCAATAACCCAAGTGAGAACAATTTCAATCCAGAGGATTG
TCTGATAATGATTGGGAAAGACGC
TACCATAGGCATATTCAAGTTTTTGCCTGTATCGTTTTCG
TCAATATAGGGTGTTTAGGGT
CGCTTAGGTTGTTGCACCCAAGCACTTCTAGGACTCAGGA
TGTATATAAAAGATGTGAGAAACACACCACAATACTATGG
CGAATTCGGTTGTATATAAACAGAAGCAGGATGCACACAA
TATTTAAATGAACTGTGTGCACAATTGCATCTGCCAGTAG
TATCCAGGAAGAACCTCAAACCTTAAGGTAAGCATGGCGG
CGAAAACGGTTGTATATAAACCAGCCCTAAAATTTAGCAA
TAACTATAAAAAGCTGCTGACAGACCCCGGTTTTCACATG
CGATGGCGGTTGAGCTATATAAAGATATCAGTTGGCCATG
CGGTACATATAAAAACCAACCCAAAAAACCTGATCTGGGG
CGGTGCATATAAAAAGCTCCTGAAACTTTGGTTTTTTGTG
TCAGGTTTCTATAAAAGCTCACACCGCACAAGGTTAGGGA
TTCTATAAAAGGAGGGGTAAACCTGCAGATTTTTGCCCAG
CCGACCGATTGCGGTTTTTTTAACACCAAAGGTTATATAG
TCCGGTCGGAGAGACCGGATTCGGTCTTCTGGCATTCTAG
TCTATAAAAGCACCACACCGCACAAGGTTGCTATCACTTG
TTCCAAGACCGATTTCGGTCCTGGCAACTGTTTCGGTCGG

TABLE 35
Papillomaviridae Set II

TATCATATAAATACTGCTGAACAGTAGATTTCTTCAGAAG
TACGGTGCATATAAAAGAGCTGATCAGCACAGATTTGAAG
TGCTACCTGCAAACTTATTATGTGATGAATTAGTAACCGA
TTAGTATTACCACAAAATTTACTCTGTGGTGAAGAACTTG
CTTTCACTACATGGACCTTTGGGCTCCATCTGCATTATGA
TACTGAGCCATTTTTTTTTTTTCGGCTTCAACTCTGGCAA
TACTGAGCCATTTTTTTTTTTCAGGCTGCACTCTGGCAAA
TTTTTATTGGCCATAAAACTAATTGTTCTGGCCAAGTTGG
CTGCAGGAACAACTGCATGCACTTAACTATCCCACAGATG
TAAATAGCTGAGACGTTCGTAAACTTTAGGATGCAGATGG
CGATTTTTAATATTTCTCTTTTTGATGTGCATCTTCCTTG
CTTTTTCCTTATAAAACTCTGGTGGGAATTTCTCTTGGGA
TATAAAAAGGGACAGTGCATTTCTACTAAATCCTGTCCAG
TGCCATTTTTGCAGTAGTTTTATGGATCTTAATAATAAGG
TCTAAGCGGATGGAGCTTTGCAGTTCCCTTCAACCATGAA
TATTAAGGGACCGCTTTGGGGGTTCAGCACAAATGGCTGA
CGAGAACTCTGTGTGTGGAGAGGGCAGGAGTTTCCTAATG
TTCAAAACGACCGATAACGGTAAGTCTTGGCACGTAGGTG
TCTGATCCTGGCAGTCACTCCTGGAACAACACCGATCCAG
TACTGTACCGGGCGCGATACCAAATATGCCACCTGCGCAA
TTATAATACAAACAGCTAGTATATAAATACAGGCAGTGAA
CTTTTACTTTACTTTGCGCTTTTTGTGATTCTCCTTTGGA
CTGTTCTGGGTTTACTACCGGAGGAATTGGTATTACCATG
TTCAATCGGGCGCGGTCACATTATACTTAGTCATCTCTTG
CTCGAGGAAACACCGCAGGCGCCCGCCAAAAGTCTGCCAA
CTGCCAACTTTTAGGGTATAAATAAGTAGTTTCTACGGAA
TAGAAGTCGGACATCTGAACCTAAATTGTGTGTACTGCAA
CTATGTATGTGGTGCCATGAGCCACTGACCAATCTGGACG
CGGTGTGGGATCCGTCGGGCCTGCAAGCTGTTGCGAGACG
CTGCGGTAGCCGGATGGATAGGACCGTGCACTCCTTTGTG
CTACCTTGTGCATTTTGCAATGACATCTTAACCTTTTTGG
TCGGTGCATATATAAGTGCTGCAGTACACTGCTGGACAGA
TCCTACTGGATACTGACTCTAGTTCTGGTTCTGAGACTGA
TAACAGGTTGTTATTGCCAACTACCATCATCACTTTCAAG
CTTGGAACTTAAATATAGCACGAAAACCGTTTCGAGGCGG
TTTTGCCTGTATCGTTTTCGTATCCTGTAATAATATCCAA
CCGGTACATATAAAAGCGGTTGTAGAAAACAGTTATTTGG
CTTCTAGGACTCAGGATGCTGAGCAGTAAATTCTTGGGAA
TCACATATAAACTGCCGCACCGCTGAAGGTGCTCTCACAA
TGCGCTCAGGAGTGTCTCTGTGCGCGATAAGCATTCCATG
CTATAAAATACACAGGTAAGACTCTGCACAGGACCAGATG
TCCCTGGATGCTCTAAAATGCAAGAATCATAAATATAGGA
CTAGCTACGTGCAAAACAGCTATGTTCGAGGATCCTAGAG
CGAAAACGGTACATATAAAAGCACTGTGTACAACACCCAG
CCACAATACTATGGCGCGCTTTGAGGATCCAACACGGCGA
CCATGCCCTAGGAACATCTTTTTGCTTTGCAAAGAGTATG
TGCCAGTAGAAGAGATATTAATTAATTGTTGCTTTTGCAA
TATCTGAGATCGCATCGGTTGCTGGCACTGTGTATCTGAG
TAAGGTAAGCATGGCGGAGGAAAGCCCATGCACAATTAAA
CGAAATCGGTGATATATAAACCAGCCCAAAAATTGAGCAA
CCAGCCCTAAAATTTAGCAAACGAGGCATTATGGAAAGTG
CGAAACCGGTTAGTATAAAAGCAGACATTTTATGCACCAA
TACATATAAAACAAGGCCCGTAGCATCTGCAGAAGCTATG
CCGGTTTTCACATGGACCTGAAACCTTTTGCAAGAACCAA
TATATAAACCACCCTGGGCAGTGGTCCTTGTTAAGGCAGA
TGTGTTATGGATCTACCAGAGACCATAAGAGACCTCTGCG
TAAAGAAACCGTAGGGTCAGCAAAGCACACTCATCTATGG
TAACCGAAAACGGTGTAACCGAAATGGGTGCATATATAAA
CTGGGGCCACTATGTCTGCACGTTGCGGCTCCACAGCTAG
TTTTTTGTGGCAATGGTAGACTGCCCTGGCGAGCCAAACG
TCCCTGGAGAGATCTCTTCGCGTTTTCTGCCTCATGCCAG
CTATGAACTGGACCTGCAGGACCTGAACATAACCTGCGTG
TTTATATAAAAAGGCCCACCGCACAAGTTTTCACAGACGG
TGCCCAGGAATGCCTTAATGGCGCGGCCACTGAGCATACG
TTATATAGCGACCGTTACAGTTAAACCGGGGTACAGAATG
TCGGTCTTCTGGCATTCTAGGTATAAGCTGTGCCTGTACG
CTATCACTTGTCACTCTGCTCAGACCCTTCCTTCTGCATG
CTGGCAACTGTTTCGGTCGGTATATATAGCATGTTTTGGG

TABLE 36
Papillomaviridae Set III

CTTCAGAAGCTGATGGAGCCACAATTTCCTACTGATTTGG
TCAGCACAGATTTGAAGGAGACTGATGGAGCCTCAGAGAG
TGTGATGAATTAGTAACCGAGGAGGAGGAGCAGCAGGACG
CTGTGGTGAAGAACTTGTGGAGGAGGAGGAGGAGGAGCAG
TATTGCTGCTCTGGGTTTCATTTCACTTTCTGTCATTGTG
TTACATGTAAAACTGTTCACCTGCCAAACATACATGAATG
TTTACATGCAAACTGTTCACCTGCCAAACATATATGAATG
TGTTCTGGCCAAGTTGGCTATAAACAGTTCCTGAAAGGCG
CTTAACTATCCCACAGATGATAGCGACGACTCCACAGACG
TTTAGGATGCAGATGGAAGAAGACAGGTTTCCAACAACAG
TCTTCCTTGCATATTTTGTGGCTATATTTTGGACCTACAG
TTTCTCTTGGGACAGATGGACCTGACATCTGTACATTCGG
CTACTAAATCCTGTCCAGATGGCAGATGGCAGACCTGCAA
TCTTAATAATAAGGCCAGCTACCTTGCTTCTCAACTAAAG
CTTGCGTCTCTTACTGTTTATTTTGCTCTTTTGGGCAGGG
CGTGGACCGACTGCGAGCTCCGTGGTGTATCCTTTGCATG
TTCCTAATGTATCTGTGACTTGCAAGTATTGTAAGAAATG
TAAGTCTTGGCACGTAGGTGGTTATTTGATCGTTGGGATG
CGATCCAGTGGCTTTGCCAAAAGCAGTTTAAACCTGCCAA
TGCGCAATTGTTGTTAGCAACTACTTTCATTACCTAACAA
TAAATACAGGCAGTGAAAGTGTTCCCATCACAATGGCAAA
TTTTGCAGACAGGGCTCGATTTGCGGTATCTCAACTGAAG
TTACCATGTAACTTTTGTAGAGCGCCTCTTTCAGTGCAGG
TATACTTAGTCATCTCTTGTGGTTGTTAACAACAATCTTG
TCTGCCAAGTTTTCTTGGCAGAACATCCATTTGGCTGCAA
TAAGTAGTTTCTACGGAAATTTTCAAATGGAGGAGCCACG
TGTGTGTACTGCAAGAAATGGCTGTCAGCGTCTGATAAGG
TCTGGACGCACTGAACTTTCTTGAGTGTAACCTCTCTATG
CTGCAAGCTGTTGCGAGACGCAGAAGCCACATACCATACG
CCGTGCACTCCTTTGTGGAGCGGCTGGGAATTCCTCGGGA
CTTAACCTTTTTGGATAAGTCTGCGTTTGCATTTGGACAG
CTGCTGGACAGATTGGGAAATGTTTTTTCCCAATCCTGAG
CTGAAACTGCAGAAGCAACCTCTCCTTCATCTTCTGAAGA
TACCATCATCACTTTCAAGTTTTTGCTTGTATCGTTTTCG
CGAAAACCGTTTCGAGGCGGGCTATGGCGCGACCATGGAG
TATCCTGTAATAATATCCAATATATGTATACATAAATAAA
TGTAGAAAACAGTTATTTGGGGGCAATGTCTGCTACTGAA
TAAATTCTTGGGAAAACAGTGCTTATGGTGCAGGGTAGAA
CGCTGAAGGTGCTCTCACAAATAGGTGGGACTATGCCATG
TTCCATGTGTGTTTTGTGGCAATCTGCTAAGCTTTGAAGA
TCAGACAGCTTTCCGAAAGCCTCTGTATCCCATATATTGA
TTATGGCATGTGTCAAATTTGCTTAGAGGCTTTGCTGCAA
TGTTCGAGGATCCTAGAGAACGACCCAGAACGCTACATGA
CCCAGGACATCCATGGATCGTCAGTTATTTGAAAATACAG
TCCAACACGGCGACCCTACAAGCTACCTGATCTGTGCACG
TGCTTTGCAAAGAGTATGGTTTGGAGCTAGAGGATTTGCG
TTGTTGCTTTTGCAATTGCCAGCTAAGCGAAAGATCAAAG
CTGGCACTGTGTATCTGAGATCGCAACGCATTGCCAGGAA
TTAAATCTTTGTGCCTTGCATTTGGACTGCGTTTTGATGA
CCAGCCCAAAAATTGAGCAAGCGGGGCATAATGGAAAGTG
TGCCTCCACGTCTGCAACGACCATAGACCAGTTGTGCAAG
TATGCACCAAAAGAGAACTGCAATGTTTCAGGACCCACAG
TCTGCAGAAGCTATGTCCATGGGTGCACAGGAACCCAGAA
CCAATCCATTCTCAGGGTTGGATTGTCTGTGGTGCAGAGA
TTGTTAAGGCAGAATGGCAAGTACTTCTGCCTCATCACAG
CCATAAGAGACCTCTGCGAGCTCCTGGAGGCCTCTGCAGA
TCCAACTAATATTTTCCTGCTCTGCAAGGACTACGAGGTG
TATGTCCAGCGGGGACGCATACCCCACCAACCTCTTCAGA
CGTTGCGGCTCCACAGCTAGAACTTTATTTGAATTATGTG
TGCCCTGGCGAGCCAAACGAATTGCCCAGGACCATTCACG
TGCCAGACAATGCATTCACTTCTCTAAGCTGTCTTTGGTG
CTGAACATAACCTGCGTGTTTTGCGGAACAGCATTAACAG
TTTCACAGACGGTTCAGGATACTTCTAATACATGCATGTG
CGCGGCCACTGAGCATACGCAGTCTTTGCTTATCCTGGGA
TTAAACCGGGGTACAGAATGGCTCGACCGACATCGGTGGA
TGTTTGGAGGGCATTCATGGCGCGACCATCTTCAGTACAA
TTCTGCATGTCTGCTGATTACTATGAACATCTATACTGTG
TATATATAGCATGTTTTGGGGGGCACTGTTATCAATGGAG

TABLE 37
Paramyxoviridae Set I

AGTGTAGGTAGAATGTTTGC
TATGGGAGGGATTGAGGGGT
AGATTGCTAGTCCCAAAGACCAGAATCATGGGCTGTAATG
AAATAAAACCTTGAAAGGGAGTTTTCCCCTCTCTTCTTTC
ATTCTGTGCCTCATACTCACTCAAAGAGAAAGAAAT
AACAAACCACTCAGGCAAGGTGCTCT
ACCTATGGCCTTCGTGACCGACCTCGAGTCAGAGTAGTTC
AAAAAACTTAGGAGCAAAGC
ACAGTAAGCCCGGAAGTGGTGTTTTGCGATTTCGAGGCCG
AGTAAGAAAAACTTAGGGTGAA
ATCGTAGGCCCGGAACCAGTGTGCTCCGGTGCCGGTTGCG
GGATTAAAGAACTTTACCGAAAGGTAAGGGGAAAGAAATC
GATTAGGCCCGAAGGTGTCTACTTTCGTGGCCGACTGCGG
ATCGTGAGCCCAGAAGTGGTGAATTCCGCGGTCGACAACG
ACCACTAGATTCGGTGCCGGTAACGATTCCAGTTTTATAC
ACTTAGGGTCAATGATCCTACCTTAAAGAACAAGGCTAGG
ACTTAGGATTAATGATCCTATCAATTGGCACAGGATTTGG
ACTTAGGATTCAAGATCCTATTATCAGGGACAAGAGCAGG
ACTTAGGAGTAAAGATCCTACTGTCGGGGGGAGGAGGAGG
ATCGTGAGGGGGAAGCTGGTGGACTCCGGGTCCGGAGTCG
AATTTAGGAGTAAAGCTCCTAAAGCCTGGTTCCAGTACCG
AACTTAGGAACCAAGACAGTGACAATTGGTCTTGGTATTG
AACTTAGGAACCAAGACAAACACTTTTGGTCTTGGTATTG
AGGAGCAAAGTAGTTCTCCTTTGGTTGGGGACTTGGTTGC
ATCTTAGGAGCAAAGATTCTCCTTCTTGGATCTGGGTTTG

TABLE 38
Paramyxoviridae Set II

AATGTCTCTTCAAGGGATTCACCTGAGTGATCTATCATAC
AATCCTTAAAGAATCACAGTACACAATCAAAAGAGATGTG
ATCATGGGCTGTAATGTGATGATGGAGCTTGATTATGGTG
ACAGAAAATGGGCAGTGAAACATTGAGTGTAATTCAAGTC
ACAATAGGCCCGGAAAGTTGGCTAATCGCTAGCGATCTCG
AAGGTGTGAATCTCGAGTGCGAGCCCGAAGCACAAACTCG
ATAAGAATTTGATAAGTACCACTTAAATTTAACTCCCTTG
ATCGTACGGGTAGAAGGTGTGAACCCCGAGCGCGAGGCCG
AATAAGAATTTGATAAGTGCTATTTAAGTCTAACCTTTTC
AGTAGTTCAATAAGGACCTATCAAGTTTGGGCAATTTTTC
AATTAGGATCAAAGACTCCAATCTACTGGGATTGTCTTTG
GAGGCCGGGCTCGATCCTCACCTTTCATTGTCGATAGGGG
AGGGTCAAAGTATCCACCCTGAAGAGCAGGTTCCAGACCC
ACGGGTTGGTTGACCGGGCCTTTCAATTCGGACTGTTATC
AAGGTAAGGGGAAAGAAATCCTAAGACTGTAATCATGTTG
ACTTAGGATTAAAGACATTGACTAGAAGGTCAAGAAAAGG
ACACTTCTTACTAAGCCAATCAATACTAACTGCCAAAATG
AAATCGAGCCCAGAAGTGGCAAAGATCGCTGTCGAATCCG
AATTCCGCGGTCGACAACGACCAAGAAACATTGCTTCTGG
AAAGTAATACTTTAAAGGGACAAGTCACAGACATTTGATC
AACGATTCCAGTTTTATACTATCTGATCATTCTCTATCTC
AAGAACAAGGCTAGGGTTCAGACCTACCAATATGGCTAGC
AATTGGCACAGGATTTGGATAAAGGTTCACAGTCATGGCG
ATTCAAGATCCTATCGACTGGAGCAGGCTTAAGGTAAAGG
ATCAGGGACAAGAGCAGGATTAGGGATATCCGAGATGGCC
GGGGGAGGAGGAGGAGCAAGATCTTTGACTATGGCGACTC
GGACTCCGGGTCCGGAGTCGGTGGACCTGAGTCTAGTAGC
GGCACCAAACCTACAATAATGTCTGGGGTGCTAAGTGCAC
GGCTTAGGAACAAAGTTTCCTATCGTGGGATCTGGTTCCG
GACAATTGTTCAAGGTTCCAAAATGAGTGATATATTTGAC
AAGAAATATATCATCATGAGTGATATCTTTGAAGAGGCGG
GGGACTTGGTTGCTCCACAATGTCGAAACTTAATAAGGTG
GGATCTGGGTTTGGGATAACCAAAATGTCCCGACTTGGAC

TABLE 39
Paramyxoviridae Set III

AGTGATCTATCATACAAGCATGCTATATTAAAAGAGTCTC
ACACAATCAAAAGAGATGTGGGGACAACCCCAGCTGTCAC
GGAGCTTGATTATGGTGGACGAGCTGCATGGCTGGCATTC
AGTGTAATTCAAGTCAGATTAAGGAATATATATGATAATG
GATCTCGATATCGATATCTGTTCTTTTTTAAGTTCAGACC
AAACTCGAGGAAGCCTTCTGCCAACATGTCTTCCGTATTC
AATTTAACTCCCTTGGTTAGAGATGGGCAGCAATTCATTG
AACCCCGAGCGCGAGGCCGAAGCTCGAACCTGAGGGAACC
AGTCTAACCTTTTCAATCAGAAATGGGGTGCAATTCACTG
AGTTTGGGCAATTTTTCGTCCCCGACACAAAAATGTCATC
GGATTGTCTTTGATCAATTGTCATAACAATTATGGAGTTG
GATAGGGGACATTTTGACACTACCTGGAAAATGTCGTCTG
AAGAGCAGGTTCCAGACCCTTAACTTTGCTGCCAAAGTAC
AATTCGGACTGTTATCCAAATTGCTCTCATCATGTCGAGC
AGACTGTAATCATGTTGAGTCTATTCGACACATTCAGTGC
AAGGTCAAGAAAAGGGAACTCTATAATTTCAAAAATGTTG
ATACTAACTGCCAAAATGTCGTCTGTGCTGAGTATGTTTG
AAAGATCGCTGTCGAATCCGATAGTGAGATTCCGCTTCTG
AAGAAACATTGCTTCTGGGCACTTGCACAGGTTGTCTGTC
AAGTCACAGACATTTGATCTTAGTATAAATTTTTATAATG
ATCTGATCATTCTCTATCTCTATTAAGGATATTTCTAGTC
ACCTACCAATATGGCTAGCCTTCTTAAAAGCCTCACACTG
AAAGGTTCACAGTCATGGCGACACTTCTTCGGAGTCTAGC
AGGCTTAAGGTAAAGGTTCTTTAAAATGGCTTCTCTCTTG
GATATCCGAGATGGCCACACTTTTGAGGAGCTTAGCATTG
ATCTTTGACTATGGCGACTCTTCTTAAAAGCTTAGCATTG
GGACCTGAGTCTAGTAGCTTCCCTGCTGTGCCAAGATGTC
GAGTTCAAAGATGCAAGACTTGCATCAAAAGGAGAGGGTC
GGGATCTGGTTCCGGTTAACTCTACAAACCAGATAACATG
AATGAGTGATATATTTGACGAGGCGGCTAGTTTCAGAAGC
ATATCTTTGAAGAGGCGGCTAGTTTTAGGAGTTATCAATC
AATAAGGTGTTGGATGAGTTCCGTGACTTCAAAAATAACC
AAATGTCCCGACTTGGACCTGCGTTGGATGAGTTTCGCTC

TABLE 40
Parvoviridae Set I

CATATTAAGTTAACGGTTTCTGCGAAGCGCTTCGCAGGAA
ACAGTTACTATTAGTAACGATCTGTCAGATCTGTATCTTG
CTGGGTGGCCGAGAAGGAATGGGA
CCCTGGGGGTACTTTGACTT
CTGGCCAGCACTCCGGTGAGGTAATGCCGTCACGTGGTCG
GGGTGGCAGCTCAAAGAGCTGCCAGACGACGGCCCTCTGG
CCAGACAGTTACATTGAAATGATGGCTCAACCAGG
GCGCACCTTCGGCGCTGGTGTTGGGCGCTTCGCGCTTGCT
CCTAGCTACGATGAAGTATTACTTAACGCTCA
CCGGCGGCATCTGATTTGGTGTCTTCTTTT
GCTGTGTGGTACGAAGTGCCGCTTCGCGGCACCACACACG
CCAATAAGAGACAGAATGTT
ACTCATAGTTATATAACACACTTATGAATATGCTAATACA
CCGGTCATGTGACTTCCGGT
GCCTCAGATCGTCGATATAAGCGGAGCTTTTCTGTGACTG
GCCACGCCCTTCCGGTTCCGGTGACGTGCTTCCGGCCACG
ATAAAATAATAAATATTCACAAGGAGGAGTGGTTATATGA
GGGAGTCGTCGACCTTGACTTCAACCGAACCATGGTTATT
ATATATAGCTATCAAGTACAGTTCTACTTTTGCATTGACG
ACACATGGCCTTTGGCCGTGTCCATGGTGTGGTGGTGGTG
ATATAATAAAAAGATAGCAGGTATCCAGTAGGCGACTAGG
AATGCGAGCGGCTGCGCCGCTGCGCGCTTCGCGCGCGCAT
ACGTGTCGCTCACGGCTAGGGGGTTGGGTTACGAGTGTCG
CCTTCTGGTCTACTGACCTTTGACCTTCT
GCCCGGCGAAGCCGAGCCGCCGCGAAGCGGCGAGCGACTG
ACGGCGAGCAGCGGGCCTTCGGCCCCCCTTCGGGGCTGCT

TABLE 41
Parvoviridae Set II

CGAAGCGCTTCGCAGGAAACCGTTACAACCTATGACGTCA
CTGTCAGATCTGTATCTTGGAGTATCCGTATCACGAAATA
CCAACATGTGCGCCGTGATTGACGGGAAC
AAGGCCGTCAGCTGCCGAGCTTCGCTCGGCAGGCCCCAAG
GCCAGACGACGGCCCTCTGGCCGTCGCCCCCCCAAACGAG
GGGGGCCGGTAGCGACGCCTTTGGCGTCGCGGCCCGAGTG
GCCAGACGACGGCCCTCTGGGCCGTCGCCCCCCCAATCGA
AGGGGCCCCTAGCGACCGCTTCGCGGTCGCGGCCCGAGTG
AAGCAACTGTATAAGTCAGTTACTTATCTTTTCTTTCATT
AAAGGTCTCCAGACTGCCGGCCTCTGGCCGGCAGGGCCGA
AGGAAATGGGCGTGGTTTATGGTATATAAGCAACTACTGA
GGGCGCTTCGCGCTTGCTAACTTCATATTGGTTGAGAATT
ATTGCGATGACCACGACGCGCGAAGCGCGTCACTTCGTGT
AAATTTTGGCGGGCTTTTTCCCGCCTTATGCAAATAAGCG
GCTTCGCGGCACCACACACGGGCCAGTACTGGGGGTGTAG
GCTACGCGCGCTGCCTTCGGCAGTCACACGTCACCATCAG
ATTTTCGCTGACCACGACGCGCGAAACGCGTCACTTCGTG
ATGAATATGCTAATACAGAGATTAGAATATCCAATCATAT
CAAGTTCCGGTCACATGCTTCCGGTGACGCACATCCGGTG
ACGTGTCTCCTGTCACGTGACTTCCGGTGACGCACTTCCT
CGCTACGCGCGCTGCCTTCGGCAGTCACACGTCACTTACG
CGCTTCGCGCGCTGCCTGCGGCAGTCACACGTCACTTACG
CTGCGCGCGCGCCTTCGGACGTCACACGTCACTTACGTTT
GCTGCGCGCGCTGCCTTCGGCAGTCACACGTCACTAGCGT
CGGAGCTTTTCTGTGACTGTACGTAGTGTATTGATCTTCG
GACGTGCTTCCGGCCACGTCAACTTCCGGCCACGTCAACT
GGAGGAGTGGTTATATGATGTAATCCATAACCACTCCCAG
CTGCGCGCGCTGCCTACGGCAGTCACACGTCATACGTACG
CCGAACCATGGTTATTTACATTTAATGAAATCAACCGGTT
CTACTTTTGCATTGACGTCATAAGTCACGTGATTTTGTAT
CCATGGTGTGGTGGTGGTGGTTGTGGTGGGGTATAGCGAA
ATCCAGTAGGCGACTAGGTGGGGGTGACGTCATCACTATT
CGCGCGCGCATTGTAAGGCCTAATCGGGCAGCCAATATGG
ATGGCGGACAATTACGTCATTTCCTGTGACGTCATTTCCT
GGGTTGGGTTACGAGTGTCGAAAAAATTTACATAAGAGGA
CCGCGAAGCGGCAAGGGACTGCCGTCGTCGTCGTCGGTGG
GCCGCGGCAGCTTCGCTGCCTCGACTGCCGTCGTCGTCGT
GGCGAAGCCGGGCCGCCGCGAAGCGGCGAGCGACTGCCGT
AAGCGGCGAGCGACTGCCGTCGTCGTCGTCGGTGGCGATA
GCCCCCCTTCGGGGCTGCTGGAGCCTGATAAGGCTTATCG

TABLE 42
Parvoviridae Set III

CGTTACAACCTATGACGTCATAGGTCCTATATAAGAGATG
AGTATCCGTATCACGAAATAATATTTCTTTTCTATATCAT
CACGCTGCCGCGTCAGCGCTGACGTAAATTACGTCATAGG
CGCTCGGCAGGCCCCAAGAGAGAGCGCGCGCGATCACTAG
CCGTCGCCCCCCCAAACGAGCCAGCGAGCGAGCGAACGCG
AAAGGTCGCCCGACGCCCGGGCTTTGCCCGGGCGGCCTCA
GGCGTCGCGGCCCGAGTGAGCGAGCGAGCCTGTTTTGGAA
CCGTCGCCCCCCCAATCGAGCCAGCGAACGAGCGAACGCG
CGCGGTCGCGGCCCGAGTGAGCGAGCGAGCCTGTCTTGGA
CGCAGACGGCAGAGCTCTGCTCTGCCGGCCCCACCGAGCG
GCCAGACGGACGTGCTTTGCACGTCCGGCCCCACCGAGCG
ATCTTTTCTTTCATTCTGTGAGTTGAGACGCACAGAGAGA
CCTCTGGCCGGCAGGGCCGAGTGAGTGAGCGAGCGCGCAT
ATATAAGCAACTACTGAAGTCAGTTACTTATATTTTCTTT
CATATTGGTTGAGAATTAATCCGTGTCTTTCCTGTGGAAT
CGAAGCGCGTCACTTCGTGTGGTCACTACGTATCGCAATA
CCGCCTTATGCAAATAAGCGGCCATGTTTAATGTTATATT
GGCCAGTACTGGGGGTGTAGGGTGTGGTAAAATCGCAAAT
CAGTCACACGTCACCATCAGCAAAGACAGTTGGTCAGTTT
GCGAAACGCGTCACTTCGTGTGGTCACTTCGTAGCGAAAA
ATTAGAATATCCAATCATATTGAAACACAAGTACTGCAGT
GACGCACATCCGGTGACGTAGTTCCGGTCACGTGCTTCCT
ACGCACTTCCTTTGATGACGTATTTCCGGTTGTCAAGGCT
GCAGTCACACGTCACTTACGTCTCACATGGTTGGTTAGTT
GCAGTCACACGTCACTTACGTCTCACATGGTTGGTCAGTT
CACACGTCACTTACGTTTCACATGGTTGGTCAGTTCTAAA
AGTCACACGTCACTAGCGTTTCACATGGTTGGTCAGTTCT
ACGTAGTGTATTGATCTTCGTGTTCTGGAACTCAGGTATG
AACTTCCGGCCACGTCAACTTCCGGTGACGTATTTCCGCT
CCATAACCACTCCCAGGAAATGACGTATGATAGCCAATCA
AGTCACACGTCATACGTACGCTCCTTGGTCAGTTGGTTCT
AATGAAATCAACCGGTTCATGGTTGAAGTCAAGGTCGACG
AGTCACGTGATTTTGTATTATAAATAGTATAAATACTCCT
GGGGTATAGCGAAGCTATGGCCAAGCACCAAGGGGAAGGG
GGGGTGACGTCATCACTATTTACTCAAGTGTTTTGTTATT
AATCGGGCAGCCAATATGGTGGATGCAGGAAATGAGTAAT
CCTGTGACGTCATTTCCTGTGACGTCACTTCCGGTGGGCG
AAAAATTTACATAAGAGGAACGAATATTAATGAGGTGGCG
GCCGTCGTCGTCGTCGGTGGCAATACTCGTAGAGTATAAG
CGTCGTCGTCGGTGGCGATACTCTAAGAGTATAAGCAAGT
GGCGAGCGACTGCCGTCGTCGTCGTCGGTGGCAATACTCT
CGTCGTCGTCGGTGGCGATACTCTTAGAGTATAAGCAAGT
GAGCCTGATAAGGCTTATCGCGGAGCTAGGGGCGGTGCGT

TABLE 43
Picornaviridae Set I

GTGGTGCTGAAATATTGCAAGC
TACTGGGGGGTGTGTGGGACCGTACCTGGAGTGCACGGTA
TGGTGGTGGAAGTTGCCTGAT
TTGGAAGCTAGGTACTCGTTACGCAAGTTTTGGATTATCT
GGTCAAGCACTTCTGTTTCCCCGG
CTGGTACTATGTACCTTTGTACGCCTGTTTCTCCCCAACC
TACTCTGGTATTACGGTACCTTTGTACGCCTGTTTTACAA
TTGCTGAGTTTCTCTAGGAGAGTCCCTTTCCCAGCCAGAG
ACTCTGGTATCAAGGTACCTTTGTACGCCTATTTTATTTC
TACACTGATATCACGGTACCTTTGTACGCCTGTTTTATCT
TTGTACGCCTATTTTATTTCCCCCCCCTTTTTGAAACTTA
ACTTGGTATTCCGGTACCTTTGTACACCTATTTACAAACC
ACTCTGGTATTACGGTACCTTTGTACGCCTATTTTACCCC
ACTCTGGTATCACGGTACCTTTGTGCGCCTGTTTTACATC
GTACTCCGGTACCCCGGTACCCTTGTACGCCTGTTTTATA
CACTCTGGTATTACGGTACCTTTGTGCGCCTGTTTTATTT
GTAATCTGGTATCAGGTACCTTTGTACGCCTGTTTTATAT
TACTCTGGTTCGTTAGAACCTTTGTACGCCTGTTTTCCCC
CACACTGGTATCTCGGTACCTTTGTGCGCCTGTTTTATCC
TGAGGGGACTTGATACCTCACCGCCGTTTGCCTAGGCTAT
ACCCTCCCTTCCACATAGGACGAATAAACGGACTTGAGAT
AAAGCAGATAGAGGTTCTGAACTGGCAAACTTTACCTCGA
CCACACCTGGTTGGTTCCCAGGTTCATACAATAACCATCA
AATTGCCTGTAGCGTCAGTAAAACGCAATACACAAGATTT
GGCTGGGTCCGTGACTACCCACTCCCCCTTTCAACGTGAA
CCCGCCTTAGGTCCATTGAAAAGACCAAACATGTCATCCC
GCGGACGGAGATCATCCCCCGGTTACCCCCTTTCGACGCG
GCATTGCACTCCACACTTACGTTGTGCGTACGCGGGGCCC
GCGGTAAAGAACACCCCAGGGGTAACCCCTTTGAACGCGG
CTTACGGGAGTTAGGGCCAAGGATCTGTTGCATAGGCGTT
GCGTCGCACTCCACACTTACGTCTCTGCGAGTGTAGGAAC
CGATACACTCCACACTTACGTTCTTGTGTGCGCGGGACCC
GCGCTGCACTCCACACTTACGTTTGTGCACGCGCGGGAAC
CGGTTGAAACGCTACTACTCAGACCTCTGGCTGTCGTACC
TGCGACTCACCTCGCACTTACGCCATCGCTCTTCGGTGGC
CTTCTTCGGAACCTGTTCGGAGGAATTAAACGGGCACCCA
TAAAGGATTATGGACTTATATGATGTGCCCGACATGGAAT
GCGCATGTTCGCGTCGTCGTAAGTCTGGATTCCCAAGGCC
AACGCCTTGGTGGATGCTCAAAGAAGATTACTCTTGATGC
AGAAGATTACTCTTGATGCTTGGCTCTCAGAAAGAATGGC

TABLE 44
Picornaviridae Set II

CTCTCCTGCCCCTTCCCCTGAGCCGGGGATCTTGGCTCAT
CGTACCTGGAGTGCACGGTATATATGCATTCCCGCATGGC
GCTCTTGTATCCCGGTACACTTGCACGCCAGTTTGCCTCT
ACGCAAGTTTTGGATTATCTTGTGCCCAACATTAGTTCTC
ACTCTGTTATTACGGTAACTTTGTACGCCAGTTTTTCCCA
ACGCCTGTTTCTCCCCAACCACCCTTCCTTAAAATTCCCA
TTTGTACGCCTGTTTTACAACCCTTCCCCCATGTAACTTA
AGTCCCTTTCCCAGCCAGAGGTGGCTGGTCAAACAATACC
TTGTACGCCTATTTTATTTCCCTTCCCCCACAGTAACTTA
TTTGTACGCCTGTTTTATCTCCCTACCCCCATCGTAACTT
CCCCCCCTTTTTGAAACTTAGAAGTTAATAATAAACACGC
TGTACACCTATTTACAAACCCTACCCCTTGTAACCTTAGA
TTGTACGCCTATTTTACCCCCTTCCCCTTGTAACTTAGAA
TACACTGGTATGCCTTACCTCGGTATTACGGTACCGATGT
TTGTGCGCCTGTTTTACATCCCCTCCCCAAATTGTAATTT
CCTTGTACGCCTGTTTTATACTCCCTTTCCCAAGTAACTT
TACCCTGGTACGCTAGTACCTTTGTACGCCTGTTTTTCCC
TACTCTGGTACGCTAGTACCTTTGTACGCCTGTTTTCCCC
TTTGTGCGCCTGTTTTATTTCCCTTCCCCATTGTAACTTT
TTTGTACGCCTGTTTTATATCCCTTCCCCCGTAACTTTAG
CACTCTGATTCTACGGAATCCTTGTGCGCCTGTTTTATGT
TTTGTACGCCTGTTTTCCCCTCCTTAAACAAATTAAGATC
TTTGTGCGCCTGTTTTATCCACCCTAAACCCCGTTGTAAC
GTACTCCGGTATTGCGGTACCCTTGTACGCCTGTTTTATA
CCGCCGTTTGCCTAGGCTATAGGCTAAATTTTCCCTTTCC
CGAATAAACGGACTTGAGATTAAGGCAAGTACATAAGGTA
ACTGGCAAACTTTACCTCGAAACACGCCCGTTTTTCTGCT
GGTTCATACAATAACCATCAATAAACTTTTAACATCTAAG
GCATGCATGCATCGACTGCTTGGGGGTGTCCCTGACCCCC
AAACGCAATACACAAGATTTGAGCCTGTAGCGTCAGTAAA
TATGATCTCACCGCAGCCTGCTTGGGGTTATTCCCAAACC
ACTCCCCCTTTCAACGTGAAGGCTACGATAGTGCCAGGGC
AAGACCAAACATGTCATCCCTTGGATGCTGGCTAATCAGA
GGTTACCCCCTTTCGACGCGGGTACTGCGATAGTGCCACC
GTTGTGCGTACGCGGGGCCCGATGGACCATCGTTCACCCA
GGTAACCCCTTTGAACGCGGGACTGCGATAGTGCCACCCC
GGATCTGTTGCATAGGCGTTGTATCCCCTAACCTTTTACC
GTCTCTGCGAGTGTAGGAACCGACGGACTGTCGCTCACCC
TTCTTGTGTGCGCGGGACCCGATGGACTTTCGTTCACCCA
GTTTGTGCACGCGCGGGAACCGATGGACTTTCGTTCAACC
AGACCTCTGGCTGTCGTACCTCTATTAGGCAGGCAGGAAC
AGACCTCTGGCTGTCGTACCTCTATTAGGCAGACAGGAAC
CGCCATCGCTCTTCGGTGGCCCAGATGGACTTCCGTTCAC
AGGAATTAAACGGGCACCCATACTCCCCCCACCCCCCTTT
TGTGCCCGACATGGAATTCGGGAAATCTGGATCTAAGGGT
AAGTCTGGATTCCCAAGGCCCACTCGGTTCAACTTCGGTT
TGGCTCTCAGAAAGAATGGCACCTCAAAGTTTTGAGACCC
TGGCTCTCAGAAAGAATGGCACCTCAATGTTTTGAGACCC

TABLE 45
Poxviridae Set I

TCATTTATTTAGTATTAAATGAC
GCAGGCGGAACTTCTCGCAGGTG
TAAAAAATTTAATTAATTTA
TTTTTATATTATCCATTAGATC

TABLE 46
Poxviridae Set II

TTGAAATTAATCATATACAACTCT
GCTTTTACATCCAACGTGTTTAAAACAGATTAATTAATTG
TGAATGCCCTTGAGGACGGGCGTCCGCAGAAACGCGACTC
GTTTTTAATGAAAAACGGCTTTTAAAGCCAACGTAAATAG
GTTAATTTACTTACCTTAGGTATAGATAAATATAATCATC
GTGCTGATTTAACTAGCGAAATATCGTTGTCAGAAACGAG
TCATTCAATCTTTTAAGTCTAATTGAAGCCAATTTAAATC
CAATTAAGTAGAAGCCAATTAAACCTAATAAGTAGAAGCC
GAAAGGAGGTAATATGGAGGAGTTTTAGAGACCTTTCTTC
GAGGGATTTAGAGACCTTTCTTCCACGTTAGAACGACGAC
GAATAAAACTACCCGAATGATGGGTTTATTCCTTTATGAA
TTCTCCCTCTCTTTCCGGAGGCTAAATTTGAGCCTATTTC
GCACGTACAAAGGGCGCCCTGACGGCACTAAGGACGAGAG
CTATAGAAATTTTAGAAATTATATTTAATTATACAGATAC
GCATTATATCTAAAATACATCAAATACAATTTAAAATACA
CCATACGGTTTTACATAAAATAATACTATATCTAATTTCC
TCTCCAGTGTTAACGAGTGTTACGAGGTAACGAGTGTTAC

TABLE 47
Poxviridae Set III

GGCTGACTCGAGAACTCGGGAGGCGGTCGTGCGGACGCAC
CAGATTAATTAATTGCTAAAAATGTCCATCAAGCTCTCCA
GTCCGCAGAAACGCGACTCCGCGGAAGAGGACTCCGACTC
CCAACGTAAATAGAATTTTTTGTTTTAATTGTTAAAAATG
TCATCTATTATTTTTATTAAAAATAATAATTTATAAACGG
GTTGTCAGAAACGAGGTCTCGAAGCAATACCAACACTTTC
TTGAAGCCAATTTAAATCTAATTATAAAAGCCAATTAAAC
GTTTTAGAGACCTTTCTTCCACGTTAGGACGAAAGCGTGA
CCACGTTAGAACGACGACGTAAGGACGAAAGGGAGGTTTC
GGTTTATTCCTTTATGAAGGTATGGGAAAGGGATAAAATG
GAATGGTTTGCATTTATTGTAGACGTAATAATGCACTACA
GCTAAATTTGAGCCTATTTCTAAGGGCCTCCGGACGCCGC
GACGGCACTAAGGACGAGAGTCCTTACGGCACTAGGAGAA
GTAAATTATATATATAATTTTATAATTAATTTAATTTTAC
GTGTCTAGAAAAAAATGTGTGACCCACGACCGTAGGAAAC
GCTTTATAGAGACCATCAGAAAGAGGTTTAATATTTTTTG
TTTTTTTACGACTCCATCAGAAAGAGGTTTAATATTTTTG
CTATCAGAAAGAGGTTTAATATTTTTGTGAGACCATCGAA
CATACATAAAATTATAATTTATATATTTAAAATATTTAGA
CAAATACAATTTAAAATACATCAAATACAATTTAAAATAC
TCTAATTTCCTTCCGGAAAATATTTTATAAAGCTACCCAA
CGAGGTAACGAGTGTTACGAGAAATCTCAAATGTTACCTC

TABLE 48
Reoviridae Set I

CCATTAGGAAGAAGAGATGT
CGAAATTTATCATATACTTCTCTCGTTTATAATAATCCAA
CACGCCAAGCAAGGAGTGTA
GAATACATTATGGAATGGAAA
CGAGTGGTCGAACGCTTTTATCCAGGGATAGCATTTGATA
GAGCTGCAGAACGGATATTAAATGGAATCAAATTAAGGAG
GAAGAGGTGGATCTACTGAACAAATTTGAAGATAGTCATT
GAATTTCTAAATTACAAAGCTGTTGTTGAATTACAGAAAT
CGATGATTTGAAGACTATTGATAAATGGGAGAAACAACAA
CCACCGAGCACACCGCCAATAA
GAATAAGGAACCAATGATGAAACGCAAGAACAAACGATAA
CCATCACCGAAATTCTCAATGACTCAAACACACCACAGAT
CGAATGACGTGTTTGAAGATGCAGCAAAAGCATTCTCTAT
CATTTCAGGAATTATTGATCAGTCTAATGATATATTTGAG
GCGACAGTACGTCGTACTTACTTACCAAACAGATACGATA
CGAAATAATGAAGAGAAACATAAACAACCAGAAGCTAACG
GCATCCCATCACGGCATCTTTACCACAATTTTATCATTCT
GACGAAGATATTGATACGTTCGAGAAAAGAGATAATGAAA
CGGATATCATTCCGCATTTGCTATGCCTCTTCCAAGAGAT
CGCAAATGTCTAATACGGATTTACAGTTTTGTACCACAGT
CCCTTACACTGCAACAGATTACAAAACGACTACACTTACT
CGTTTACATTTAACCTGATTGCGCGCTACATATCACACTA
CTTTACATGAAGTACACGGTAGATTTGAAACGTCGGGTTT
CAGATGTCGAGTCATACATATTTCCGCGTATCCGGGAGAT
CTTGATCTGGTACGCAGAGAACTCACGGACACACCACAAA
GACTCAGTAAACAAGTTTGAAATTGATTTAAAAAGAATTT
CCGATCTTATCCATAATGGTGTACC
GCCTTATCCCTGAAATGCAAGCAACTAATACATTCATCAA
CAATACCTTATCCCTGAAATGCAAGCAACTGACACATACG
CCGTTTGTCGAGCAAAAGAGAAATGCCTAGAAAAATACAA

TABLE 49
Reoviridae Set II

CTTGCTAGTAGATATCTTAAATTTGTTTATGATTTTGAAA
CGTTTATAATAATCCAAAAGTCGCAATTGTAGAGTTACTG
CTCGATCTCTTCGCCGATCAGGTCCCCCCTTTACCGGGAG
CATTCATATATAATTCACAATCCGCAGTTCAAATTCCAAT
CCTGGAGCTCCCTATTTGGATGGTGACGTGTTATCCAGAG
CCAGGGATAGCATTTGATATAAATGAAGGAGCATGTTATA
GGGCTTTAAATCGATTATTTAAGTATGGGAGGATAGATGG
GGAATCAAATTAAGGAGAAACGCCGCCCAAGATTTTTATT
GCTGCTCGAATTCTACCTGGAATACATTTCAACCAGAATG
CAAATTTGAAGATAGTCATTTTAAACAATTAGAAGTATTT
CCAAACTAAATAAATTATTTCCAGGAAAACGACAAATCTT
GGGAGAAACAACAATTGTCCGTTTATGATGAGTTATATGG
CACCGCGACTGTCCGACGTCCGCTTAGGCTACGTCGATAT
CGCAAGAACAAACGATAACAATCAATTAATGAAATAATAA
CAAACACACCACAGATTCTTCTTCATTATGCGAACATCGT
GAGAGCATTTCAGGTATCACTGATCAATCGAATGACGTGT
GATATATTTGAGGAGGCAGCAAAGGCGTTTTCGGCATTTA
CCTCATTGACCGCCTCACCAACCATACACAACACAACGTA
GCAGCAAAAGCATTCTCTATGTTTACTCGCAGCGACGTCT
CACCTCTACGACACGTCGTACATTTTTACCTCTCAGATTT
CAACCAGAAGCTAACGGCAGTGCAGATAATGGAGAAGGAG
CATTCTACACCAATCGCTGATTCCATCCAACCGACTGTTA
CAAATTGAAAAAAATGAACCAAAACCGAGAGAATCAACTT
CTATGCCTCTTCCAAGAGATAATCCAAGCCAACATCCAAA
CAGTTCTTAACAATCAGATTCTTCTTCCTTTAATTGCATT
CAAAACGACTACACTTACTTATTTCCACGCAACATAATCT
CGCTACATATCACACTATAAAACTACTATTATAACGACCG
GATTTGAAACGTCGGGTTTAAATTTGACGAGTTTGACAAG
GCGTATCCGGGAGATTCTGACTGGTGGAATTTCTGGAATT
CTCACGGACACACCACAAACCCAAGACTTACAAAAACTAA
GATTAAAAAGTTACAGACTAAGACCAAACCAACCAAGCAT
GGCAGACCTAGAACGGAGAACGTTTGGATCATATAAAATA
GCAGAAATTTGCTTAAAGAAATTTGAATCAATCCAACAAT
CAACTAATACATTCATCAATTACAAATGATTTTACAACAA
CAAGCAACTGACACATACGAATACAAGTACTGATCTGTCT
CCTAGAAAAATACAAGAACATACTAAAATACAAAGAACAA

TABLE 50
Reoviridae Set III

CTTATCAAAATAATTACTTCGCCACAGATAAATTTAAAAA
CGCAATTGTAGAGTTACTGGATAATAAAGAAGCGTTCTTT
CCCCCTTTACCGGGAGGTGATTCACGGGCTCTATCCCGAG
CAGTTCAAATTCCAATTTACTATTCTTCCAATAGTGAATT
GGTGACGTGTTATCCAGAGATAATGGGGCTCTACTATCAA
GAGCATGTTATATATATAAGTTTTCTGATCATATACGACG
GGAGGATAGATGGAACTAAGATGTATTATGAATATTACAG
CGCCGCCCAAGATTTTTATTACAAATACTCTGAATTACGG
CATTTCAACCAGAATGAAGGGACGACTTACTACTACAAAT
CAATTAGAAGTATTTTATACAAACAGTCAAGCTGACCATG
CGACAAATCTTGATTGTAAACGATCCAACACATGAGTTCG
GATGAGTTATATGGAACTGAAACTGCTGAGTTTGTACTTG
CGCTTAGGCTACGTCGATATGATTCCTGCATTACTACTTT
CAAGACAGAACAAGTAAGAGATAAACACATATTTACACAG
CATTATGCGAACATCGTTAATGGTTCTACTCCTGTGCACT
GCAGCAAAAGCATTCTCTATGTTTACTCGCAGCGATGTCT
GCGTTTTCGGCATTTACTAGAAGCGACGTATATAAAGCAT
CCATACACAACACAACGTACTCCACCGCGCATTGGACTTT
CTCGCAGCGACGTCTACAAGGCGCTGGATGAAATACCTTT
CATTTTTACCTCTCAGATTTGACCTACTCCTCGATCGCTT
GCAGATAATGGAGAAGGAGCGTCAGGAACACGCAATCAAA
CCATCCAACCGACTGTTACAGATAGTGGATCTGGTTGTTG
GAGAGAATCAACTTCAGAAAGAGTCGAGAGACGCGAGACT
CCAAGCCAACATCCAAAAAGTATCTGAGGCGTACGATTTG
CTTCTTCCTTTAATTGCATTGACACTTGTATTGTTGCTAA
CCACGCAACATAATCTGACCTCCTCAAAGCAAGATACACT
CTACTATTATAACGACCGTTCATCTAACAGTGATCTTGTG
GACGAGTTTGACAAGTCGTGTAAGTGCGCTTGAATCTGGT
GGTGGAATTTCTGGAATTCGAGAAGCATACATTAATGAGT
CCAAGACTTACAAAAACTAACTGAACGTATTATTTCGCTT
GACCAAACCAACCAAGCATAGTGAACATTCTAATAAGACT
CGTTTGGATCATATAAAATAGAAGAAATAACAATTAAAAA
GAATCAATCCAACAATTTAGACAAAAGAGACAACAACAAG
GATTTTACAACAACTGACAAAGCACAACAAAGTACCTTTT
CTGATCTGTCTTCATCCAACTCAGCGAAACCAACAACCTT
CTAAAATACAAAGAACAACTAGCAAAACAAGATCAAAAAG

TABLE 51
Retroviridae Set I

GAAGGCTTCATTTGGTGACCCCGACGTGAT
CCCAGGGACCACCGACCCACC
TGTTGTAGGCGTAGCGAGGGAAACGAGGTGTGTTGTAGGC
GAGAGTATAAATATGGGACA
GCAGCTGCAAGCCTTTCCAACTGTGCTAATCACTATGCCA
CGTATTAGCTTCTGTAATCATGCTTGCTTGCCTTAGCCGC
GGGGAACTGTGGGGTTTTTATGAGGGGTTTTATAAATGAT
GAAGGAAAAGAAATTAAAAATAAA
CTTGCTCCCGAGACCTTCTGGTCGGCTATCCGGCAGCGGT
GGCACTGGCTCGGTTGGGTAGCCAGCCTTTCGGGTAATAA
GACCACCAACACCATGGGTAA
TGTCTCTTGTTCCCTTCAATTCCCACTCCCTCCTCCAGGT
CTCCCCGCCAAAAGCATGCCCCGGGCGTGGTGGCGGGCCA
CGTCTCCGCTCGTCACTTATCCTTCACTTTCCAGAGGGTC
TAGCTGAATCATCCGTCTGAGGGCCGTCTCACACTAGGAT
GGGGTGGAGATGGGGCACCATGCTCCTTGGGATGTTGATG
GATTGCCTTACTGCCGAGTGGAGAGTGATTACTGAGCGGC
TCCTGCCTGCCTGAAAAGCTCAATAAAGGAGTTGGCTGAT
TGACTGTGGAGACAATAAAGGAGTTACTTTACAACTGCGC
GGACTGTTTACGAACAAATGATAAAAGGAAATAGCTGAGC
TTGCGCTTGAAGTGAGTCTCTCCCTGAGAGGCTACCAGAT
GCCTTGAACGAGTGGGGAATAATAGATGATTGGCAAGCTT
TTTACTGTTATACTGTGTGTCTGCTATATTATATTGTATT
GTACCAGAATACCTTTACTCTGAATAAACTGCAGATTGTT
CTAGAAAAAGAGGAAGGGATAATACCAGATTGGCAGAATT
GCTTGGGTAAGATTTTGATATGTATTTTGCTTGAATATTA
TTGAGCCTGAGTCGTACTTTCACCGTTTACAGTGGCGAGC
GCCCGGAGGATTGGCTGGAGTGTGAGGAAGATAGTGAGAA
TACTGAAGTACAAGAATGGTTCCAGATGGAGGATGTAGAT
GATATTAATAAAGTGTATAACAGACAAATGTGACTGGCCT
TGTGAATATGATCACCGTGGATTTTTTCCTATGGTTCCAA
GAGACGCATACCGTTGGGGATATTTCCCCTTAGTTCCCAA
GAAGGAGGAGAAGAACCTCACTACCCAAATACTCCAGCTC

TABLE 52
Retroviridae Set II

GATGAGTTAGCAACATGCCTTATAAGGAAAGAAAAAGCAC
TCGATTCCCTGACGACTACGAACACCTAAATGAAGCGGAA
TGATCGTTAGGGAATAGTGGTCGGCCACAGGCGTGGCGAT
CTTTTGCTGTTGCATCCGAATCGTGGTCTCGCTGATCCTT
GGTGTGTTGTAGGCGTAGCGAGGGAAACGAGGTGTGACGC
TTGAGTCCCTAACGATTGCGAACACCTGAATGAAGCGGAA
CGGAAAATTACCCTGGTAAAAAGCCCAAAGCATAGGGGAA
GATGAGTTAGCAATATGCCTTACAAGGAAAGAAAAGGCAC
GAGGGTCTCCTCTGAGTGATTGACTACCCACGACGGGGGT
CTCTTGCAGTTGCATCCGACTTGTGGTCTCGCTGTTCCTT
TGCAAGGCATGGAAAAATACCAAACCAAGAATAGGGAAGT
TTGATTCCCTGACGACTACGAGCACCTGCATGAAGCAGAA
CTCTTATTTTCTTAGCGGGGATGCTCCGTTCTCTCCTTAT
GTCTTTTTTTCTCAGCGAGGGCGCTCCGTTCTTTCCTTAT
TTCTCAGTTTCTTAGCGGGGACCGTCCGTTCTCTCCCTGT
CTGTGCTAATCACTATGCCACCCTTCTTGTAATAACATAA
TCTTGCTGATTGCATCCGGAGCCGTGGTCTCGTTGTTCCT
GCCTTTTGCTGTTTGCATCCGAAACGTGGCCTCGCTGTTC
GCCTTTTGCTGTTTGCATCCGAAGCGTGGCCTCGCTGTTC
TGTACTTGATATATTTCGCTGATATCATTTCTCGGAATCA
CTCTTGCTGTTGCATCCGACTCGTGGTCTCGCTGTTCCTT
TGAGGGGTTTTATAAATGATTATAAGAGTAAAAAGAAAGT
CGCTTCTGTAAAACCGCTTATGCGCCCCACCCTAACCGCT
GTCGGCTATCCGGCAGCGGTCAGGTAAGGCAAACCACGGT
GGCATGGAAAATTACTCAAGTATGTTCCCATGAGATACAA
GCCAGCCTTTCGGGTAATAAAGGCTTGTTGGCATTCGGCA
GCCGGTTGAGTCGCGTTCTGCCGCCTCCCGCCTGTGGTGC
CTCCTCCAGGTTCCTACTGTTGATCCCGCGGGTCGGGACA
GCGTGGTGGCGGGCCACCAATGGAGGACCTGATCACGGGC
TCACTTTCCAGAGGGTCCCCCCGCAGACCCCGGTGACCCT
GTCATCAGCTTAAAAGGTCACGCTGTCTCACACAAACAAT
GGGCCGTCTCACACTAGGATTGTGCCCAAAAAGAACACCA
GGTCAGACCGTCTCACACAAACAATCCCAAGTAAAGGCTC
GGAACCCACTGCTTAAGCCTCAATAAAGCTTGCCTTGAGT
GAGTGATTACTGAGCGGCCGGTGTATCGGGAGTCGTCCCT
GTTGGCTGATATCTGAGCTTGCCTGGTTATTATCGGGATT
GTTACTTTACAACTGCGCTAGCCTGGTTATTATCGGGATT
GAAATAGCTGAGCATGACTCATAGTTAAAGCGCTAGCAGC
GAGAGGCTACCAGATTGAGCCTGGGTGTTCTCTGGTGAGT
GATGATTGGCAAGCTTACTCACCAGGCCCGGGGATAAGGT
GCACTAGCAGGTAGAGCCTGGGTGTTCCCTGCTAGACTCT
CTGCTATATTATATTGTATTTCCTTGCTCAGCTATTTTGC
CTGCAGATTGTTAAACTTTAACTCCTCGTCTGATCTGATC
TGGCAGAATTATACTCATGGGCCAGGAGTAAGGTACCCAA
TGTATTTTGCTTGAATATTATTTGCCTTGCTCAAAATTAA
CGTTTACAGTGGCGAGCCAGCCAGGAGCCTTTTCTTCATA
TGTGAGGAAGATAGTGAGAATGAGGAACTCAGTGTTTCTC
TCCAGATGGAGGATGTAGATGATAGAGCAAGAGAACCACT
GTGACTGGCCTGGGCTGCTTTCCTTTCTTCGAACATGGAT
TTTTTCCTATGGTTCCAAACAAGCTGTCTCCTACCTGGGT
TTTCCCCTTAGTTCCCAATAAGCATCATCCTGGGTGGACT
TACTCCAGCTCCTCATAAAAAGACCTGGGAGGAGAGACAT

TABLE 53
Retroviridae Set III

GGAAAGAAAAAGCACCGTGCATGCCGATTGGTGGAAGTAA
CGACGTGATAGTTAGGGAATAGTGGTCGGCCACAGACGGC
TCGGCCACAGGCGTGGCGATCCTGCCCTCATCCGTCTCGC
GTGGTCTCGCTGATCCTTGGGAGGGTCTCCTCAGAGTGAT
GGGAAACGAGGTGTGACGCGTGCAGGTTCCTATGCCACCT
CGACGTGATCGTTAGGGAATAGTGGTCGGCCACAGGCGGC
GCATAGGGGAAGTACAGCTAAAGGTCAAGTCGAGAAAAAC
TGACTACCCACGACGGGGGTCTTTCATTTGGGGGCTCGTC
GTGGTCTCGCTGTTCCTTGGGAGGGTCTCCTCTGAGTGAT
GAATAGGGAAGTTCAGATCAAGGGCGGGTACACGAAAACA
TGCTCCGTTCTCTCCTTATACAGGTGTAACTTTTGTCCGT
CGCTCCGTTCTTTCCTTATACAGGTGCATTCCTTGTCAGT
GTCCGTTCTCTCCCTGTGCAGGTGCGACTCTTGTTTGTGC
CTTCTTGTAATAACATAACAACTGTGTGCTCTCTGTCCAA
GCCGTGGTCTCGTTGTTCCTTGGGAGGGTTTCTCCTAACT
GTGGCCTCGCTGTTCCTTGGGAGGGTCTCCTCTGAGTGAT
GTGGCCTCGCTGTTCCTTGGGAGGGTCTCCTCAGAGTGAT
CTCTTGCTGTTGCATCCGACTTGTGGTCTCGCTGTTCCTT
TATCATTTCTCGGAATCAGCATCATTTCTCGGAATCGGCA
GTGGTCTCGCTGTTCCTTGGGAGGGTCTCCTCAGAGTGAT
TATAAGAGTAAAAAGAAAGTTGCTGATGCTCTCATAACCT
TGCGCCCCACCCTAACCGCTTTCATTTCGCTTCTGTAAAA
GCAAACCACGGTTTGGAGGGTGGTTCTCGGCTGAGACCGC
TATGTTCCCATGAGATACAAGGAAGTTAGAGGCTAAAACA
GGCTTGTTGGCATTCGGCATCTACCCGTGCCTCCTGTCTT
CGCCTCCCGCCTGTGGTGCCTCCTGAACTACGTCCGCCGT
TGATCCCGCGGGTCGGGACAGTTGGCGCCCAACGTGGGGC
TGGAGGACCTGATCACGGGCAAGACATGCCTCAGGGCCAC
GCAGACCCCGGTGACCCTCAGGTCGGCCGACTGCGGCAGC
GCTGTCTCACACAAACAATCCCGGGAACAGGCTCTGACGT
TGTGCCCAAAAAGAACACCAAGGCTCTGACGTCTCTCCCT
GGCTCTGACGTCTCCCCCTTTTTTTAGGAACTGAAACCAC
CTGAAAAACATTTCCGCGAAACAGAAGTCTGAAAAGGTCA
GCTTGCCTTGAGTGCTTCAAGTAGTGTGTGCCCGTCTGTT
TGTATCGGGAGTCGTCCCTTAATCTGTGCAATACCAGAGC
GCCTGGTTATTATCGGGATTCGTTACTAATTCCGTGCAAC
GCCTGGTTATTATCGGGATTCGTCACTAATTCTGTGCAAC
TAGTTAAAGCGCTAGCAGCTGCCTAACCGCAAAACCACAT
CTGGGTGTTCTCTGGTGAGTCTTGGAAGGAGTGCCTGCTT
GGCCCGGGGATAAGGTACCCGAGAGTCTTTGGCTTCTGCT
GGTGTTCCCTGCTAGACTCTCACCAGCACTTGGCCGGTGC
TTGCTCAGCTATTTTGCAATACCATATATCCTGTCCCCAA
CTCCTCGTCTGATCTGATCCTTGACCGGCTCGCTAGCCTA
GGAGTAAGGTACCCAATGTACTTCGGGTGGCTGTGGAAGC
TTTGCCTTGCTCAAAATTAAATAAATTGGCTTTTCTTTCA
GGAGCCTTTTCTTCATAAAGAGATTCGAGAAACGAAGCGT
TGAGGAACTCAGTGTTTCTCCCCTCACAGGCTGGGAGCCT
GATAGAGCAAGAGAACCACTAGATGGCAGTGAAACACATC
TCCTTTCTTCGAACATGGATATAATTTAGATAAGTGAATT
GCTGTCTCCTACCTGGGTGAGACATGCTGCCCCCTACTGT
TCATCCTGGGTGGACTAGACATTTAACTAAGTTCAAGATT
CTGGGAGGAGAGACATAAGGTTCTTAAGCTGTCCCCATTC

TABLE 54
Rhabdoviridae Set I

TATGAAAAAAACTAACAGAGATC
TAGATAGAAAAAAATGGCAC
AAGCCTTAACGGGAACTCCCGTATTGCCAAGATGAGTTTG
TCTCTCGACATTCAAAATGTCAACAGATATCATATCTGAA
AGATGGCACGTAAGTTGCAAAGAGTTTCAGTTTACCAAAA
TATAGACATTGGGGTCATCCTTATAT
GAAATGCAACACCCCTACAATGGATGCTGACAGAATTGTC
ATGTAACACCTCTACAATGGATGCCGACAAGATTGTATTC
AAAATGTAACACTCCTACAATGGAGTCTGACAAGATTGTG
ATGTTCTGCATTTCCCTCTGAATGGGTGCTTTGGGGGTAA
TGTGGGAAGATCCGCCCGCAACCTGCTCAATAACACATGA
GCTTATACAGATCCCCTAAGTTTGGATGCTGAGCTAGCGC
AGCTCAAAATCTGGGTATTGGTTCGGGAAAAGAGTGAGAA
AGGTGCAATGGCCCCAATCTGCGGATTAAAATAAAACCTG
TCTGTTTTTTTGCTCGCGTAACCGGCAGGACGAACTCCTG
GGATCCTCCATATGGTGGATTCGGGCACCGTCCTGGGCCC
AGGCATAGAATACAACCATGGTTATAAGATAGAGCAGGTG
AGGTCTCTTTCCTTCATCATGTACTGCACATTGAATAAGA

TABLE 55
Rhabdoviridae Set II

AAAAATGGTAACAGACATCATGAGTGTCATTCGGATCAAA
TTCAGTTGTACACTGATAACGTGTTATAGACACTAGAAAC
AAGAAAAAGGTGGCACTTCAGTTGTAACCTGATAACGTGC
AGTAGCAAAAAGTTTTCAAGTTTGAAATTCCAAGAATTTG
AGTAATCAAAATGTCTGTTACAGTCAAGAGAATCATTGAC
GTATTGCCAAGATGAGTTTGTCACGGTTGTACTCTAAGAA
AACAGATATCATATCTGAATCTTCAAGAATGGAACACCAA
AGAGTTTCAGTTTACCAAAACAGAAAGCCCTAGAAACAAG
TAAGCCGGAGGTGATAGTAGATCAGTATGAATATAAGTAC
GGATGCTGACAGAATTGTCTTCAAAGTCCATAACCAGTTG
TGCCGACAAGATTGTATTCAAAGTCAATAATCAGGTGGTC
GAGTCTGACAAGATTGTGTTCAAGGTGAATAACCAAGTTG
GTAACACCCCTACAATGGATGTTAACAAGGTTGTTTTTAA
TGGGTGCTTTGGGGGTAATGCCCTTGTACGTGCCCCTTAA
TGCTCAATAACACATGATCAGGAAGTGACACAATCTGCGA
TTTGGATGCTGAGCTAGCGCGGTAGTGTATTGGTGAGTCC
TCGGGAAAAGAGTGAGAAACCACATTAAGTCATACCCTTC
GGATTAAAATAAAACCTGAGATCGCCACTCTCATTAATCA
GCAGGACGAACTCCTGCTGCTAGTGGCTGACGTTTTGGTG
GGGCACCGTCCTGGGCCCCGCTGTAGTCGTGCTGGCTAGC
GTTATAAGATAGAGCAGGTGTATCTGGGGTAACGGCGGAG
GTACTGCACATTGAATAAGAAAGAGATCAAGGCTGTTAAG

TABLE 56
Rhabdoviridae Set III

TGAGTGTCATTCGGATCAAAACAAATGCTACCGTTGCTGC
GTGTTATAGACACTAGAAACCAAGTCTAAGTGATATATTC
GTTGTAACCTGATAACGTGCTTTAGACACTATAAACCGAG
TTTGAAATTCCAAGAATTTGGAAAGTGAAAGTTGAACACA
AGTCAAGAGAATCATTGACAACACAGTCATAGTTCCAAAA
TCACGGTTGTACTCTAAGAAGACTCAGTCATCTTACAATG
TCAAGAATGGAACACCAAATCATCAGGAGAGTGTCTACTG
AGAAAGCCCTAGAAACAAGCGTGAGATATCAGAATCTGAC
ATCAGTATGAATATAAGTACCCTGCAATCAAAGATCAGAG
AAAGTCCATAACCAGTTGGTGTCTGTAAAGCCAGAAGTAA
AGTCAATAATCAGGTGGTCTCTTTGAAGCCTGAGATTATC
AAGGTGAATAACCAAGTTGTTTCTTTGAAGCCTGAGGTCA
TTAACAAGGTTGTTTTTAAGGTCCATAATCAGCTGGTCTC
TGCCCCTTAACAATCATGTCACCAAGACCTGATATGTTAA
GGAAGTGACACAATCTGCGACTATTAACAAAAACCCAACC
GGTAGTGTATTGGTGAGTCCTTCTCCCTTAGCTACGGTCC
TTAAGTCATACCCTTCTAATTGTATACCCTGTGTTATTTC
GCCACTCTCATTAATCACAACTAATATTTGGAAGTTTTCA
TGGCTGACGTTTTGGTGATTTTAACTGATTAGTAGATTAA
TGTAGTCGTGCTGGCTAGCGGTCACACAAAACGAGTGTCC
TATCTGGGGTAACGGCGGAGACCCGTGACGGCGCCGCTAC
AAGAGATCAAGGCTGTTAAGCCAACTGATGCTATCCCTCC

TABLE 57
Togaviridae Set I

CCAAATGAAGGTAACCGTGGACGTTGAGGCTGATAGCCCA
CCGCAGTGAGAGATAAACAACCCAGAATGAAGGTCACTGT
GACTTAGACGCAGACAGCCCATTCGTCAAGTCACTGCAAA
GGAGAAGCCAGTAGTAAACGTAGACGTAGACCCCCAGAGT
GCTAAACTAGCCCCAATCATCGAAAATGGAGAAACCGACA
GAGATTAAGAACCCATCATGGATCCTGTGTACGTGGACAT
CTGCATTGCAAGAGATTAAAGTACCCATCATGGATTCAGT
CCCGCGGACCACCCGGCCCTGAACCAGTTCAAGACTGCGT

TABLE 58
Togaviridae Set II

GGCCTTATAACTTAACCGTCGGCAGTTGGGTAAGAGACCA
CGAAAGTCTTTGTAGACATCGAGGCCGAGAGCCCGTTTTT
CTCGGCTACGCGAGAGATTAACCACCCACGATGGCCGCCA
CGTTGACATCGAGGAAGACAGCCCATTCCTCAGAGCTTTA
GCCCGTATGTCAAGTCGTTACAGCGGACGTTTCCACAATT
CGAAACCAGTTGTGAAGATCGACGTGGAACCTGAAAGCCA
CCAAATGAAGGTAACCGTGGACGTTGAGGCTGATAGCCCA
CCGCAGTGAGAGATAAACAACCCAGAATGAAGGTCACTGT
GACTTAGACGCAGACAGCCCATTCGTCAAGTCACTGCAAA
GGAGAAGCCAGTAGTAAACGTAGACGTAGACCCCCAGAGT
GCTAAACTAGCCCCAATCATCGAAAATGGAGAAACCGACA
GAGATTAAGAACCCATCATGGATCCTGTGTACGTGGACAT
CTGCATTGCAAGAGATTAAAGTACCCATCATGGATTCAGT
CCCGCGGACCACCCGGCCCTGAACCAGTTCAAGACTGCGT

TABLE 59
Togaviridae Set III

GAGACCACGTCCGATCAATTGTCGAGGGCGCGTGGGAAGT
GAGGCCGAGAGCCCGTTTTTAAAATCACTACAAAGAGCAT
GGCCGCCAAAGTGCATGTTGATATTGAGGCTGACAGCCCA
GCCCATTCCTCAGAGCTTTACAACGGAGCTTCCCGCAGTT
CGGACGTTTCCACAATTTGAGATCGAAGCAAGGCAGGTCA
CGTGGAACCTGAAAGCCATTTCGCTAAGCAGGTCCAGAGT
GAGGCTGATAGCCCATTCCTTAAGGCCCTTCAGAAGGCGT
GAGGCTGACAGCCCATTTTTGAAGGCCCTTCAGAAAGCAT
CGTCAAGTCACTGCAAAGATGCTTTCCACATTTTGAGATA
GACGTAGACCCCCAGAGTCCGTTTGTCGTGCAACTGCAAA
GGAGAAACCGACAGTGCACGTTGACGTAGACCCCCAAAGT
GATCCTGTGTACGTGGACATAGACGCTGACAGCGCCTTTT
CCCATCATGGATTCAGTGTATGTAGACATAGATGCTGACA
GCGTTTCCAGGGTTCGAAGTGGTGGCCAGCAACCGGTCGT
GCGTTTCCAGGGTTCGAAGTGGTGGCCAGCAATAGGTCGT

In another embodiment, the present invention provides methods for making a set of oligomers that uniquely identify a particular viral family, and a set of primers used to amplify the regions containing the sequences matching these oligomers. These methods can also be encoded on a computer-readable medium as computer-readable program code devices that are configured to enable a general purpose electronic computing machine (FIG. 2 at 2000) to perform the methods on a electronic dataset of viral family genomic sequences.

In one embodiment, a computer is programmed to perform a string comparison of various viral family genomic sequences to determine if substrings of viral family member genomes match multiple viral family members. Substring matches at different locations in different viral family members are used to construct a list of oligomers which each match (within a defined tolerance) a certain number of viral family members. The list is then cleaned of excess error; and each oligomer is then expanded to it's longest length according to a defined tolerance. The list is then sorted, and the best oligomer is added to a “results set”. The intersection of the results set and the list of oligomers is then filtered out, and the next best oligo is selected. This process of filtering and selecting next best oligomers is repeated until every family member is matched (to within a defined tolerance) by at least one oligomer in the set of results. The above set of results defines the probes of interest used to identify a viral family. Three such sets are generated in total. Primers are then selected for each probe in an analogous manner. The performance of these operations can be accomplished by a person having ordinary skill in the art using the disclosure and drawings herein.

In one embodiment, the methods use a simple computer-generated string comparison technique to determine if subsequences of a viral family member genome matches multiple viral family genomic sequences. In a more particular embodiment, a “match” is determined when a count of differences between two sequences is less than, or equal to, a defined limit for any possible substring of a viral genomic sequence. In a more particular embodiment, the defined limit is defined as:

└Tₐ/100×Sₗ┘

where Tₐ is the acceptable tolerance (%) and Sₗ is the sequence length.

Substring matches at different locations in different viral family members are collected as a list of sequences, which sequences are formed from sets of substrings which, when combined, match multiple viral family members; wherein a “match” is declared when the count of base differences between two equal-length sequences is less than the defined limit. Two bases are said to match if the intersection of the set of characters encoding the base is not empty.

The list is then cleaned of excess error. An error is defined as any character which is not one of the set {A, C, G, T}. The amount of error is tolerable when it is less than, or equal to, the defined limit above.

Each sequence in the list is then expanded to its longest tolerable length, which is determined by considering the next character past the end of each subsequence as now part of the sequence. The acceptability of each extended sequence is then reconsidered using the criteria defined above, and if it passes, the expansion continues; if not, the length of the sequence is reduced by one. The process is stopped if the length of the sequence exceeds a defined upper limit.

The list is then sorted in ascending order according to the number of viral matches using the criteria for matching defined above, and the best sequence, defined as the first oligo in the sorted list which does not match any oligo in the results set, or any virus outside the viral family, using 0% tolerance for both, is added to the results set. The intersection of the results set and the list of oligos is then filtered out by moving to the back of the list those sequences in the list which match (with 0% tolerance) any sequences in the set of results, and the next best oligo is selected. This process, of filtering and selecting next best sequences, is repeated until every family member is matched by at least one oligo in the set of results. The above set of results defines the probes of interest used to identify a viral family. Three such sets are generated in total, in which the second and third sets of results reuse the list of sequences used to make the first set of results, but ignoring sequences oligos which match (0% tolerance) anything in the previous sets of results. More or fewer results sets can be generated in other embodiments.

Primers are then selected for each probe in an analogous manner as follows: For each sequence in every set of results, viral genomic sequences that match the sequence are used to generate two lists of substrings. The two lists are made from substrings found to the left, and to the right, of the location where the sequence is matched as defined above; and the sequences are chosen such that when the left substring, sequence, and right substring are concatenated together, they are of a length optimal for amplification using PCR at a given length of base pairs (bp). In some embodiments, the length is between about 100 by and about 1,000 bp, and in more particular embodiments about 500 bp. From the left list, the same process used to make the probes (described above) is used, but with the following changes: (a) using the left list in place of the viral family list, (b) using sequence lengths of between about 10 and about 17 bases, (c) using tolerance of about 25%, and (d) skipping the check against non-family members. The same is done for the right list, but using the compliment of each primer.

The foregoing can be implemented using skills and information known to those having ordinary skill in the art in light of the disclosure and drawings herein.

### 5.2 Viral Family Genomic Probes and Arrays

In another aspect, the present invention includes genes and corresponding polypeptides, probes, primers (e.g., PCR primers), and arrays of such polypeptides, genes, probes, and primers defined using the methods, software, and programmed electronic computing machines provided herein. Methods and materials for making such polypeptides and corresponding genes encoding such polypeptides, probes, primers (e.g., PCR primers), and arrays of such polypeptides, genes, probes, and primers are familiar to those having ordinary skill in the art.

### 5.3 Systems and Methods for Identifying Viral Infections Using Viral Family Genomic Probes

In another aspect, the present invention provides systems for diagnosing diseases including the polypeptides, genes, probes, and primers described herein. In some embodiments, the systems provided by the present invention include devices configured to identify individual or sets of polypeptides or genes (or both) in biological samples. The preparation, configuration, and operation of such systems is familiar to those having ordinary skill in the art.

In yet another aspect, once a viral family (or families) have been identified in a biological sample from an infected mammal (e.g., a human or animal), the treatment as described in WO 08/124,550 can be administered to either cure or alleviate the infection, or prevent additional harm to the infected mammal or the public. Such administration is familiar to those having ordinary skill in the art.

Still other useful methods, systems, and apparatus provided by the present invention include the following.

In another aspect, the present invention provides a system for diagnosing a virus comprising a first array of oligonucleotides configured to identify at least one viral family in combination with a as described above in combination with a second, and optionally subsequent, array or arrays of oligonucleotides configured to identify a specific virus. As will be understood by those of ordinary skill in the art, exposure of a biological sample to the first array provides identification of the viral family (or families) present in the sample; exposure of the sample to the second array then can be used to identify the particular virus. As will be appreciated by those having ordinary skill in the art, in medical practice a care giver can prescribe treatment with a broad-spectrum anti-viral agent (such as described in WO 08/124,550) until identification of the virus is made using the second array, at which time the caregiver can assign a treatment more specific to the virus. Still other embodiments include using an array to identify the virus's sub-type. In still other embodiments, the second (or subsequent) array is configured to identify single nucleotide polymorphisms and other variants of host factors that prove to be relevant for viral infection (e.g. once drug targets are known). In yet another embodiment, the second (or subsequent) array is configure to reproduce the result of the first array, but for a subset of viral families; thereby corroborating the conclusion and raising the sensitivity or specificity (or both) of the result of the first array. Those having ordinary skill in the art will understand from the foregoing that the invention provides caregivers the opportunity to tailor drug therapies to viruses quickly and while giving treatment.

In another aspect, the present invention provides arrays of oligonucleotides, probes, and primers, and methods for using such as described herein wherein the viral families and viruses are plant and non-human animal viruses. In addition, the methods, systems, and devices provided by the present invention can be used to identify and treat emerging viruses, and engineered viruses (e.g., weaponized viruses).

### 6 EXAMPLES

The following Examples are provided to illustrate certain aspects of the present invention and to aid those of skill in the art in the art in practicing the invention. These Examples are in no way to be considered to limit the scope of the invention in any manner.

### 6.1 Example 1

This Example demonstrates the amplification of the EBOV and MARV nucleocapsid genes from a mixture of nucleocapsid DNA sequences using the methods and materials provided by the present invention. This Example further demonstrate that the amplified EBOV PCR product so obtained could be identified by a specific biotinylated probes provided by the present invention using Southern blot analysis.

### 6.1.1 Materials and Methods

A plasmid DNA template consisting of a mixture of genes encoding nucleocapsid proteins, chosen from viruses of different families, was prepared. The viruses and their corresponding families are shown below:

EBOV and MARV (Filoviridae);

RPXV (Poxviridae);

LASV (Arenaviridae);

RVFV and HNTV (Bunyaviridae);

FLUV (Orthomyxoviridae);

HIV (Retroviridae);

SARS (Coronaviridae);

DENV and HCV (Flaviviridae); and

EGFP (Enhanced Green Fluorescent Protein) (irrelevant template);

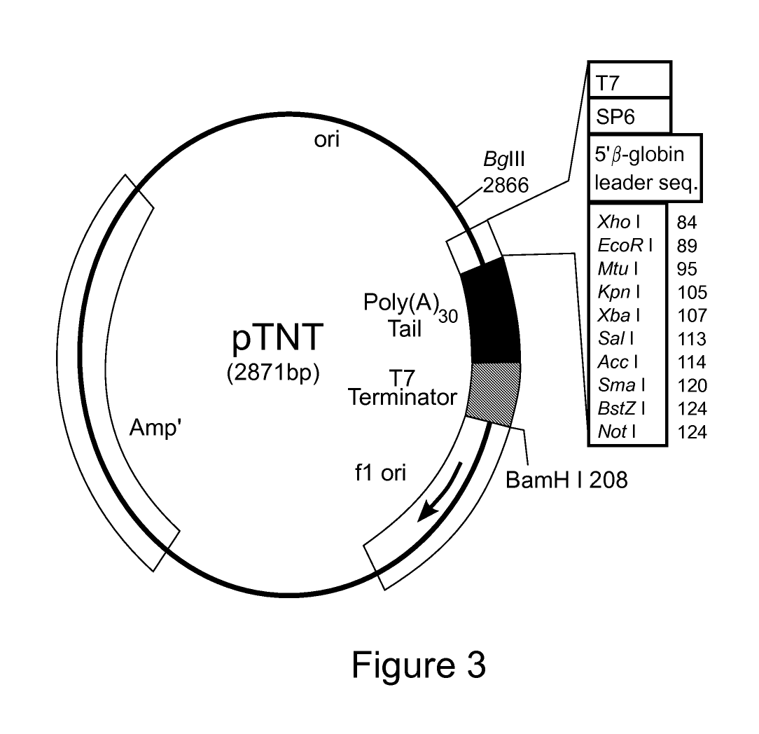

The cDNA sequences encoding various nucleocapsid genes were cloned into the Kpn I and Not I sites of the pTnT plasmid (obtained commercially from Promega Corp., Madison, Wis.). Clones were authenticated by restriction mapping and sequence analysis as illustrated in FIG. 3.

The following primers were synthesized commercially (Bioneer Inc., Alameda, Calif.), and employed in the PCR amplification of the cDNAs:

| | |
|---|---|
| EboZ_NP For | 5′-ATGGATTCTCGTCCTCAGAAAA-3′; |
| EboZ_NP Rev | 5′-TCACTGATGATGTTGCAGGATT-3′; |
| MarbNP_F | 5′-ATGGATTTACACAGTTTGTTGG-3′; |
| MarbNP_R | 5′-TCATCGCAACATGTCTCCTTC-3′; |
| pTnT-For | 5′-GGCTCGACAGATCTTAAGGCT-3′; |
| and | |
| pTnT-Rev | 5′-GCCTCTTCGCTATTACGCCAG-3′. |

The oligonucleotide 5′-AAGCAACTCCAACAATATGC-3′ (for EBOV a member of the Filoviridae) maps to the nucleocapsid gene. A 5′- and 3′-biotinylated version of this probe (with a 15-atom triethylene glycol (TEG) spacer) was synthesized by Bioneer, Inc., Alameda, Calif., and employed in a Southern blot analysis.

The following reagents were added sequentially in a 100 μl PCR reaction:
1. 70 μl dH₂O.
2. 16 μl dNTPs (1.25 mmol each).
3. 10 μL 10× YieldAce buffer (provided by supplier—Stratagene, Inc., La Jolla, Calif.).
4. 1 μl (100 nmol) Forward PCR primer (either pTnT or gene-specific).
5. 1 μl (100 nmol) Reverse PCR primer (either pTnT or gene-specific).
6. 1 μl Mixed plasmid DNA templates (0.1 ug each—final conc.)

7. 1 μA YieldAce DNA Ploymerase (provided by supplier—Stratagene, Inc., La Jolla, Calif.).

The following reagents were added sequentially in a 100 μl PCR reaction:
1. 70 μL dH₂O.
2. 16 μl dNTPs (1.25 mmol each).
3. 10 μL 10× YieldAce buffer (provided by supplier—Stratagene, Inc., La Jolla, Calif.).
4. 1 μl (100 μmol) Forward PCR primer (either pTnT or gene-specific).
5. 1 μl (100 μmol) Reverse PCR primer (either pTnT or gene-specific).
6. 1 μl Mixed plasmid DNA templates (0.1 μg each final conc.)
7. 1 μA YieldAce DNA Ploymerase (provided by supplier—Stratagene, Inc., La Jolla, Calif.).

PCR was performed using a TGradient Thermocycler (BioMetra, Goettingen, Germany) the following sequence:

| Temperature (° C.) | Time (s) | Number of Cycles |
|---|---|---|
| 95 | 40 | 1 |
| 95 | 40 | 11 |
| 46 | 30 | |
| 72 | 180 | |
| 95 | 40 | 35 |
| 43 | 30 | |
| 72 | 180 | |
| 72 | 600 | 1 |
| 4 | HOLD | |

### 6.1.2 Results

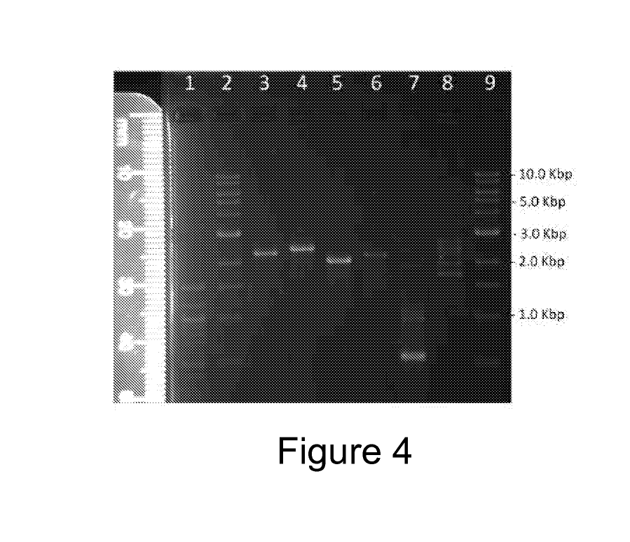

A 2 μL aliquot of each PCR reaction was electrophoresed through a 1% agarose gel in Tris acetate (TAE) buffer, as shown in FIG. 4. The lanes were assigned as follows:

### Lane Material

1 100 by DNA Ladder from New England BioLabs (Cat. No. N3231L)

2 1 Kbp DNA Ladder from New England BioLabs (Cat. No. N3232L)

3 PCR product from MARV—Reference

4 PCR product from EBOV—Reference

5 Mixed plasmid DNA templates PCR'd with MARV-For and -Rev primers

6 Mixed plasmid DNA templates PCR'd with EBOV-For and -Rev primers

7 Mixed plasmid DNA templates PCR'd with pTnT-For and -Rev primers

8 Mixed plasmid DNA templates

9 1 Kbp DNA Ladder from New England BioLabs (Cat. No. N3232L)

The PCR products in lanes 4 and 6 were slightly bigger than the corresponding PCR products in lanes 3 and 5 respectively. Without wishing to be bound to any particular theory of action, this was expected as PCR amplification with pTnT primers adds on an additional 200 bp to the PCR products when compared to PCR amplification using gene-specific primers.

The DNA from the agarose gel was transferred to a Biodyne Nylon membrane as described by the manufacturer (Pall Corp., Port Washington, N.Y.), and the membrane-bound materia was hybridized to a 5′- and 3′-TEG-biotinylated probe, as described above and as published in Leukemia (2000) 14, 767-772 (FIG. 4).

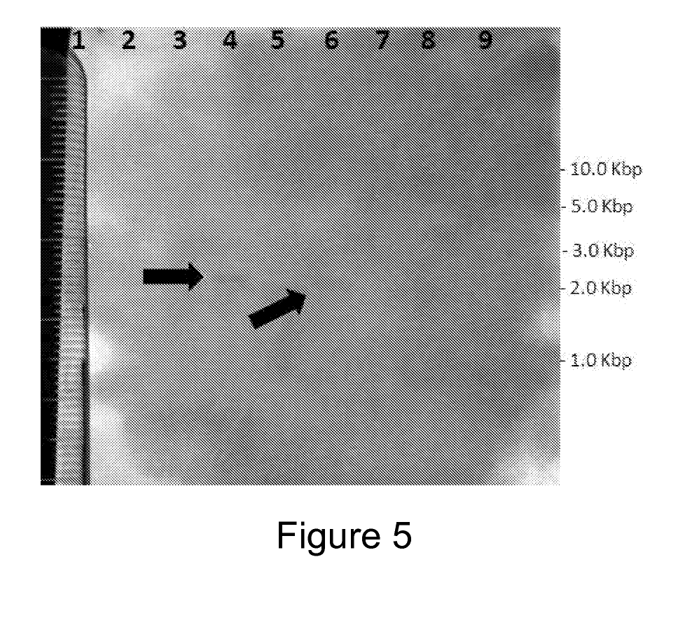

As can be clearly seen in Lanes 5 and 6 of the agarose gel (FIG. 4), the nucleocapsid genes for EBOV and MARV were specifically amplified from a mixture of template DNAs containing genes for several viruses. In addition, the PCR product for the EBOV-NP alone was detected by the biotinylated probe (FIG. 5).

### 7 CONCLUSION

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

What is claimed:

1. A method for detecting the presence of a member of a viral family in a sample, comprising: normalizing viral genomic oligonucleotide sequence data from at least one viral family, and identifying at least one oligonucleotide sequence that is unique to each viral family; forming an array of the identified oligonucleotide sequences; amplifying viral family genomic sequences in said sample; and detecting the presence of a member of said viral family. More particularly, the above-described method is implemented using an electronic computing device that is configured to execute the method on an electronic database of viral oligonucleotide sequences that have been electronically encoded and stored in a electronic memory device in electronic communication with the electronic computing device.
